(19) United States
(12) Patent Application Publication
(10) Pub. No.: US 2025/0128163 A1
(43) Pub. Date: Apr. 24, 2025

(54) NON-TRANSITORY COMPUTER READABLE MEDIUM, INFORMATION PROCESSING METHOD, AND GAME DEVICE

(71) Applicant: CYGAMES, INC., Tokyo (JP)

(72) Inventors: Kosuke Hirahata, Tokyo (JP); Mizuki Masuda, Tokyo (JP); Nozomi Kikuchi, Tokyo (JP); Yujiro Deguchi, Tokyo (JP)

(73) Assignee: CYGAMES, INC., Tokyo (JP)

(21) Appl. No.: 19/005,523

(22) Filed: Dec. 30, 2024

Related U.S. Application Data
(63) Continuation of application No. PCT/JP2023/024002, filed on Jun. 28, 2023.

(30) Foreign Application Priority Data
Jul. 1, 2022 (JP) 2022-106867

(51) Int. Cl. A63F 13/58; A63F 13/825

(52) U.S. Cl. CPC A63F 13/58; A63F 13/825

(57) ABSTRACT

A non-transitory computer readable medium stores a program causing a computer to execute: a process for allowing a player to select a nurturing-completed game medium used in a nurturing game and to which predetermined inheritance information is tied; a process for executing the nurturing game, the process including a process for updating at least one parameter tied to a nurturing-target character and a process based on the nurturing-completed game medium; and a process for creating and storing, based on completion of the nurturing game, the nurturing-completed game medium in which the at least one parameter and the inheritance information are tied to the nurturing-target character. The inheritance information includes specific inheritance information for increasing an upper limit of the at least one parameter. The process for executing the nurturing game increases the upper limit of a predetermined parameter when the specific inheritance information is tied to the nurturing-completed game medium.

### CROSS REFERENCE TO RELATED APPLICATIONS

This application is a continuation application of International Application No. PCT/JP2023/024002, filed on Jun. 28, 2023, which claims priority to Japanese Patent Application No. 2022-106867, filed on Jul. 1, 2022, the entire contents of which are incorporated by reference herein.

### BACKGROUND ART

### Technical Field

The present invention relates to an information processing program, an information processing method, and a game device.

There are well-known nurturing games in which a player nurtures a character, as indicated in, for example, Patent Literature 1. In such nurturing games, characters nurtured by the player are stored as nurtured characters. Nurtured characters can be used, for example, in competition games against other players.

### CITATION LIST

### Patent Literature

Patent Literature 1: JP 2021-121396 A

### SUMMARY OF INVENTION

### Technical Problem

In nurturing games, it is difficult to make much difference among nurtured characters in abilities and properties. This is problematic in that the player is discouraged from repeatedly playing the nurturing game.

An object of the present invention is to provide an information processing program, an information processing method, and a game device capable of further encouraging a player to play a game.

### Solution to Problem

In order to solve the aforementioned problem, an information processing program causes a computer to execute:
a process for allowing a player to select a nurturing-completed game medium that is used in a nurturing game and to which predetermined inheritance information is tied;
a process for executing the nurturing game, said process including at least a process for updating at least one parameter tied to a nurturing-target character and a process based on the nurturing-completed game medium selected by the player; and
a process for creating and storing, on the basis of completion of the nurturing game, the nurturing-completed game medium in which the at least one parameter and the inheritance information are tied to the nurturing-target character,
wherein the inheritance information includes specific inheritance information for increasing an upper limit of the at least one parameter, and
the process for executing the nurturing game increases the upper limit of a predetermined parameter in the case where the specific inheritance information is tied to the nurturing-completed game medium selected by the player.

A base value set in common among a plurality of the parameters may be provided,
the process for executing the nurturing game may be capable of increasing the upper limit of the predetermined parameter to a value larger than the base value in the case where the specific inheritance information is tied to the nurturing-completed game medium selected by the player, and
the information processing program may cause the computer to execute a process for performing different displays between in the case where the parameter is updated in the range below the base value and in the case where the parameter is updated so as to exceed the base value.

The inheritance information may include a plurality of kinds of the specific inheritance information that differ from one another in terms of at least either the parameter the upper limit of which increases or an increase value of the upper limit,
the information processing program may cause the computer to execute a process for allowing the player to select, from among a plurality of characters to which any of the plurality of kinds of specific inheritance information is tied, a character that is set as the nurturing-target character, and
the process for creating and storing the nurturing-completed game medium may tie, to the nurturing-completed game medium, the specific inheritance information tied to the character set as the nurturing-target character.

An increase value of the predetermined parameter may be further tied to the specific inheritance information.

A base value set in common among a plurality of the parameters may be provided,
the process for executing the nurturing game may be capable of increasing the upper limit of the predetermined parameter to a value larger than the base value in the case where the specific inheritance information is tied to the nurturing-completed game medium selected by the player,
an update value of the parameter may be decided according to a first update condition in the case where the parameter is updated in the range below the base value, and
an update value of the parameter may be decided according to a second update condition, which less readily increases the parameter than the first update condition, in the case where the parameter is updated so as to exceed the base value.

In order to solve the aforementioned problem, an information processing method is a method executed by at least one computer that executes:
a process for allowing a player to select a nurturing-completed game medium that is used in a nurturing game and to which predetermined inheritance information is tied;
a process for executing the nurturing game, said process including at least a process for updating at least one parameter tied to a nurturing-target character and a process based on the nurturing-completed game medium selected by the player; and
a process for creating and storing, on the basis of completion of the nurturing game, the nurturing-completed game medium in which the at least one parameter and the inheritance information are tied to the nurturing-target character,
wherein the inheritance information includes specific inheritance information for increasing an upper limit of the at least one parameter, and
the process for executing the nurturing game increases the upper limit of a predetermined parameter in the case where the specific inheritance information is tied to the nurturing-completed game medium selected by the player.

In order to solve the aforementioned problem, a game device includes at least one computer that executes:
a process for allowing a player to select a nurturing-completed game medium that is used in a nurturing game and to which predetermined inheritance information is tied;
a process for executing the nurturing game, said process including at least a process for updating at least one parameter tied to a nurturing-target character and a process based on the nurturing-completed game medium selected by the player; and
a process for creating and storing, on the basis of completion of the nurturing game, the nurturing-completed game medium in which the at least one parameter and the inheritance information are tied to the nurturing-target character,
wherein the inheritance information includes specific inheritance information for increasing an upper limit of the at least one parameter, and
the process for executing the nurturing game increases the upper limit of a predetermined parameter in the case where the specific inheritance information is tied to the nurturing-completed game medium selected by the player.

### Effects of Disclosure

According to the present invention, it is possible to further encourage a player to play a game.

### BRIEF DESCRIPTION OF DRAWINGS

FIG. 1 is an illustration showing the schematic configuration of an information processing system.

FIG. 2A is a drawing for illustrating the hardware configuration of a player terminal.

FIG. 2B is a drawing for illustrating the hardware configuration of a server.

FIG. 3A is a drawing for illustrating an example of a home screen.

FIG. 3B is a drawing for illustrating an example of an option setting screen.

FIG. 3C is a drawing for illustrating an example of a profile setting screen.

FIG. 3D is a drawing for illustrating an example of a home setting screen.

FIG. 4 is a drawing for illustrating a general flow of proceeding of a nurturing game.

FIG. 5A is a drawing for illustrating an example of scenario initial addition value data.

FIG. 5B is a drawing for illustrating an example of scenario initial upper limit data.

FIG. 5C is a drawing for illustrating an example of scenario event addition value data.

FIG. 6A is a drawing for illustrating a nurturing-target-character selection screen.

FIG. 6B is a first drawing for illustrating a character details screen.

FIG. 6C is a second drawing for illustrating the character details screen.

FIG. 7A is a drawing for illustrating an ability parameter (initial value) table.

FIG. 7B is a drawing for illustrating an aptitude parameter (initial value) table.

FIG. 7C is a drawing for illustrating a skill table.

FIG. 7D is a drawing for illustrating a dedicated event table.

FIG. 8A is a first drawing for illustrating an inheritance character selection screen.

FIG. 8B is a first drawing for illustrating a nurtured character list screen.

FIG. 8C is a second drawing for illustrating the inheritance character selection screen.

FIG. 8D is a third drawing for illustrating the inheritance character selection screen.

FIG. 9 is a drawing for illustrating an inheritance line of descent.

FIG. 10 is a drawing for illustrating factor information.

FIG. 11A is a drawing for illustrating effectiveness resulting from a base ability factor.

FIG. 11B is a drawing for illustrating effectiveness resulting from a character factor.

FIG. 12A is a drawing for illustrating compatibility determination combinations, and FIG. 12B is a drawing for illustrating compatibility determination features.

FIG. 13A is a drawing for illustrating sort conditions.

FIG. 13B is a drawing for illustrating refining conditions.

FIG. 14 is a first drawing for illustrating a character details dialog.

FIG. 15 is a second drawing for illustrating the character details dialog.

FIG. 16 is a third drawing for illustrating the character details dialog.

FIG. 17 is a drawing for illustrating a skill display dialog.

FIG. 18A is a first drawing for illustrating a support card organization screen.

FIG. 18B is a drawing for illustrating a support card selection screen.

FIG. 18C is a second drawing for illustrating the support card organization screen.

FIG. 19A is a drawing for illustrating a support card table.

FIG. 19B is a drawing for illustrating a support effect table.

FIG. 19C is a drawing for illustrating a possessed skill table.

FIG. 19D is a drawing for illustrating a support event table.

FIG. 20A is a drawing for illustrating a final confirmation screen.

FIG. 20B is a drawing for illustrating a preset selection screen.

FIG. 21 is a drawing for illustrating electives for each turn.

FIG. 22 is a drawing for illustrating a game screen.

FIG. 23A is a first drawing for illustrating a training screen.

FIG. 23B is a second drawing for illustrating the training screen.

FIG. 23C is a drawing for illustrating a training result report screen.

FIG. 23D is a drawing for illustrating a special indication.

FIG. 24A is a drawing for illustrating an event screen.

FIG. 24B is a drawing for illustrating a special presentation.

FIG. 25A is a first drawing for illustrating a skill screen.

FIG. 25B is a second drawing for illustrating the skill screen.

FIG. 26A is a first drawing for illustrating a race selection screen.

FIG. 26B is a drawing for illustrating a race start screen.

FIG. 26C is a first drawing for illustrating a race result screen.

FIG. 26D is a second drawing for illustrating the race result screen.

FIG. 27A is a drawing for illustrating an example of a live preparation screen.

FIG. 27B is a drawing for illustrating a confirmation dialog.

FIG. 28 is a drawing for illustrating an example of a first bonus and a second bonus.

FIG. 29 is a drawing for illustrating an example of live-music-etc-routing information.

FIG. 30A is a drawing for illustrating an example of a live start screen.

FIG. 30B is a drawing for illustrating an example of a live event screen.

FIG. 31 is a drawing for illustrating the general flow of a turn-at-start process.

FIG. 32 is a drawing for illustrating a placement probability table.

FIG. 33A is a drawing for illustrating a training level table.

FIG. 33B is a drawing for illustrating an increase-fixed value (speed) table.

In addition, FIG. 33C is a drawing for illustrating an increase-fixed value table (power).

FIG. 33D is a drawing for illustrating a bonus addition rate table.

FIG. 34A is a drawing for illustrating performance features tied to training courses.

FIG. 34B is a drawing for illustrating increase-fixed values of performance parameters.

FIG. 34C is a drawing for illustrating bonus addition rates of performance parameters.

FIG. 35 is a drawing for illustrating a second event table.

FIG. 36A is a first drawing for illustrating a nurturing completion screen.

FIG. 36B is a second drawing for illustrating the nurturing completion screen.

FIG. 36C is a third drawing for illustrating the nurturing completion screen.

FIG. 37 is a drawing for illustrating the configuration of a memory in the player terminal and functions of the player terminal as a computer.

FIG. 38 is a drawing for illustrating the configuration of a memory in the server and functions of the server as a computer.

FIG. 39 is a sequence diagram for illustrating processes of the player terminal and the server related to a nurturing game.

FIG. 40 is a first flowchart for illustrating a preparatory-stage process in the player terminal.

FIG. 41 is a second flowchart for illustrating the preparatory-stage process in the player terminal.

FIG. 42 is a third flowchart for illustrating the preparatory-stage process in the player terminal.

FIG. 43 is a flowchart for illustrating a nurturing-stage process in the server.

FIG. 44 is a flowchart for illustrating the turn-at-start process in the server.

FIG. 45 is a flowchart for illustrating an invoking-factor decision process in the server.

FIG. 46 is a flowchart for illustrating an ability parameter decision process in the server.

FIG. 47 is a flowchart for illustrating the nurturing-stage process in the player terminal.

FIG. 48 is a flowchart for illustrating the turn-at-start process in the player terminal.

FIG. 49 is a flowchart for illustrating an in-turn process in the player terminal.

FIG. 50 is a flowchart for illustrating a command selection process in the player terminal.

FIG. 51 is a first flowchart for illustrating the in-turn process in the server.

FIG. 52 a second flowchart for illustrating the in-turn process in the server.

FIG. 53 is a flowchart for illustrating a command reception process in the player terminal.

FIG. 54 is a flowchart for illustrating a nurturing game end process in the server.

### DESCRIPTION OF EMBODIMENTS

An aspect of an embodiment of the present invention will be described below in detail with reference to the accompanying drawings. Numerical values, etc. given in this embodiment are merely examples for facilitating understanding, and do not limit the present invention unless otherwise specifically mentioned. In this description and the drawings, the same reference signs are attached to elements having substantially the same functions and configurations, omitting repeated descriptions thereof, and elements that are not directly related to the present invention are not shown.

(Overall Configuration of Information Processing system S)

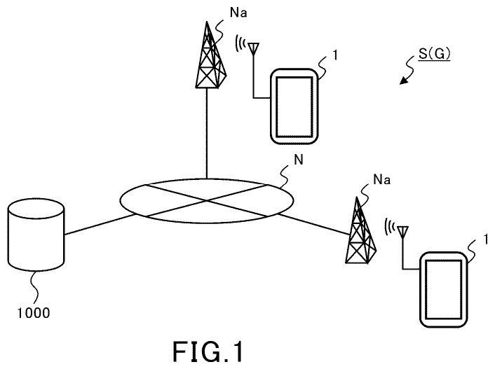

FIG. 1 is an illustration showing the schematic configuration of an information processing system S. The information processing system S is what is called a client-server system, including player terminals 1 functioning as clients (i.e., game terminals), a server 1000, and a communication network N having communication base stations Na.

In the information processing system S according to this embodiment, the player terminals 1 and the server 1000 each function as a game device G. The player terminals 1 and the server 1000 individually have assigned thereto roles for controlling the proceeding of the game such that it is possible to proceed with the game through cooperation between the player terminals 1 and the server 1000.

Each of the player terminals 1 can establish communication with the server 1000 via the communication network N. The player terminals 1 widely include electronic appliances that can be communicatively connected to the server 1000 by wire or wirelessly. Examples of the player terminals 1 include smartphones, mobile phones, tablet devices, personal computers, and game devices. This embodiment will be described by way of an example where each of the player terminals 1 is a smartphone.

The server 1000 is communicatively connected to the plurality of player terminals 1. The server 1000 accumulates various kinds of information for each player who plays a game. Furthermore, mainly on the basis of operations input from the player terminals 1, the server 1000 executes processes, such as updating the accumulated information and causing the player terminals 1 to download images and various kinds of information.

The communication base stations Na are connected to the communication network N, and transmit information to and receive information from the player terminals 1 wirelessly. The communication network N is configured of a mobile phone network, the Internet, a local area network (LAN), a dedicated circuit, or the like, and realizes wired or wireless communicative connection between the player terminals 1 and the server 1000.

### (Hardware Configuration of Player Terminal 1 and Server 1000)

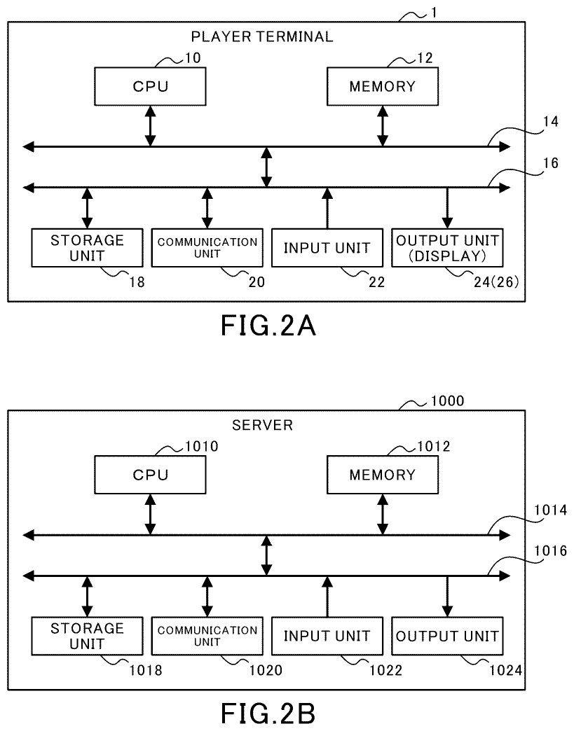

FIG. 2A is a drawing for illustrating the hardware configuration of a player terminal 1. In addition, FIG. 2B is a drawing for illustrating the hardware configuration of the server 1000. As shown in FIG. 2A, the player terminal 1 is configured to include a central processing unit (CPU) 10, a memory 12, a bus 14, an input/output interface 16, a storage unit 18, a communication unit 20, an input unit 22, and an output unit 24.

Furthermore, as shown in FIG. 2B, the server 1000 is configured to include a CPU 1010, a memory 1012, a bus 1014, an input/output interface 1016, a storage unit 1018, a communication unit 1020, an input unit 1022, and an output unit 1024.

Note that the configurations and functions of the CPU 1010, the memory 1012, the bus 1014, the input/output interface 1016, the storage unit 1018, the communication unit 1020, the input unit 1022, and the output unit 1024 of the server 1000 are substantially the same as those of the CPU 10, the memory 12, the bus 14, the input/output interface 16, the storage unit 18, the communication unit 20, the input unit 22, and the output unit 24, respectively, of the player terminal 1. Thus, a description of the hardware configuration of the player terminal 1 will be given below, and a description of the server 1000 will be omitted.

The CPU 10 runs programs stored in the memory 12 to control the proceeding of the game. The memory 12 is configured of a read only memory (ROM) or a random access memory (RAM), and stores the programs and various kinds of data needed for controlling the proceeding of the game. The memory 12 is connected to the CPU 10 via the bus 14.

The input/output interface 16 is connected to the bus 14. The storage unit 18, the communication unit 20, the input unit 22, and the output unit 24 are connected to the input/output interface 16.

The storage unit 18 is configured of a semiconductor memory, such as a dynamic random access memory (DRAM), and stores various kinds of programs and data. At the player terminal 1, the programs and data stored in the storage unit 18 are loaded into the memory 12 (RAM) by the CPU 10.

The communication unit 20 is communicatively connected to a communication base station Na wirelessly, and transmits/receives information, such as various kinds of data and programs, to/from the server 1000 via the communication network N. At the player terminal 1, the programs, etc. received from the server 1000 are stored in the memory 12 or the storage unit 18.

The input unit 22 is configured of, for example, a touchscreen, buttons, a keyboard, a mouse, a cross key, or an analog controller with which player operations are input (operations are accepted). Alternatively, the input unit 22 may be a special controller provided in the player terminal 1 or connected (externally attached) to the player terminal 1. Alternatively, the input unit 22 may be configured of an acceleration sensor that detects tilting or movement of the player terminal 1 or a microphone that detects speech of the player. That is, the input unit 22 widely includes devices that enable the player to input his/her intents in distinguishable manners.

The output unit 24 is configured to include a display device and a speaker. The output unit 24 may be a device connected (externally attached) to the player terminal 1. In this embodiment, the player terminal 1 is provided with a display 26 as the output unit 24 and is provided with a touchscreen as the input unit 22, wherein the touchscreen is overlaid on the display 26.

### (Game Content)

Next, a game provided by the information processing system S and a game device G according to this embodiment will be described. A player can possess characters earned by lottery, which is a so-called gacha, and characters distributed by the game administrator. Furthermore, the player can possess support cards earned by lottery and support cards distributed by the game administrator.

Although described below in detail, a nurturing game is provided in the game according to this embodiment. In the nurturing game, the player can nurture a character possessed by the player. In addition, the nurturing game according to this embodiment has gameplay in which the player nurtures a character by having the character run in a race simulating a horse race.

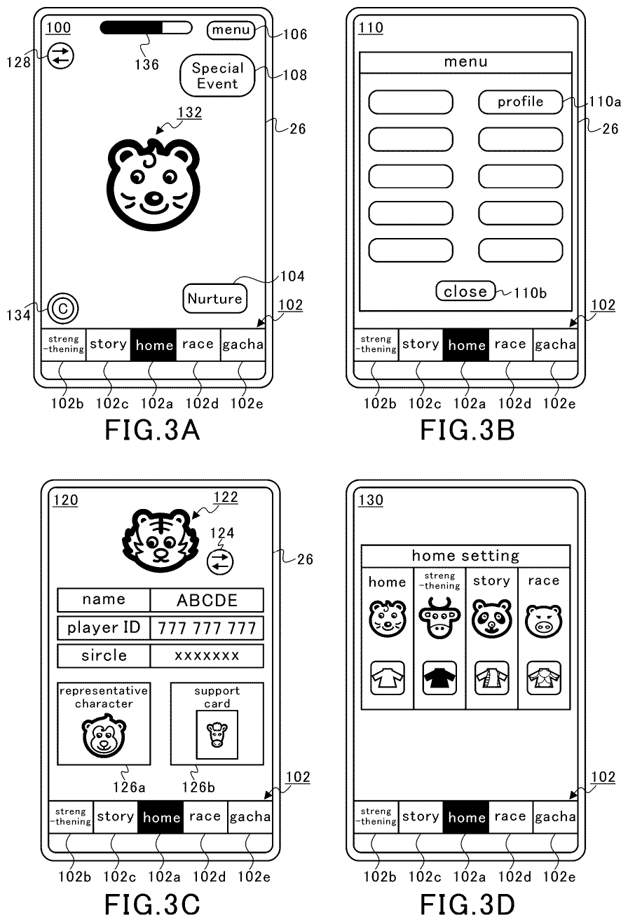

FIG. 3A is a drawing for illustrating an example of a home screen 100. When the game application is started at the player terminal 1, the home screen 100 is displayed on the display 26. In the lower section of the home screen 100, a menu bar 102 is displayed. A plurality of operation sections that can be operated (tapped) by the player are provided in the menu bar 102.

Here, a home screen selection operation section 102a, a strengthening screen selection operation section 102b, a story screen selection operation section 102c, a race game selection operation section 102d, and a gacha screen selection operation section 102e are provided in the menu bar 102. Note that in the menu bar 102, the operation section corresponding to the screen being displayed on the display 26 is highlighted so that the screen being displayed can be identified.

When the home screen selection operation section 102a is tapped, the home screen 100 shown in FIG. 3A is displayed on the display 26.

When the strengthening screen selection operation section 102b is tapped, a strengthening screen (not shown in the figure) is displayed. On the strengthening screen, it is possible to strengthen characters and support cards possessed by the player. The player can increase the levels set for characters and support cards by strengthening the characters and the support cards. Characters and support cards have various kinds of parameters set therefor, so that the parameters increase as the levels increase. As a result of parameters of characters and support cards increasing, the player can nurture a character having more powerful statuses in the nurturing game.

When the story screen selection operation section 102c is tapped, a story screen (not shown in the figure) is displayed. Here, a story image is provided for each of the characters appearing in the game. The player can select a character and a story image to view a story on the story screen.

When the race game selection operation section 102d is tapped, a race game selection screen (not shown in the figure) is displayed. This embodiment provides various race games in which a nurtured character nurtured in the nurturing game (described below) can be made to run. On the race game selection screen, the player can select a race game in which a nurtured character is made to run. Race games include a team competition game in which a team organized with a plurality of nurtured characters is made to compete against a team organized by another player selected by the computer. The team competition game has gameplay in which the player competes against other players for rankings.

When the gacha screen selection operation section 102e is tapped, a gacha screen (not shown in the figure) is displayed. On the gacha screen, the player can draw a so-called gacha lottery, in which a character and a support card can be earned by lottery by consuming in-game currency.

In addition, on the home screen 100, a nurturing game operation section 104 is provided above the menu bar 102. When the nurturing game operation section 104 is tapped, a nurturing game screen is displayed, whereby a nurturing game (described below) is started. The nurturing game is roughly classified into a preparatory stage and a nurturing stage, and the player first selects one of the characters possessed by himself/herself in the preparatory stage to set the selected character as a character to be nurtured (hereinafter, referred to as a nurturing-target character).

In the preparatory stage, the player also sets a deck to be used when nurturing the nurturing-target character. A deck is organized with a plurality of inheritance characters and a plurality of support cards (described below in detail). Therefore, in the nurturing game, the inheritance characters and the support cards organized in the deck are used.

When setting the nurturing-target character and the deck (inheritance characters and support cards) is completed, the preparatory stage transitions to the nurturing stage, whereby a game for nurturing the nurturing-target character is started. In the nurturing game, parameters of the nurturing-target character can be changed. The player can possess the character nurtured in the nurturing game as a nurtured character. As described above, the player can organize nurtured characters possessed by himself/herself into a team for use in a team competition game, etc.

Thus, the main objects of the game according to this embodiment are to nurture a nurtured character in a nurturing game and increase the ranking in a team competition game by using nurtured characters.

In addition, in this embodiment, a function for sharing a nurtured character or a support card among players and a function for sharing information among a plurality of players are provided. The player can set a nurtured character and a support card that can be used by other players in nurturing games. More specifically, as shown in FIG. 3A, a setting operation section 106 is provided in the upper right section of the home screen 100. When the setting operation section 106 is tapped, an option setting screen 110 is displayed.

FIG. 3B is a drawing for illustrating an example of the option setting screen 110. The option setting screen 110 is a screen that allows various kinds of information to be confirmed and set. A plurality of operation sections are provided on the option setting screen 110, so that when an operation section is tapped, information corresponding to the operation section can be confirmed and set.

The operation sections on the option setting screen 110 include a profile setting operation section 110a and a close operation section 110b. When the close operation section 110b is tapped, the option setting screen 110 is closed, and the home screen 100 is displayed. When the profile setting operation section 110a is tapped, a profile setting screen 120 is displayed.

FIG. 3C is a drawing for illustrating an example of the profile setting screen 120. On the profile setting screen 120, the player can confirm and set his/her own profile information. The profile information includes a profile character, a player name, a player ID, a circle to which the player belongs, a representative character, and a rental card.

The profile character functions as a character that is displayed when information concerning the player is viewed by another player. For example, the profile character is displayed when a circle function, which is a place for sharing information with other players, is used. On the profile setting screen 120, a currently set profile character image 122 is displayed. A change button 124 is provided near the profile character image 122. When the change button 124 is tapped, a profile character change screen (not shown in the figure) is displayed. On the profile character change screen, the player can change the profile character.

The player name set by the player, the player ID assigned to the player, and the name of the circle to which the player belongs are also displayed on the profile setting screen 120. In addition, a representative character setting operation section 126a and a rental card setting operation section 126b are provided on the profile setting screen 120.

When the representative character setting operation section 126a is tapped, a representative character setting screen (not shown in the figure) is displayed. On the representative character setting screen, the player can set, as a representative character, any one of the nurtured characters nurtured by himself/herself. In the representative character setting operation section 126a, an icon image indicating the currently set representative character is displayed. Although described below in detail, the representative character can be organized as an inheritance character in a deck in a nurturing game played by another player.

When the rental card setting operation section 126b is tapped, a rental card setting screen (not shown in the figure) is displayed. On the rental card setting screen, the player can set, as a rental card, any one of the support cards possessed by himself/herself. In the rental card setting operation section 126b, an icon image indicating the currently set rental card is displayed. Note that, as described above, the support card set as a rental card can be organized by another player in a deck and is used in a nurturing game played by the other player.

Although not described in detail, when a setting of the profile information is changed on the profile setting screen 120, setting change information is transmitted to the server 1000. In the server 1000, profile information for each player is saved.

As shown in FIG. 3A, a setting icon 128 is displayed on the home screen 100. When the setting icon 128 is tapped, a home setting screen 130 is displayed.

FIG. 3D is a drawing for illustrating an example of the home setting screen 130. On the home setting screen 130, the player can set home screen setting characters 132 to be displayed on the home screen 100. The player can set four home screen setting characters 132 to be displayed on the home screen 100.

Although not shown in the figure, when a leftward/rightward flick operation is input on the home screen 100, the screen displayed on the display 26, i.e., the display of the home screen 100, is switched. The four currently set home screen setting characters 132 are displayed on the home screen 100. The home screen setting characters 132 are assigned functions as respective operation sections displayed in the menu bar 102. Therefore, when a home screen setting character 132 displayed on the home screen 100 is tapped, the screen is switched in the same manner as when an operation section in the menu bar 102 is tapped.

On the home setting screen 130, character images corresponding to the four respective home screen setting characters 132 that are currently set, as well as corresponding operation sections, are displayed so as to be identifiable. When a character image displayed on the home setting screen 130 is tapped, a character selection screen (not shown in the figure) is displayed. The player can select a home screen setting character 132 on the character selection screen. Also, the player can set costumes for the home screen setting characters 132 on the home setting screen 130.

As shown in FIG. 3A, a circle icon 134 is displayed on the home screen 100. When the circle icon 134 is tapped, a circle screen is displayed. On the circle screen, the player can exchange information with other players belonging to the same circle.

In addition, various time-limited events are held irregularly in this embodiment. During the holding period of a specific event, which is a time-limited event, a specific event icon 108 is displayed on the home screen 100. When the specific event icon 108 is tapped, a specific event screen is displayed. On the specific event screen, the player can exchange specific event points, which are offered, for example, only during a specific event, for various rewards.

When the nurturing game operation section 104 is tapped on the home screen 100, the nurturing game screen is displayed, and a nurturing game is started. Note that the player can play a nurturing game by consuming game points. Game points are granted to the player every predetermined time (e.g., 10 minutes) by a predetermined value (e.g., +1). There is an upper limit (e.g., 100) on the number of game points the player can have, and the player can have game points within the range up to the upper limit. In the upper section of the home screen 100, a game point indication bar 136 is provided to visually indicate the percentage of currently possessed game points relative to the upper limit.

The game points are reduced by a predetermined value (e.g., −30) when a nurturing game is started. Therefore, the player cannot start a nurturing game if he/she does not have a required number of game points. It should be noted, however, that the player can possess an item that restores game points and can use the item to restore game points. This item can be granted, for example, as a reward for a nurturing game or team competition game or can be earned by consuming in-game currency. The nurturing game will be described below in detail.

### (Nurturing Game)

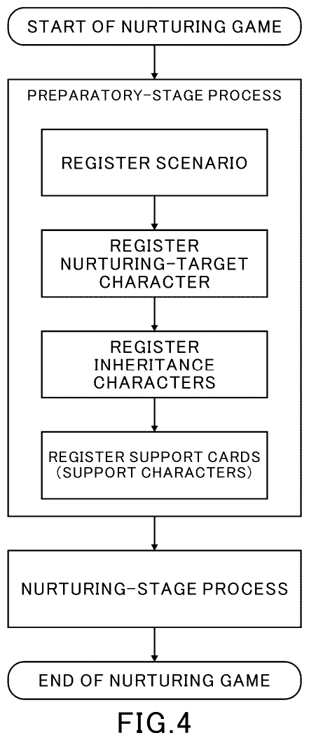

FIG. 4 is a drawing for illustrating a general flow of the nurturing game. The nurturing game is roughly classified into a setting game and a nurturing main game. Although described below in detail, the nurturing main game is a game in which one nurturing-target character selected from among the characters possessed by the player is nurtured as a nurturing-target character.

In addition, the setting game allows the player to register a scenario, a nurturing-target character, and a deck (inheritance characters and support cards), and corresponds to the preparatory stage of the nurturing game. Hereafter, the processes executed in the setting game are referred to as a preparatory-stage process, and the processes executed in the nurturing main game are referred to as a nurturing-stage process. Here, for the sake of ease of understanding, the general flow of the preparatory-stage process and the nurturing-stage process will be described first.

### <Preparatory-Stage Process>

In the preparatory-stage process, registration of a scenario, a nurturing-target character, and a deck (inheritance characters and support cards) is mainly performed. Note that support cards are used to assist in nurturing the nurturing-target character. Each of the support cards always has one character tied thereto, and the characters tied to the support cards that have been registered in the preparatory-stage process assist in nurturing the nurturing-target character. Hereafter, the character tied to a support card is referred to as a support character.

### <Registration of Scenario>

When the nurturing game operation section 104 is tapped by the player on the home screen 100, a scenario selection screen (not shown in the figure) is displayed. In this embodiment, a plurality of scenarios for the nurturing main game are provided. In each of the scenarios for the nurturing main game, a final goal, mid-game goals, etc. are set. The player needs to clear the goals set in each scenario one after another. Each of the scenarios has different goals, different time periods in which those goals are to be achieved, different difficulty levels, etc.

In addition, the nurturing main game has a storyline, so that the game proceeds along the story. Also, events occur at various timings during the nurturing main game. Events that occur during the nurturing main game include scenario-specific events. Therefore, at least some of the events that occur during the nurturing main game in one scenario differ from those in another scenario. The player can select one of the plurality of scenarios on the scenario selection screen.

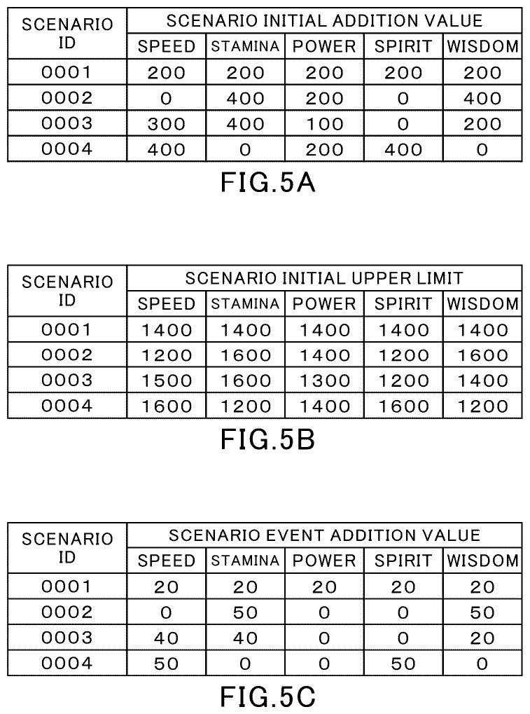

FIG. 5A is a drawing for illustrating an example of scenario initial addition value data. FIG. 5B is a drawing for illustrating an example of scenario initial upper limit data. FIG. 5C is a drawing for illustrating an example of scenario event addition value data. As shown in FIG. 5A, a unique scenario ID is tied to each of the scenarios. When the player selects a scenario on the scenario selection screen, the scenario ID tied to the selected scenario is registered. Here, four scenario IDs 0001 through 0004 are provided.

Although described below in detail, objects of the nurturing game include increasing ability parameters of the nurturing-target character. Here, five ability parameters, speed, stamina, power, spirit, and wisdom, are provided. The higher the values of these five ability parameters, the more advantageous to the nurturing-target character the proceeding of the race.

It should be noted, however, that each of the ability parameters has an upper limit set therefor, so that the value of each of the ability parameters is updated only within the range up to the upper limit thereof in the nurturing main game. The ability parameters are thus constrained from being updated to values exceeding the respective upper limits thereof. When the nurturing main game is started, an initial upper limit of each of the ability parameters is set. This initial upper limit differs from scenario to scenario. Note that the upper limit of each of the ability parameters may increase from the initial upper limit during the game.

Scenario initial addition value data is stored in the player terminal 1 and the server 1000. The scenario initial addition value data is data in which initial addition values of the five ability parameters are tied to each of the scenario IDs. In this embodiment, when a nurturing main game is started, the initial upper limits of the ability parameters are set on the basis of the scenario initial addition value data.

More specifically, a common base value is set in advance for the ability parameters. In this embodiment, “1200” is set as the common base value. This common base value is common to all scenarios and all ability parameters. It should be noted, however, that the common base value may differ from scenario to scenario, and may also differ for each of the ability parameters. Also, when the nurturing main game is started, the scenario initial addition values corresponding to the scenario selected by the player are added to the common base value, thus setting an initial upper limit of each of the ability parameters.

As shown in, for example, FIG. 5A, according to the scenario initial addition value data, the scenario initial addition values of all the five ability parameters tied to scenario ID “0001” are set as “200”. Therefore, in the case where a nurturing main game is started with scenario ID “0001” selected, the initial upper limits of all the five ability parameters are “1400”.

In addition, in the case where a nurturing main game is started with, for example, scenario ID “0002” selected, the initial upper limits of the speed and spirit ability parameters are “1200”, which is the common base value, the initial upper limits of the stamina and wisdom ability parameters are “1600”, and the initial upper limit of the power ability parameter is “1400”.

Note that here, initial upper limits are derived by adding the initial addition values of the ability parameters to the common base value. It should be noted, however, that scenario initial upper limit data as shown in FIG. 5B may be provided, so that the initial upper limits of the ability parameters can be derived on the basis of the scenario initial upper limit data. According to the scenario initial upper limit data, the initial upper limits of each of the five ability parameters are tied to respective scenario IDs. The values of the initial upper limits tied to each of the scenario IDs in the scenario initial upper limit data are values obtained by adding the initial addition values in the scenario initial addition value data to the common base value.

Thus, the scenario initial upper limits tied to each of the scenario IDs may be set as the initial upper limits of the ability parameters. Alternatively, values obtained by adding the scenario initial addition values to the common base value may be set as the initial upper limits of the ability parameters.

In addition, in the nurturing main game, a scenario event for increasing the upper limit of each of the ability parameters can occur at a predetermined timing. When a scenario event occurs, the scenario event addition values tied to that scenario event are added to the upper limits at that time. When a predetermined scenario event occurs in a nurturing main game with, for example, scenario ID “0001”, the upper limits of the five ability parameters increase by “20”.

As shown in FIG. 5C, the upper limits of ability parameters that increase due to a scenario event differ from scenario to scenario. Note that one scenario may have two or more scenario events for increasing the upper limits of the ability parameters or may have no such scenario events. Also, the timings at which scenario events occur may be common or differ among all scenarios.

Thus, the upper limits of the ability parameters differ depending on the scenario selected by the player. Consequently, characters having abilities and properties different from scenario to scenario can be nurtured. This further encourages the player to play the game with various scenarios.

### <Registration of Nurturing-Target Character>

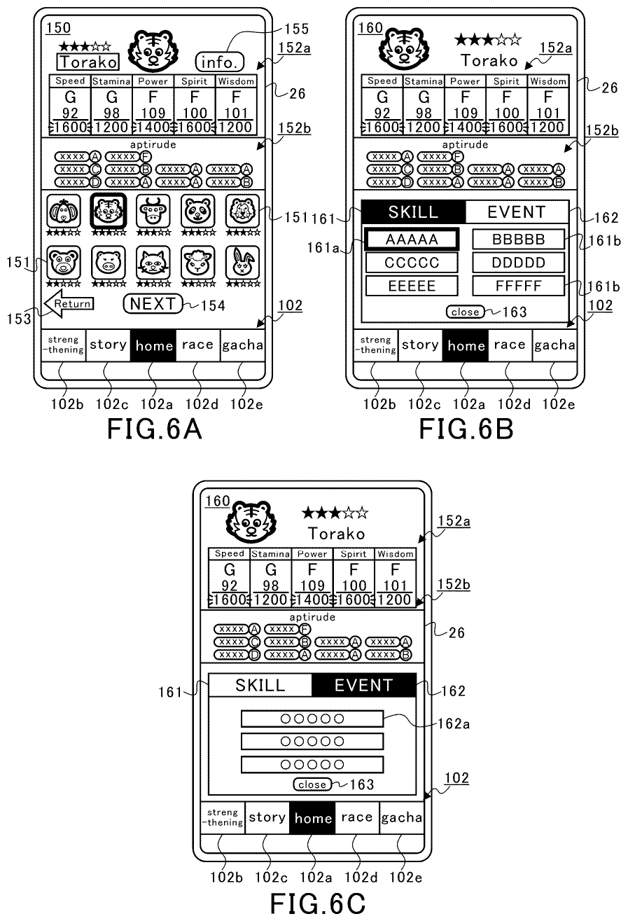

FIG. 6A is a drawing for illustrating a nurturing-target-character selection screen 150. When the player selects a scenario on the scenario selection screen, the nurturing-target-character selection screen 150 shown in FIG. 6A is displayed. In the center of the nurturing-target-character selection screen 150, a plurality of character icons 151 are displayed, showing a list of the characters possessed by the player.

In addition, in the upper section of the nurturing-target-character selection screen 150, an ability parameter display section 152a and an aptitude parameter display section 152b are displayed. A return operation section 153 captioned “Return” and a next operation section 154 captioned “NEXT” are also displayed in the lower section of the nurturing-target-character selection screen 150.

In this embodiment, initial values of the ability parameters are set for each character. The initial values of the ability parameters of the character corresponding to a character icon 151 selected by the player are displayed as numerical values in the ability parameter display section 152a. In this embodiment, the larger the numerical value of an ability parameter, the higher the ability.

In addition, the initial upper limit of each of the ability parameters is displayed in the ability parameter display section 152a. In other words, in a state in which the player can select a scenario or after the player has selected a scenario, the upper limit of each of the ability parameters that is set when the nurturing main game is started is displayed in the ability parameter display section 152a. In the ability parameter display section 152a, the initial upper limits corresponding to the scenario selected by the player are displayed as denominators, and the initial values of the ability parameters of the character selected by the player are displayed as numerators.

Here, in the ability parameter display section 152a, the initial upper limits exceeding the common base value are identifiably indicated. In the example shown in FIG. 6A, the initial upper limits of speed, power, and spirit exceeds “1200”, which is the common base value. Therefore, in the ability parameter display section 152a, the initial upper limits of speed, power, and spirit are identifiably indicated in contrast to the initial upper limits of stamina and wisdom. Here, an identifiable indication of the initial upper limits exceeding the common base value includes blinking and display in a different color.

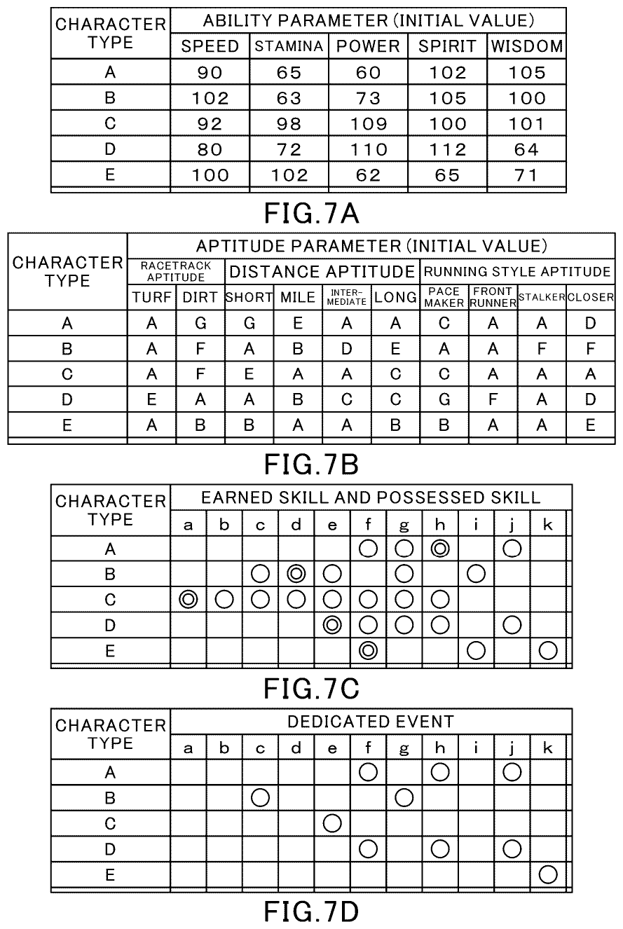

FIG. 7A is a drawing for illustrating an ability parameter (initial value) table. In this embodiment, as shown in FIG. 7A, the initial values of the ability parameters for each character are stored in the ability parameter (initial value) table. Also, on the basis of the initial values of the ability parameters stored in the ability parameter (initial value) table, the initial values of the ability parameters are displayed in the ability parameter display section 152a.

In this embodiment, the initial values of a plurality of kinds of ability parameters indicating the respective abilities are set for each character. More specifically, the ability parameters include: a speed ability parameter captioned “Speed” in the ability parameter display section 152a; a stamina ability parameter captioned “Stamina” in the ability parameter display section 152a; a power ability parameter captioned “Power” in the ability parameter display section 152a; a spirit ability parameter captioned “Spirit” in the ability parameter display section 152a; and a wisdom ability parameter captioned “Wisdom” in the ability parameter display section 152a.

Note that the initial values of the ability parameters for each character are increased via a player operation, etc. For example, each character has five status levels, so that the player can increase the status level of a character by consuming in-game currency or predetermined items. The initial values of the ability parameters of a character increase as the status level of the character increases.

FIG. 7A shows initial values in the case where the characters have a predetermined level. Note that the player can increase the values of ability parameters in the nurturing main game. Namely, an object of the nurturing main game is to nurture a character with larger numerical values of the ability parameters.

In addition, aptitude parameters (initial values) are set for each character in this embodiment. Initial values of the aptitude parameters of the character corresponding to the character icon 151 selected by the player are displayed as letters in the aptitude parameter display section 152b, as shown in FIG. 6A.

FIG. 7B is a drawing for illustrating an aptitude parameter (initial value) table. In this embodiment, the initial values of the aptitude parameters for each character are stored in the aptitude parameter (initial value) table, as shown in FIG. 7B. The initial value of each of the aptitude parameters is set as one of seven stages from letters A to G. Note that the initial value A of an aptitude parameter indicates the highest aptitude, and the initial value G of the aptitude parameter indicates the lowest aptitude. The initial values of the aptitude parameters are displayed in the aptitude parameter display section 152b on the basis of the initial values of the aptitude parameters stored in the aptitude parameter (initial value) table.

In this embodiment, the initial values of a plurality of kinds of aptitude parameters indicating the respective aptitudes are set for each character. More specifically, the aptitude parameters include: aptitude parameters related to a racetrack aptitude (turf track and dirt track); aptitude parameters related to a distance aptitude (short distance, mile, intermediate distance, and long distance); and aptitude parameters related to a running style aptitude (pace maker, front runner, stalker, and closer).

In the nurturing game, the player can allow the nurturing-target character to run in various races. At this time, the higher the aptitude of the nurturing-target character matching the race content is, the more advantageously the race proceeds.

It is also acceptable that the initial values of the aptitude parameters for each character can be increased by consuming in-game currency. In addition, the value of an aptitude parameter may change in the nurturing main game. In addition, there may be some cases where an aptitude parameter is set as S, which indicates a higher aptitude than A, in the nurturing main game.

FIG. 6B is a first drawing for illustrating a character details screen 160. In addition, FIG. 6C is a second drawing for illustrating the character details screen 160. When a character icon 151 on the nurturing-target-character selection screen 150 is pressed and held, the character details screen 160 is displayed on the display 26. On the character details screen 160, details of the abilities of the character corresponding to the character icon 151 that was pressed and held on the nurturing-target-character selection screen 150 are displayed.

In the center of the character details screen 160, a skill operation section 161 and an event operation section 162 are displayed. As shown in FIG. 6B, when the character details screen 160 is displayed, the skill operation section 161 is initially highlighted, and skills provided for the character are displayed. A skill is an ability that may be invoked in the case where a predetermined condition is satisfied while a race (described below) is being executed. When a skill is invoked, the race proceeds advantageously to each character.

FIG. 7C is a drawing for illustrating a skill table. As shown in FIG. 7C, skills for each of the characters possessed by the player are stored in the skill table. Also, skills are displayed on the character details screen 160, as shown in FIG. 6B, on the basis of the skills stored in the skill table. Note that merely possessing a skill does not allow the skill to be invoked-a skill can be invoked only after it has been earned. Hereinafter, a skill that is ready to be invoked by a character is referred to as an earned skill.

One earned skill is set for a character from the beginning of the nurturing main game. In addition, a plurality of possessed skills are set for the character, besides the one earned skill. A possessed skill is a skill that can be earned by consuming skill points (described below) after the start of the nurturing main game. In short, a possessed skill can become an earned skill in exchange for skill points.

In this embodiment, the skill indicated with a double circle in the skill table shown in FIG. 7C is displayed as the earned skill on the character details screen 160 in FIG. 6B. In addition, the skills indicated with a circle in the skill table shown in FIG. 7C are displayed as the possessed skills on the character details screen 160 in FIG. 6B. In this embodiment, the earned skill is highlighted so that it can be easily distinguished from the possessed skills, as shown on the character details screen 160 in FIG. 6B.

Although FIG. 6B is shown by way of an example where one earned skill and seven possessed skills are displayed in an earned-skill display field 161a and possessed-skill display fields 161b, respectively, as the skills provided for each character, the present invention is not limited to this example. For example, the number of earned skills and the number of possessed skills may differ for each character. Also, for example, the number of earned skills or possessed skills for each character may increase with an increase in the level of the character, consumption of in-game currency or items, etc.

In addition, when the player taps the event operation section 162 on the character details screen 160, the content of the character details screen 160 is switched to display dedicated-event display fields 162a indicating dedicated events provided for the character, as shown in FIG. 6C. In this case, the event operation section 162 is highlighted, as shown in FIG. 6C. A dedicated event occurs when a predetermined condition is satisfied in the nurturing main game, and displays a story related to a character appearing in the nurturing game or changes the value of an ability parameter.

FIG. 7D is a drawing for illustrating a dedicated event table. As shown in FIG. 7D, dedicated events for each of the characters possessed by the player are stored in the dedicated event table. Also, on the basis of the dedicated events stored in the dedicated event table, the dedicated events are displayed on the character details screen 160, as shown in FIG. 6C. Note that the dedicated events may include a hint event that enables possession or earning of a skill, an ability event that increases or decreases the numerical values of ability parameters of the character, etc.

Regarding the dedicated events displayed on the character details screen 160 shown in FIG. 6C, all of the dedicated events may be allowed to occur during execution of the nurturing main game, at least some of the dedicated events may be allowed to occur during execution of the nurturing main game, or none of the dedicated events may be allowed to occur during execution of the nurturing main game if the predetermined condition is not satisfied. Also, for example, the number of dedicated events provided for each character may increase with an increase in the level of the character, consumption of in-game currency or items, etc. It is also acceptable that when a predetermined condition is satisfied, a dedicated event that is not displayed as a dedicated event is executed during the nurturing main game.

In addition, as shown in FIGS. 6B and 6C, a close operation section 163 captioned “close” is displayed in the lower section of the character details screen 160. In the case where the close operation section 163 on the character details screen 160 is tapped, the character details screen 160 disappears, and the nurturing-target-character selection screen 150 is displayed on the display 26.

In addition, when the return operation section 153 is tapped on the nurturing-target-character selection screen 150 shown in FIG. 6A, the scenario selection screen (not shown in the figure) is displayed on the display 26. A nurturing information display button 155 is also provided on the nurturing-target-character selection screen 150. When the nurturing information display button 155 is tapped, a nurturing information display screen (not shown in the figure) is displayed. On the nurturing information display screen, the player can confirm information concerning the character selected on the nurturing-target-character selection screen 150.

A clearance goal tab is provided on the nurturing information display screen. Here, an object of the nurturing game is to create a more powerful nurtured character by nurturing a character selected as a nurturing-target character from among the characters possessed by the player. Although described below in detail, a nurturing main game is composed of a plurality of turns, and the player needs to make the nurturing-target character do training and run in a race in each of the turns.

Also, each of the characters has a plurality of clearance goals set therefor. When the clearance goal tab is tapped, the clearance goals set for the currently selected character are listed on the nurturing information display screen. In each of the turns, a race that allows the nurturing-target character to run therein is defined in advance.

Also, when the nurturing-target character is made to run in a race, the nurturing-target character can earn fans, victory points, and special currency. In each of the races, the number of base earnings of fans, victory points, and special currency is defined for each finish place, and the higher the finish place, the larger the number of earned fans and the larger the numerical values of the victory points.

Races also have difficulty levels set therefor, and the higher the difficulty level of a race, the more fans and victory points the player can earn in the race. For example, some races are called high-stakes races, having GI, GII, and GIII grades. The grade becomes higher in the order of GIII, GII, and GI. The higher the grade of a race, the higher the difficulty level of the race, and the more fans and victory points the player can earn in the race.

Here, the number of fans the player can earn by participating in a race is calculated by adding the number of bonus earnings to the number of base earnings defined for each finish place. More specifically, a correction value is decided on the basis of a race result, and the number of base earnings is multiplied by the correction value to calculate the number of bonus earnings. The sum of this number of bonus earnings and the number of base earnings is the number of fans earned by the nurturing-target character. In the case where the race result indicates, for example, the first place, the larger the difference between the nurturing-target character and the character that has won the second place, the larger the correction value. Also, in the case where the race result indicates one of the second to fifth places, the smaller the difference between the nurturing-target character and the character that has won the first place, the larger the correction value.

In addition, the nurturing-target character invokes a skill at a predetermined probability during a race. At this time, the larger the number of invoked skills, the larger the correction value. Thus, a condition for adding the number of fans is defined in each of the races, and the number of earned fans increases depending on various race results other than the finish place and a midway state of the race. It should be noted, however, that the number of fans earned by the nurturing-target character is at least the number of base earnings corresponding to the finish place.

Note that a certain number of fans may be specified as a race-participating condition in some races. In this case, if the number of fans earned by the nurturing-target character is less than the number of fans specified as a race-participating condition, the player cannot allow the nurturing-target character to run in the race. The higher the difficulty level of a race, the larger the number of fans required to allow the nurturing-target character to run in the race.

Thus, each of the characters has a plurality of clearance goals set therefor. The player can continue the nurturing main game until the last turn by achieving the clearance goals. On the other hand, in the case where the player fails to achieve a clearance goal, the nurturing main game ends at the turn.

Thus, the player can select a nurturing-target character while confirming various items of information concerning each of the characters on the nurturing-target-character selection screen 150 shown in FIG. 6A. Also, when the next operation section 154 is tapped on the nurturing-target-character selection screen 150, the currently selected character is set as a nurturing-target character, and an inheritance character selection screen 170 is displayed on the display 26.

### <Registration of Inheritance Characters>

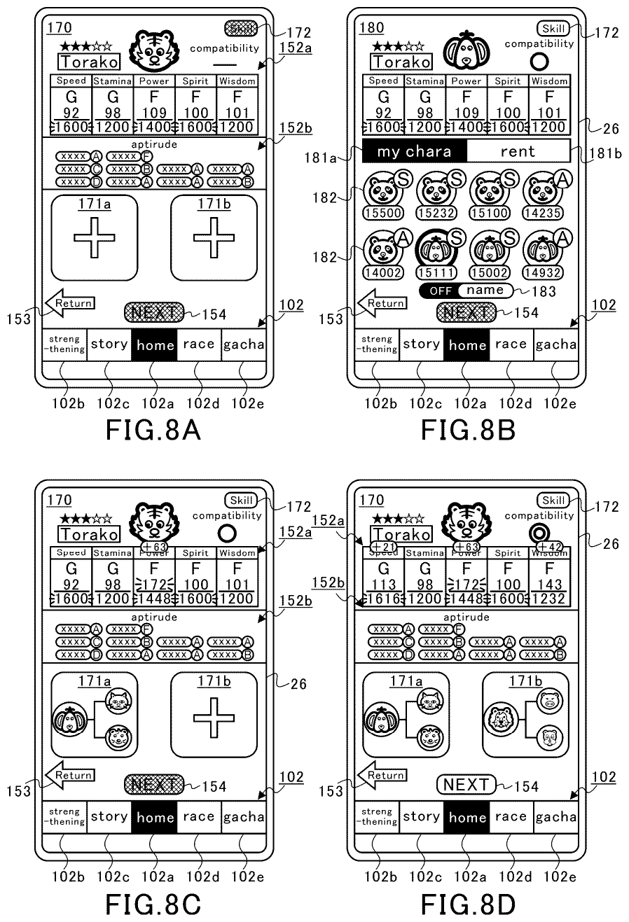

FIG. 8A is a first drawing for illustrating the inheritance character selection screen 170. FIG. 8B is a first drawing for illustrating a nurtured character list screen 180. FIG. 8C is a second drawing for illustrating the inheritance character selection screen 170. FIG. 8D is a third drawing for illustrating the inheritance character selection screen 170. The inheritance character selection screen 170 is a screen for the player to register inheritance characters.

An inheritance character is a character from which the nurturing-target character inherits ability values, skills, etc. The player can select two inheritance characters from among the nurtured characters possessed by himself/herself, as well as from among the representative characters of other players extracted according to a predetermined extraction condition, such as the representative characters of friends typified by followers, thereby organizing and registering the selected inheritance characters in the deck. Note that only one representative character of another player can be organized as an inheritance character in the deck in one nurturing game.

The ability parameter display section 152a, the aptitude parameter display section 152b, a first inheritance character selection region 171a, and a second inheritance character selection region 171b are provided on the inheritance character selection screen 170. When the screen transitions from the nurturing-target-character selection screen 150 to the inheritance character selection screen 170, the first inheritance character selection region 171a and the second inheritance character selection region 171b are displayed blank, as shown in FIG. 8A.

When the first inheritance character selection region 171a or the second inheritance character selection region 171b is tapped, the nurtured character list screen 180 shown in FIG. 8B is displayed. A my character tab 181a and a rental tab 181b are provided on the nurtured character list screen 180. In addition, a nurtured character list display region is provided below the my character tab 181a and the rental tab 181b. Nurtured character icons 182 are displayed in the nurtured character list display region.

While the my character tab 181a is selected, the nurtured character icons 182 corresponding to the nurtured characters possessed by the player himself/herself are displayed, as shown in FIG. 8B. Also, although not shown in the figure, the nurtured character icons 182 corresponding to the representative characters of friends, i.e., nurtured characters that have been nurtured by the friends, are displayed while the rental tab 181b is selected.

In addition, when a nurtured character icon 182 is tapped, the nurtured character corresponding to the nurtured character icon 182 is temporarily selected. When the nurtured character icon 182 is tapped, the inheritance character selection screen 170 is also displayed, as shown in FIG. 8C. At this time, for example, if the nurtured character list screen 180 is displayed as a result of the first inheritance character selection region 171a being tapped and a nurtured character icon 182 is tapped on the nurtured character list screen 180, then an image indicating the nurtured character that has been temporarily selected is displayed in the first inheritance character selection region 171a.

In this state, for example, if the nurtured character list screen 180 is displayed as a result of the second inheritance character selection region 171b being tapped and a nurtured character icon 182 is tapped on the nurtured character list screen 180, then an image indicating the nurtured character that has been temporarily selected is displayed in the second inheritance character selection region 171b, as shown in FIG. 8D.

In addition, information concerning the inheritance characters used when a nurtured character was nurtured is stored so as to be tied to the nurtured character. In the first inheritance character selection region 171a, information concerning the inheritance characters used when the nurtured character was nurtured is displayed.

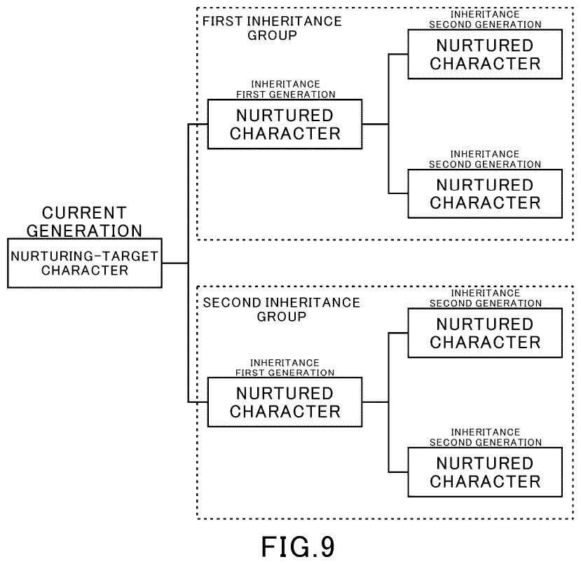

FIG. 9 is a drawing for illustrating an inheritance line of descent. In a nurturing game, various kinds of effectiveness are achieved on the basis of factor information possessed by the inheritance characters, such as an increase in the values of ability parameters and aptitude parameters of the nurturing-target character. Here, two inheritance characters are set for one nurturing-target character. These inheritance characters are nurtured characters created before. Therefore, when a nurtured character set as an inheritance character was created, the nurtured character also had two inheritance characters set therefor.

As shown in FIG. 9, the nurturing-target character in the nurturing main game that will be started from now is assumed to be the current generation. In addition, two nurtured characters set as inheritance characters for this nurturing-target character are assumed to be the inheritance first generation. Furthermore, when nurturing of each of the nurtured characters of the inheritance first generation was started, two nurtured characters were set as inheritance characters. The two nurtured characters set as inheritance characters when each of the nurtured characters of the inheritance first generation was created are assumed to be the inheritance second generation.

In this case, the nurtured characters of the inheritance first generation and the inheritance second generation give effectiveness to the nurturing-target character of the current generation, as shown in FIG. 9. As described above, because two inheritance characters (inheritance first generation) are set for one nurturing-target character, a total of six nurtured characters give effectiveness to the one nurturing-target character.

For example, a first inheritance group is composed of one of the two nurtured characters of the inheritance first generation and the two nurtured characters of the inheritance second generation serving as the inheritance characters of this nurtured character. Similarly, a second inheritance group is composed of the other of the two nurtured characters of the inheritance first generation and the two nurtured characters of the inheritance second generation serving as the inheritance characters of this nurtured character.

As shown in FIG. 8D, the first inheritance character selection region 171a contains icons corresponding to the one nurtured character of the inheritance first generation and the two nurtured characters of the inheritance second generation, respectively, that constitute the first inheritance group. Similarly, the second inheritance character selection region 171b contains icons corresponding to the one nurtured character of the inheritance first generation and the two nurtured characters of the inheritance second generation, respectively, that constitute the second inheritance group.

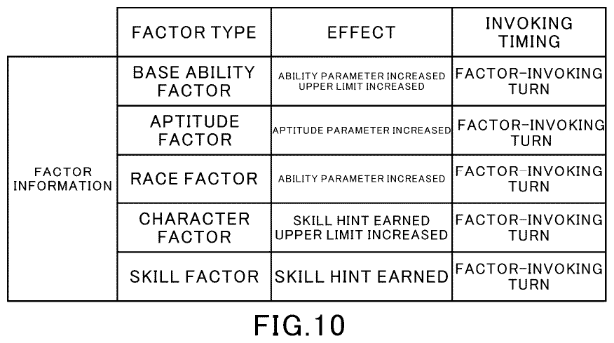

FIG. 10 is a drawing for illustrating factor information. Although described below in detail, when the nurturing game is completed, the nurturing-target character is registered as a nurtured character, and at this time, factor information is stored so as to be tied to the nurtured character. More specifically, when nurturing of the nurtured character is completed, factors to be earned by the nurtured character are decided by lottery. Also, factor information indicating the factors won by lottery is tied to the nurtured character. In other words, when the nurturing game is completed, the nurtured character can earn the factors won by lottery.

It should be noted, however, that the factors earned by the nurtured character do not affect the abilities themselves of the nurtured character. For example, the nurtured character can be made to run in a race game, such as a team competition game. At this time, in the race, simulation, i.e., computation for deciding the finish places and race proceeding is executed on the basis of the ability parameters, aptitude parameters, earned skills, etc. of all nurtured characters running in the race. Factors possessed by the nurtured characters are not used for computation, and even if a nurtured character has many factors, the race does not proceed advantageously to the nurtured character.

Factors possessed by a nurtured character affect only the nurturing-target character in the case where the nurtured character is set as an inheritance character. Factors that can be earned by a nurtured character are classified into a plurality of types. FIG. 10 shows factor types: a base ability factor, an aptitude factor, a race factor, a character factor, and a skill factor. One of a plurality of stages is set for each of the factors. Here, three stages of factor level, including level 1, level 2, and level 3, are provided as factor stages.

Note that the factor level is decided by lottery. At this time, after factors to be earned by the nurtured character are decided, a factor level may be decided by lottery for each of the earned factors. Alternatively, a winning rate may be set for each of the combination patterns of factors and factor levels, so that any of the combination patterns can be decided on the basis of the set winning rate. In this case, factors to be earned and factor levels are decided simultaneously.

The factor level has level 3 as the most effective level and level 1 as the least effective level. In a lottery for deciding a factor level, level 3 is set to have the lowest winning probability, and level 1 is set to have the highest winning probability. It should be noted, however, that the winning probability of a factor to be earned and the winning probability of a factor level may change depending on the result of the nurturing game. In this case, a factor level may be decided so that, for example, the higher an ability parameter and an evaluation score of the nurtured character, the higher the factor level.

The base ability factor increases the value of an ability parameter and the upper limit of an ability parameter of the nurturing-target character. The base ability factor has five factors: a speed factor, a stamina factor, a power factor, a spirit factor, and a wisdom factor. A nurtured character always earns one of the five base ability factors. The five base ability factors correspond to the five ability parameters: speed, stamina, power, spirit, and wisdom, respectively. In the case where a nurtured character of the inheritance first generation or the inheritance second generation has, for example, a speed factor, the value and the upper limit of the speed ability parameter of the nurturing-target character increase.

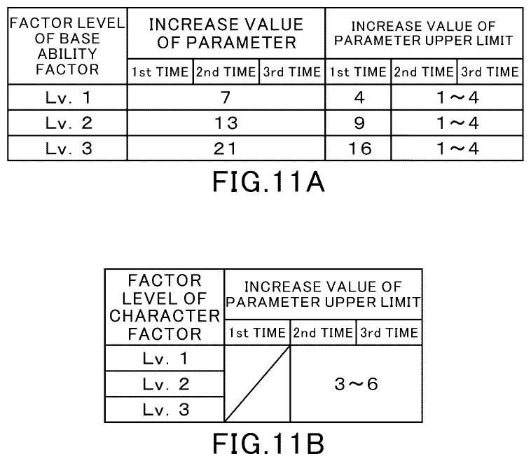

FIG. 11A is a drawing for illustrating effectiveness resulting from the base ability factor. The increase value of each of the ability parameters and the increase value of the upper limit of each of the ability parameters differ depending on the factor level of the base ability factor. For example, the speed ability parameter of the nurturing-target character increases by “7” in the case where the factor level of the speed factor is level 1, the ability parameter increases by “13” in the case where the factor level of the speed factor is level 2, and the ability parameter increases by “21” in the case where the factor level of the speed factor is level 3.

Therefore, in the case where a total of six nurtured characters, including the two nurtured characters of the inheritance first generation and the four nurtured characters of the inheritance second generation, all have a speed factor of level 3, the speed ability parameter of the nurturing-target character increases by a maximum of 126 (increase value 21×six characters).

It should be noted, however, that each of the factors has an invoking timing and an invoking condition set therefor. Therefore, even if an inheritance character has a factor, no effectiveness is given to the nurturing-target character in the case where the invoking condition is not satisfied at the invoking timing.

As described above, a nurturing main game is composed of a plurality of turns, and predetermined turns among those turns are set as factor-invoking turns. Suppose that three turns of the nurturing main game, e.g., the first turn, the 30th turn, and the 54th turn, are set as factor-invoking turns. In this case, the first turn serves as the first invoking timing, the 30th turn serves as the second invoking timing, and the 54th turn serves as the third invoking timing. In each of the factor-invoking turns, it is decided whether or not to invoke each of the factors (inheritance characters), and in the case where it is decided to invoke a factor, the invoking condition of that factor is satisfied, thus achieving effectiveness corresponding to the factor.

Note that whether or not to invoke a base ability factor is decided by lottery. At this time, the probability of winning a lottery for deciding whether or not to invoke a base ability factor, i.e., the probability of invoking the base ability factor (hereinafter, referred to as an invoking probability) may differ among the three factor-invoking turns. Here, in the first turn, the invoking probability of a base ability factor is set to 100%, regardless of the factor level. In addition, in the 30th turn and the 54th turn, the invoking probability of a base ability factor differs depending on the factor level. As an example, in the 30th turn and the 54th turn, the invoking probability of a base ability factor of level 3 is set to 100%, the invoking probability of a base ability factor of level 2 is set to 90%, and the invoking probability of a base ability factor of level 1 is set to 80%.

On the inheritance character selection screen 170, an increase value by which an ability parameter increases in the first turn is displayed. For example, one inheritance character constituting the first inheritance group is temporarily selected in FIG. 8C. In this case, the kind of an ability parameter that increases in the first turn due to the one inheritance character that is temporarily selected, as well as an increase value of the ability parameter, is displayed. Here, “+63” is displayed above the power ability parameter, indicating that the power ability parameter increases by 63 points in the first turn. In addition, the ability parameter display section 152a shows a value resulting from the increase value brought about in the first turn being added.

In addition, two inheritance characters constituting the first inheritance group and the second inheritance group are temporarily selected in FIG. 8D. In this case, the kinds of ability parameters that increase in the first turn due to the two inheritance characters that are temporarily selected, as well as increase values of the ability parameters, are displayed. Here, “+21”, “+63”, and “+42” are displayed above the speed, power, and wisdom ability parameters, respectively, indicating that the speed, power, and wisdom ability parameters increase by 21 points, 63 points, and 42 points, respectively, in the first turn.

Note that on the inheritance character selection screen 170, an increase value of the ability parameter that increases due to the inheritance character constituting the first inheritance group and increase values of the ability parameters that increase due to the inheritance character constituting the second inheritance group are displayed identifiably. For example, in FIG. 8D, the “+63” indication displayed above the power ability parameter and the “+21” and “+42” indications displayed above the speed ability parameter and the wisdom ability parameter are differentiated by color.

In addition, when a base ability factor is invoked, the upper limit of the corresponding ability parameter increases. At this time, the increase value of the upper limit of the ability parameter differs depending on the factor level of the base ability factor. Also, the increase value of the upper limit of the ability parameter differs depending on the invoking timing. In the case where the factor level of the speed factor is, for example, level 1, the upper limit of the speed ability parameter of the nurturing-target character increases by “4” at the first invoking timing, and increases in the range of “1” to “4” at the second and third invoking timings.

Furthermore, in the case where the factor level of the speed factor is level 2, the upper limit of the speed ability parameter of the nurturing-target character increases by “9” at the first invoking timing, and increases in the range of “1” to “4” at the second and third invoking timings. Moreover, in the case where the factor level of the speed factor is level 3, the upper limit of the speed ability parameter of the nurturing-target character increases by “16” at the first invoking timing, and increases in the range of “1” to “4” at the second and third invoking timings.

Note that here, the upper limit of the ability parameter always increases by the increase value corresponding to the factor level at the first invoking timing. At the second and third invoking timings, on the other hand, a lottery for deciding whether or not to invoke a base ability factor is drawn. In the case where it is decided that a base ability factor is invoked, a lottery for deciding an increase value of the upper limit is drawn. At this time, the base ability factor may be set such that the higher the factor level, the higher the probability at which the factor is decided to be invoked. Furthermore, the base ability factor may be set such that the higher the factor level, the larger the increase value of the upper limit.

Also, whether or not to invoke base ability factors may be decided separately for each factor or may be decided separately for each type of effectiveness. For example, it is assumed that one base ability factor has been decided to be invoked in the case where whether or not to invoke base ability factors is decided separately for each factor. In this case, the value of the corresponding ability parameter, as well as the upper limit of the same ability parameter, increases according to the factor level.

On the other hand, in the case where whether or not to invoke one base ability factor is decided for each type of effectiveness, whether or not to increase the value of the ability parameter is decided by one lottery, and whether or not to increase the upper limit of the ability parameter is decided by another lottery. In this case, therefore, it is possible that only one of the value and the upper limit of the ability parameter increases. In any case, base ability factors are always invoked at the first invoking timing in this embodiment. This ensures that the values and upper limits of ability parameters increase according to the factor levels when a nurturing main game is started.

Also, as shown in FIG. 8C and FIG. 8D, the initial upper limits of ability parameters displayed in the ability parameter display section 152a of the inheritance character selection screen 170 are updated to reflect the addition values by which the upper limits increase due to base ability factors. Thus, an initial upper limit of an ability parameter is displayed by counting the scenario initial addition value and the addition value due to a base ability factor, thereby improving convenience for selecting an inheritance character.

The aptitude factor shown in FIG. 10 increases an aptitude parameter of the nurturing-target character. The aptitude factor has six factors: a turf factor, a dirt factor, a short distance factor, a mile factor, an intermediate distance factor, and a long distance factor. A nurtured character always earns one of the six aptitude factors. The six aptitude factors correspond to a turf aptitude, a dirt aptitude, a short distance aptitude, a mile aptitude, an intermediate distance aptitude, and a long distance aptitude, respectively. In the case where the nurtured characters of the inheritance first generation or the inheritance second generation include a nurtured character having, for example, a turf factor, the aptitude parameter of the turf aptitude of the nurturing-target character increases.

It should be noted, however, that each of the aptitude factors also has an invoking timing and an invoking condition set therefor, and it is decided whether or not to invoke each of the aptitude factors in the same factor-invoking turns as those for the base ability factor. In the case where it is decided to invoke an aptitude factor, the corresponding aptitude parameter increases in one stage. As an example, the invoking probability of an aptitude factor is set to 100% in the first turn, regardless of the factor level.

Suppose that, for example, the aptitude factors of the three nurtured characters belonging to the first inheritance group are the turf factor, the short distance factor, and the mile factor, respectively, and that the aptitude factors of the three nurtured characters belonging to the second inheritance group are the turf factor, the short distance factor, and the intermediate distance factor, respectively. In this case, the turf aptitude and the short distance aptitude of the nurturing-target character each increase in two stages, and the mile aptitude and the intermediate distance aptitude each increase in one stage.

Also, suppose that, for example, all aptitude factors of the three nurtured characters belonging to the first inheritance group are the turf factor and that all aptitude factors of the three nurtured characters belonging to the second inheritance group are the short distance factor. In this case, the turf aptitude and the short distance aptitude of the nurturing-target character each increase in three stages. As still another example, suppose that all aptitude factors of the three nurtured characters belonging to the first inheritance group are the turf factor and that the aptitude factors of the three nurtured characters belonging to the second inheritance group are the turf factor, the short distance factor, and the mile factor, respectively. In this case, the turf aptitude of the nurturing-target character increases in four stages, and the short distance aptitude and the mile aptitude each increase in one stage.

It should be noted, however, that a limit is set on the increase values of aptitude parameters in the first turn. More specifically, the upper limits of all aptitude parameters are set to A in the first turn. Therefore, in the case where the initial value of the turf aptitude of the nurturing-target character is A, the turf aptitude does not increase in the first turn even if an inheritance character has the turf factor.

On the other hand, in the 30th turn and the 54th turn, a lottery for deciding whether or not to invoke each of the aptitude factors is drawn on the basis of the factor level thereof. As an example, in the 30th turn and the 54th turn, the invoking probability of an aptitude factor of level 3 is set to 5%, the invoking probability of an aptitude factor of level 2 is set to 3%, and the invoking probability of an aptitude factor of level 1 is set to 1%. In the 30th turn or the 54th turn, when it is decided to invoke an aptitude factor by lottery, the aptitude parameter corresponding to the aptitude factor increases. Note that in the 30th turn and the 54th turn, the upper limit of each of the aptitudes is raised from A to S. Therefore, in the 30th turn and the 54th turn, the value of each of the aptitude parameters can be increased up to S by invoking an aptitude factor.

Note that the values of the aptitude parameters after having increased in the first turn are displayed in the aptitude parameter display section 152b of the inheritance character selection screen 170.

The race factor increases an ability parameter of the nurturing-target character. A race factor is provided for each of the races with a high difficulty level (hereinafter, referred to as a factor-target race), such as GI, among the races of the nurturing main game in which the nurturing-target character can run. When the nurturing game is completed, a lottery for deciding whether or not to earn a race factor is drawn for each of the factor-target races in which the nurturing-target character won the first place. The nurtured character can earn a race factor by winning this lottery.

Note that a factor level is also provided for each of the race factors, and a factor level is decided by lottery for each of the race factors that have been decided to be earned. Here, there are no upper limits on the number of race factors that can be earned by one nurtured character, so that one nurtured character can earn a plurality of race factors.

Each of the race factors has set therefor in advance an ability parameter that is increased when the race factor is invoked and the increase value thereof. For example, race factors include a race factor for increasing the speed ability parameter and a race factor for increasing the power ability parameter. At this time, the higher the factor level, the larger the increase value of the ability parameter.

In addition, each of the race factors also has an invoking timing and an invoking condition set therefor, and it is decided whether or not to invoke each of the race factors in the factor-invoking turns. In the case where it is decided to invoke a race factor, the ability parameter corresponding to the race factor increases. Note that the factor-invoking turns for invoking a race factor are limited to the 30th turn and the 54th turn. In addition, the invoking probability of a race factor in a factor-invoking turn differs depending on the factor level, and the higher the factor level, the higher the invoking probability.

The character factor is a factor specific to a character. For example, only in the case where a character that has been strengthened up to a predetermined level is nurtured as a nurturing-target character, the character factor set for the character is always granted to the nurtured character when the nurturing game is completed. Note that because only one character factor is set for one character, one nurtured character can earn at most one character factor. Also, in the case where a nurtured character is created on the basis of a character that has not been strengthened to the predetermined level, the nurtured character cannot earn the character factor.

In addition, a character factor can be invoked in factor-invoking turns set in advance and is invoked when a lottery drawn in the factor-invoking turns is won. When a character factor is invoked, a hint event set for the character factor occurs, allowing the player to earn a hint for a skill, as described above. Also, when a character factor is invoked, the upper limit of a predetermined ability parameter increases.

FIG. 11B is a drawing for illustrating effectiveness resulting from a character factor. A character factor causes the upper limit of an ability parameter to increase only at the second and third invoking timings. It should be noted, however, that a character factor can be invoked at the first invoking timing. In the case where a character factor is invoked at the first invoking timing, the nurturing-target character earns a hint for a skill as described above, but there is no increase in the upper limit of an ability parameter.

In addition, when a character factor is invoked at the second or third invoking timing, not only is a hint for a skill earned but also the upper limit of an ability parameter increases. Here, the upper limit of an ability parameter increases in the range of “3” to “6”, regardless of the factor level. Note that the increase value of the upper limit is decided by, for example, lottery. At this time, the character factor may be set such that the higher the factor level, the larger the increase value.

Furthermore, in this embodiment, ability parameters the upper limits of which increase as a result of character factors being invoked are set in advance for each of the character factors. For example, a character factor A increases the upper limit of stamina in the range of “3” to “6”, and a character factor B increases the upper limit of speed by “1” and the upper limit of spirit by “2” or increases the upper limit of speed by “2” and the upper limit of spirit by “2”. Note that whether or not to invoke a character factor may be decided separately for each factor or for each type of effectiveness, just as in the case of the aforementioned base ability factor.

The skill factor shown in FIG. 10 is granted on the basis of earned skills earned by the nurtured character. More specifically, when the nurturing game is completed, a lottery for deciding whether or not to earn a skill factor is drawn for each of the earned skills earned by the nurtured character. A skill factor is granted to the nurtured character when this lottery is won. In short, the nurtured character can earn some or all of the skill factors corresponding to the earned skills. Note that when it is decided that a skill factor is to be earned, the factor level of that skill factor is decided by lottery.

In addition, a skill factor can be invoked in factor-invoking turns set in advance and is invoked when a lottery drawn in the factor-invoking turns is won. At this time, the higher the factor level, the higher the winning probability. When a skill factor is invoked, a hint event set for the skill factor occurs, allowing the player to earn a hint for a skill. Because of this, the nurturing-target character can earn a skill similar to an earned skill earned by an inheritance character, etc.

Thus, skill factors are earned within the range of earned skills earned by the nurtured character. Therefore, the larger the number of earned skills earned by a nurtured character, the higher the probability that the nurtured character earns a skill factor. It should be noted, however, that because whether or not to earn a skill factor is decided by lottery, no skill factors are earned in some cases, irrespective of whether many earned skills are earned.

Here, the present embodiment has been described by way of an example where the nurtured character earns a skill factor other than an earned skill. However, instead of providing skill factors, a skill that can be earned by the nurturing-target character may be decided on the basis of earned skills possessed by the nurtured characters serving as inheritance characters.

As described above, ability parameters of the nurturing-target character greatly change depending on the inheritance characters organized in the deck. In addition, a nurtured character with a high ability is not necessarily suitable as an inheritance character because whether or not to earn a factor is decided by lottery, regardless of the high ability of the nurtured character itself. On the other hand, even if a nurtured character itself does not have a high ability, the nurtured character may function as an effective inheritance character by earning many factors with a high factor level. Thus, allowing an inheritance character to be organized in a deck brings about pleasure in that not only is a powerful nurtured character nurtured but also a nurtured character effective as an inheritance character is nurtured.

Furthermore, in this embodiment, compatibility among the nurturing-target character, the nurtured characters of the inheritance first generation, and the nurtured characters of the inheritance second generation is determined. Also, in the case of a combination of characters with good compatibility, the factor invoking condition becomes favorable.

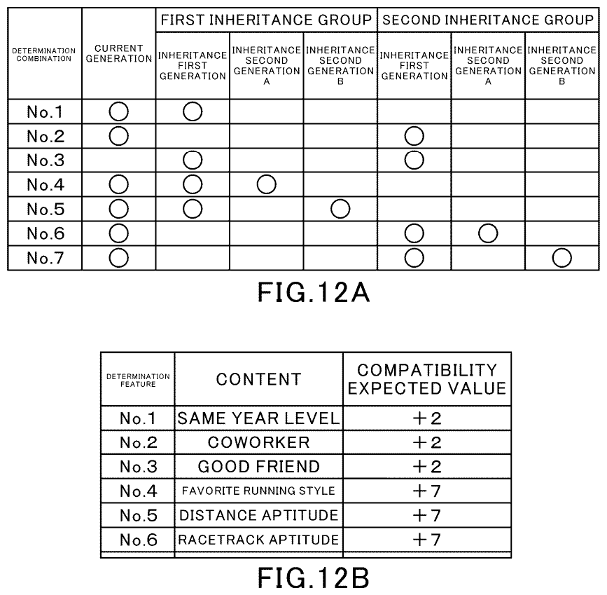

FIG. 12A is a drawing for illustrating compatibility determination combinations, and FIG. 12B is a drawing for illustrating compatibility determination features. As shown in FIG. 12A, seven determination combinations from No. 1 to No. 7 are provided in this embodiment. The first determination combination (No. 1) is the combination of the nurturing-target character of the current generation and the nurtured character of the inheritance first generation in the first inheritance group. The second determination combination (No. 2) is the combination of the nurturing-target character of the current generation and the nurtured character of the inheritance first generation in the second inheritance group.

The third determination combination (No. 3) is the combination of the nurtured character of the inheritance first generation in the first inheritance group and the nurtured character of the inheritance first generation in the second inheritance group. The fourth determination combination (No. 4) is the combination of the nurturing-target character of the current generation, the nurtured character of the inheritance first generation in the first inheritance group, and one (nurtured character A) of the nurtured characters of the inheritance second generation in the first inheritance group. The fifth determination combination (No. 5) is the combination of the nurturing-target character of the current generation, the nurtured character of the inheritance first generation in the first inheritance group, and the other (nurtured character B) of the nurtured characters of the inheritance second generation in the first inheritance group.

The sixth determination combination (No. 6) is the combination of the nurturing-target character of the current generation, the nurtured character of the inheritance first generation in the second inheritance group, and one (nurtured character A) of the nurtured characters of the inheritance second generation in the second inheritance group. The seventh determination combination (No. 7) is the combination of the nurturing-target character of the current generation, the nurtured character of the inheritance first generation in the second inheritance group, and the other (nurtured character B) of the nurtured characters of the inheritance second generation in the second inheritance group.

It is determined whether or not a condition is satisfied for each of the aforementioned determination combinations with respect to each of a plurality of determination features. FIG. 12B shows an example of determination features. In this embodiment, the game world is set up such that the characters that can be selected as a nurturing-target character are students, and each character does training at school.

Also, each character has pre-defined settings of year level, coworker, and good friend, as shown in FIG. 12B. The determination features include content, for example, as to whether the two or three characters constituting a determination combination are in the same year level, are coworkers, and are good friends. The determination features also include content as to whether the characters constituting a determination combination have in common a favorite running style, a favorite distance aptitude, and a favorite racetrack aptitude.

Also, a compatibility expected value is tied to each of the determination features, so that the compatibility expected values of the determination features that are satisfied among the characters constituting a determination combination are accumulated. Although the compatibility expected value differs depending on the determination feature here, the compatibility expected value may be common to all determination features.

For example, in order to determine compatibility, first it is determined whether or not each of the determination features is satisfied between the characters belonging to the first determination combination, i.e., between the nurturing-target character of the current generation and the nurtured character of the inheritance first generation in the first inheritance group. At this time, compatibility expected values tied to the satisfied determination features are accumulated and counted. In this manner, the compatibility expected values are counted sequentially from the first determination combination to the seventh determination combination, and invoking probabilities of factors are corrected on the basis of the finally calculated compatibility expected value. In short, the larger the compatibility expected value is, the higher the invoking probabilities of all factors are, and the smaller the compatibility expected value is, the lower the invoking probabilities of all factors are.

Note that the invoking probabilities may be calculated by using the calculated compatibility expected value as a correction value. In addition, for example, a correction value for correcting the invoking probabilities of factors may be set for each compatibility level, so that the compatibility level is decided by the calculated compatibility expected value.

Thus, because the invoking probabilities of factors differ depending on the compatibility between the nurturing-target character and an inheritance character or the compatibility between inheritance characters, the combination of two inheritance characters greatly affects nurturing of the nurturing-target character. In short, the compatibility between characters can be an important determination consideration in selecting an inheritance character.

In a state in which an inheritance character is selected, a compatibility mark indicating the level of compatibility is displayed in the upper right section of the inheritance character selection screen 170 and the nurtured character list screen 180, as shown in FIGS. 8B, 8C, and 8D. Here, the compatibility level based on the currently selected character is indicated with three compatibility marks: a double circle, a circle, and a triangle. Note that in a state in which no inheritance characters are selected, no compatibility marks are displayed, as shown in FIG. 8A.

In addition, a display switch button 183 is provided on the nurtured character list screen 180, as shown in FIG. 8B. When the display switch button 183 is operated, a display condition setting screen (not shown in the figure) is displayed. On the display condition setting screen, the player can make a setting for reordering or refining the nurtured character icons 182 displayed on the nurtured character list screen 180, i.e., the nurtured characters that can be selected as inheritance characters.

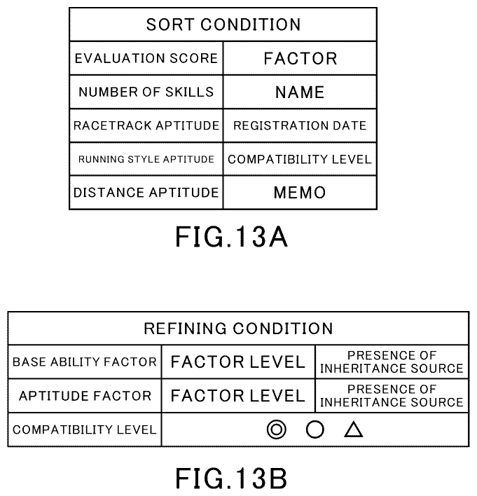

FIG. 13A is a drawing for illustrating sort conditions. FIG. 13B is a drawing for illustrating refining conditions. The player can select and set a sort condition shown in FIG. 13A on the display condition setting screen. Here, any of the evaluation score, factor, number of skills, name, racetrack aptitude, registration date, running style aptitude, compatibility level, distance aptitude, and memo can be selected and set as a sort condition. When a sort condition is set, the nurtured character list screen 180 is displayed. At this time, on the nurtured character list screen 180, the order in which the nurtured character icons 182 are displayed is changed according to the sort condition.

On the display condition setting screen, the player can also select and set a refining condition shown in FIG. 13B. Here, the base ability factor, aptitude factor, and compatibility level are provided as refining conditions. Note that when the base ability factor or the aptitude factor is set as a refining condition, only the nurtured characters having the factor selected by the player are displayed on the nurtured character list screen 180.

At this time, the player can set a factor level. In the case where the nurtured characters are refined with the factor level set to, for example, level 3, only the nurtured characters having factors that are identical to the factor selected by the player and that have a factor level of level 3 are displayed on the nurtured character list screen 180. Note that the player can refine the nurtured characters by selecting whether the nurtured character itself has the factor or inheritance characters of the nurtured character have the factor.

In addition, the player can refine the nurtured characters by compatibility level. Here, the player can refine nurtured characters with the compatibility indicated by a double circle, nurtured characters with the compatibility indicated by a circle, and nurtured characters with the compatibility indicated by a triangle. In this manner, sorting and refining are possible with various conditions, thereby enhancing convenience to the player.

Furthermore, when a nurtured character icon 182 is pressed and held on the nurtured character list screen 180 shown in FIG. 8B, detailed information concerning the nurtured character corresponding to the nurtured character icon 182 is displayed.

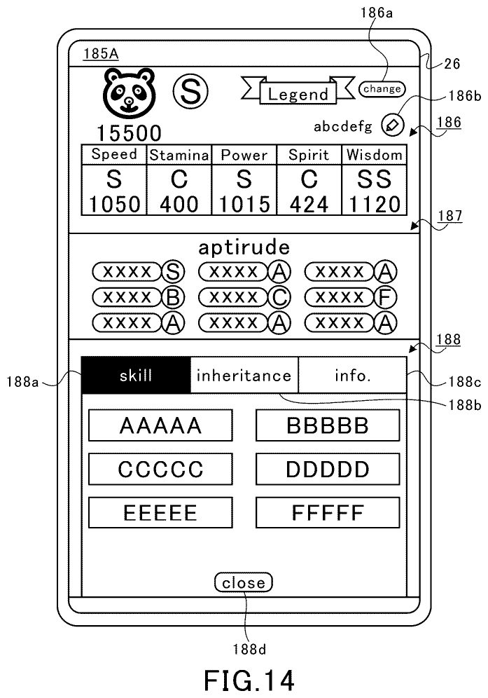

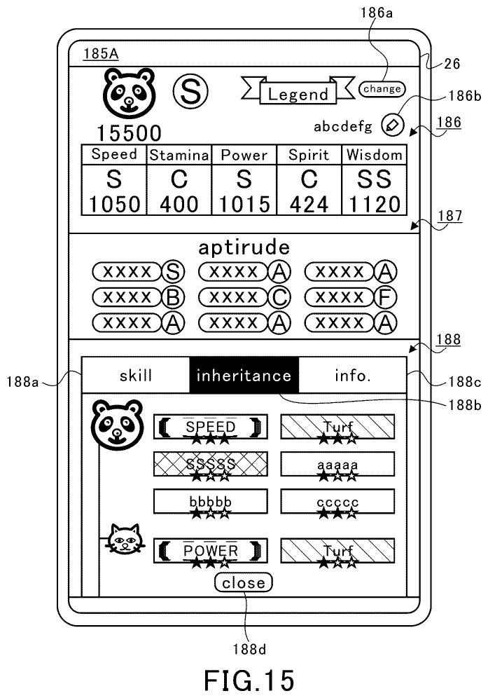

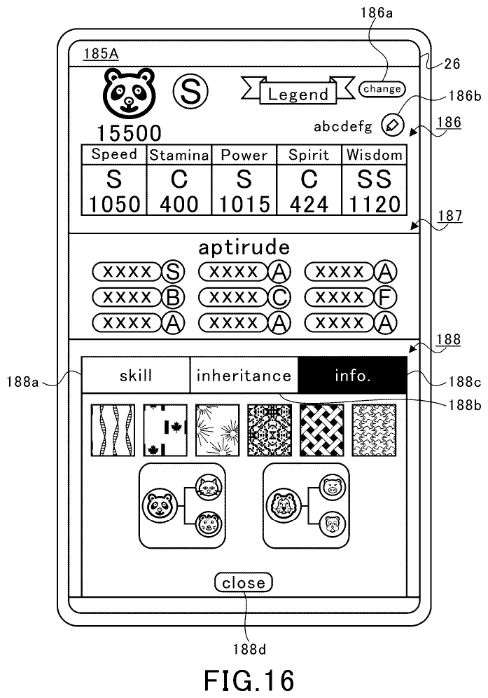

FIG. 14 is a first drawing for illustrating a character details dialog 185A. FIG. 15 is a second drawing for illustrating the character details dialog 185A. FIG. 16 is a third drawing for illustrating the character details dialog 185A. Detailed information concerning the nurtured character is displayed in the character details dialog 185A. An ability parameter display field 186 indicating the ability parameters of the nurtured character is displayed in the upper section of the character details dialog 185A.

In the upper left section of the ability parameter display field 186, an icon indicating the character on which the nurtured character is based, as well as an evaluation score and a nurturing rank of the nurtured character, is displayed. Also, in the upper right section of the ability parameter display field 186, a nickname change button 186a and a memo input button 186b are provided. When the nickname change button 186a is tapped, a nickname list screen (not shown in the figure) is displayed. The nicknames earned by the nurtured character are listed on the nickname list screen. Note that many nicknames are provided in the nurturing main game, and an earning condition is set for all nicknames.

In the nurturing main game, a nickname satisfying the earning condition thereof is granted to the nurtured character. The player can select any one of the nicknames earned by the nurtured character and set it for the nurtured character. The player can change the nickname set for the nurtured character on the nickname list screen. The currently set nickname (Legend, here) is displayed to the left of the nickname change button 186a.

Note that examples of the earning condition of a nickname include: the nurturing-target character earning a predetermined number of fans; an ability parameter or an aptitude parameter having a predetermined value or larger; a predetermined skill being earned; the number of wins in races reaching a predetermined number; and a predetermined finish place (e.g., first place) being won in a particular race.

In addition, when the memo input button 186b is tapped, a character input screen (not shown in the figure) is displayed. On the character input screen, up to nine characters can be input in, for example, hiragana, katakana, numeric characters, or Roman letters. The characters input on the character input screen are stored as a memo so as to be tied to the nurtured character. In the case where a memo is stored in the nurtured character, the memo (abcdefg, here) is displayed to the left of the memo input button 186b.

Note that the sort conditions of the nurtured character icons 182 on the nurtured character list screen 180 include the aforementioned memo. Therefore, by registering a memo so as to be tied to a nurtured character, the player can more easily find nurtured characters for use as inheritance characters.

In addition, an aptitude information display field 187 is displayed below the ability parameter display field 186. In the aptitude information display field 187, aptitude parameters related to the racetrack aptitudes (turf and dirt), aptitude parameters related to the distance aptitudes (short distance, mile, intermediate distance, and long distance), and aptitude parameters related to the running style aptitudes (pace maker, front runner, stalker, and closer) are displayed.

A various-kinds-of-information display field 188 is displayed below the aptitude information display field 187. A skill display tab 188a, an inheritance information display tab 188b, a nurturing information display tab 188c, and a close operation section 188d are provided in the various-kinds-of-information display field 188. When the skill display tab 188a is tapped, the earned skills of the nurtured character are displayed in the various-kinds-of-information display field 188, as shown in FIG. 14. In addition, when the inheritance information display tab 188b is tapped, inheritance information concerning the nurtured character is displayed, as shown in FIG. 15.

Note that the various-kinds-of-information display field 188 shows inheritance information on the basis of the nurtured character that can be set as an inheritance character and the inheritance characters used to nurture the nurtured characters. The inheritance information includes information concerning the inheritance characters used to nurture the nurtured character, factor information possessed by the nurtured character, and factor information possessed by the inheritance characters. Here, inheritance information is listed for each of the nurtured characters.

More specifically, factor information tied to the nurtured character and factor information tied to the inheritance characters of the nurtured character are displayed for each of the characters. Therefore, the player can confirm factor information possessed by each of the three characters by scrolling the various-kinds-of-information display field 188 in the up/down direction.

In the various-kinds-of-information display field 188, base ability factors, aptitude factors, and character factors are displayed in different colors. For example, the base ability factors are displayed in blue, the aptitude factors are displayed in red, and the character factors are displayed in green. Note that in the various-kinds-of-information display field 188, the race factors and the skill factors are displayed in white. In addition, stars indicating the factor level are displayed so as to be superimposed on the factor information.

Also, when the nurturing information display tab 188c is tapped, nurturing information concerning the nurtured character is displayed, as shown in FIG. 16. Note that the nurturing information includes support card types used to nurture the nurtured character, the characters of the inheritance first generation and the inheritance second generation, race records in the nurturing game, and furthermore the evaluation score.

Thus, the player can confirm various items of information concerning the nurtured character in the character details dialog 185A. Therefore, it becomes easier for the player to grasp information tied to an inheritance character to be organized in the deck, thereby enhancing convenience to the player.

Note that when the close operation section 188d is tapped on the character details dialog 185A, the character details dialog 185A is closed, and the nurtured character list screen 180 is displayed on the display 26. In addition, as shown in FIGS. 8A, 8B, 8C, and 8D, a skill display button 172 is provided in the upper right section of the inheritance character selection screen 170 and the nurtured character list screen 180. When the skill display button 172 is tapped, the skills that may be earned due to the nurtured character temporarily selected as an inheritance character are listed.

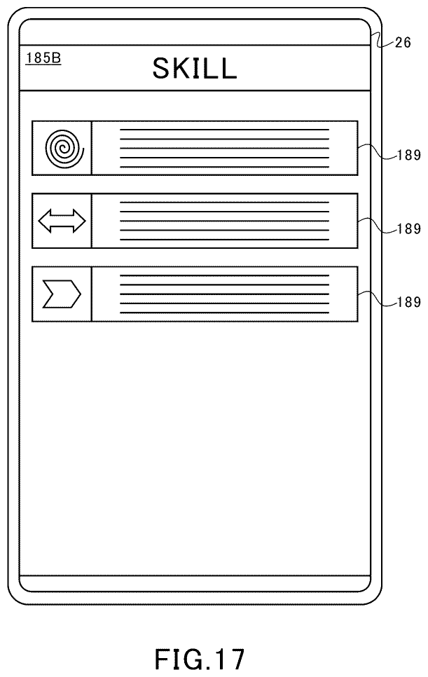

FIG. 17 is a drawing for illustrating a skill display dialog 185B. In the skill display dialog 185B, skill description display fields 189 indicating icons corresponding to skills and content of the skills are displayed. The skills listed in these skill description display fields 189 constitute all skills that may be earned by the nurturing-target character in the case where the currently selected nurtured character is used as an inheritance character.

Namely, the skill display dialog 185B lists information concerning skills tied to the character factor or skill factors possessed by the nurtured character. As shown in FIG. 8C, in the case where the skill display button 172 is tapped in a state in which one nurtured character is selected as an inheritance character, the skills tied to the character factor and race factors possessed by this one nurtured character (inheritance character) are displayed in the skill display dialog 185B.

On the other hand, in the case where the skill display button 172 is tapped in a state in which two nurtured characters are selected as inheritance characters, as shown in FIG. 8D, the skills tied to the character factor and race factors possessed by each of the two nurtured characters (inheritance characters) are displayed in the skill display dialog 185B.

As described above, in this embodiment, the character details dialog 185A lists inheritance information (factor information) for each of the nurtured characters that can be set as inheritance characters. The skill display dialog 185B also lists information (skills) tied to the inheritance information (factor information). At this time, the character details dialog 185A and the skill display dialog 185B are displayed on the basis of the nurtured character that can be set as an inheritance character and the inheritance characters used to create the nurtured character. Display of the character details dialog 185A and the skill display dialog 185B enhances convenience to the player.

Also, when two nurtured characters are temporarily selected, the next operation section 154 provided on the inheritance character selection screen 170 is enabled. When the enabled next operation section 154 is tapped, the temporarily selected nurtured characters are temporarily registered in the deck as inheritance characters, and a support card organization screen 190 (described below) is displayed.

Note that on the inheritance character selection screen 170, the player needs to select two nurtured characters as inheritance characters. If two inheritance characters are not in a temporarily selected state, the next operation section 154 is grayed out, as shown in FIGS. 8A and 8C, disabling a player operation from being accepted. In addition, the return operation section 153 is provided on the inheritance character selection screen 170, so that when the return operation section 153 is tapped, the nurturing-target-character selection screen 150 is displayed.

### <Registration of Support Cards>

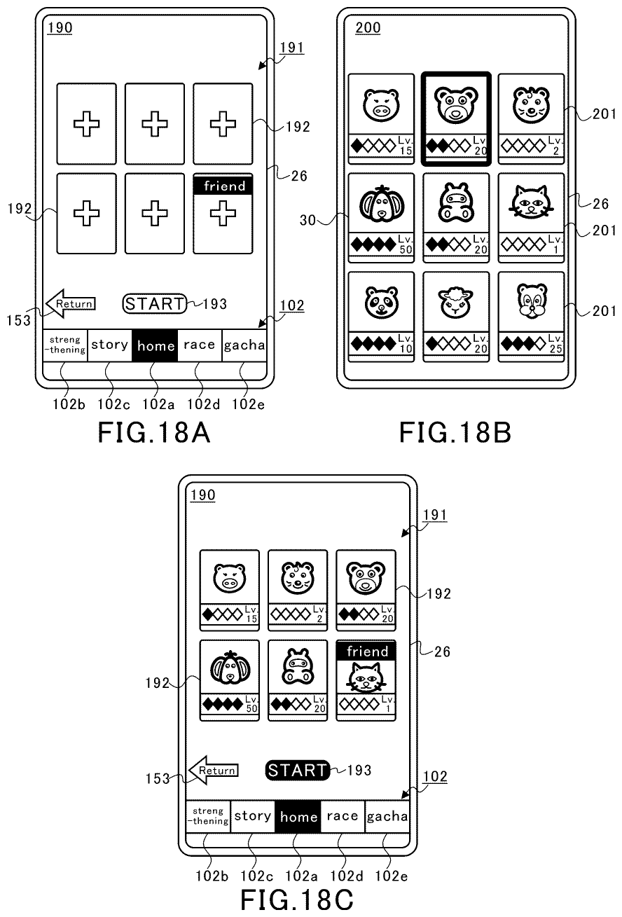

FIG. 18A is a first drawing for illustrating the support card organization screen 190. When two inheritance characters are registered on the inheritance character selection screen 170, the support card organization screen 190 shown in FIG. 18A is displayed. A support card display region 191 is provided in the center of the support card organization screen 190. The support card display region 191 includes a plurality of support card display frames 192. In addition, the return operation section 153 captioned “Return” and a start operation section 193 captioned “START” are displayed in the lower section of the support card organization screen 190.

The plurality of (six here) support card display frames 192 are displayed in the support card display region 191. The same number of support card display frames 192 as the number of support cards that can be set by the player are displayed. Note that in the initial display of the support card organization screen 190, the support card display frames 192 are displayed blank.

In this embodiment, the player can set six kinds of support cards in the deck. Note that some (e.g., five) of the six kinds of support cards that can be set by the player can be selected from among the support cards possessed by the player. In addition, some other (e.g., one) of the six kinds of support cards that can be set by the player can be selected from among the support cards that are set as rental cards by other players such as friends.

FIG. 18B is a drawing for illustrating a support card selection screen 200. When a support card display frame 192 (excluding the support card display frame 192 shown in the lower right section) is tapped on the support card organization screen 190 in FIG. 18A, the support card selection screen 200 shown in FIG. 18B is displayed on the display 26. Card icons 201 corresponding to the support cards possessed by the player are listed on the support card selection screen 200. The player can select a support card by tapping a card icon 201 displayed on the support card selection screen 200.

Although not shown in the figure, when the support card display frame 192 displayed in the lower right section of the support card organization screen 190 is tapped, support cards set as rental cards by friends or players extracted on the basis of a predetermined condition, such as a lottery, are displayed on the support card selection screen 200. At this time, the player can select one of the support cards of the friends by tapping a support card displayed on the support card selection screen 200. Thus, in the nurturing game, the player can use a support card possessed by another player.

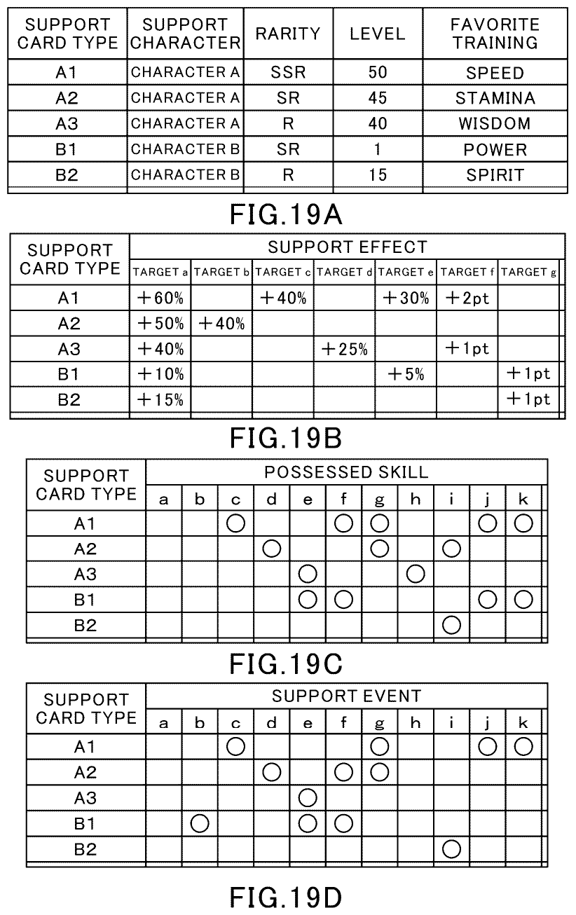

FIG. 19A is a drawing for illustrating a support card table. As shown in FIG. 19A, the support card table stores the kind of support character (i.e., character ID), rarity, level, and favorite training for each of the support card types (i.e., support card IDs) possessed by the player. There is a one-to-one correspondence between the support characters and the support card types. In short, one character ID is always tied to a support card ID. In other words, one support character is always associated with one support card.

In this embodiment, a rarity is set for each of the support cards. There are three stages of rarity: R (rare), SR (super rare), and SSR (super special rare). Note that the rarity is set so that R is the lowest rarity and SSR is the highest rarity. In this embodiment, support cards with higher rarity tend to have higher support effects, as described below. In addition, in this embodiment, support cards with higher rarity tend to have a larger number of possessed skills and support events described below.

There are 50 levels of a support card, from level 1 to level 50. The level of a support card can be increased by the player, and the level increased by the player is stored for each of the support cards. Note that the level of a support card can be increased by using in-game currency or items. Note that the maximum level of a support card is limited according to rarity.

For example, the maximum level of a support card with rarity R is defined as 20, the maximum level of a support card with rarity SR is defined as 25, and the maximum level of a support card with rarity SSR is defined as 30.

Note that the maximum level of a support card can be increased in a stepwise manner when a predetermined condition is satisfied. For example, it is also acceptable that a support card with rarity R can have the maximum level thereof increased to 40, a support card with rarity SR can have the maximum level thereof increased to 45, and a support card with rarity SSR can have the maximum level thereof increased to 50.

FIG. 19B is a drawing for illustrating a support effect table. As shown in FIG. 19B, support effects for each of the support card types possessed by the player are stored in the support effect table.

Support effects work to increase various kinds of statuses in the nurturing main game. A plurality of support effect targets are provided in a support card. Examples of support effect targets include physical strength, speed, stamina, power, spirit, wisdom, etc.

FIG. 19C is a drawing for illustrating a possessed skill table. In the possessed skill table, possessed skills are set for each of the support cards possessed by the player, as shown in FIG. 19C. In this embodiment, each of the support cards has possessed skills set therefor, just as the character set as the nurturing-target character by the player has possessed skills set therefor. The possessed skills set for each of the support cards can be earned by the nurturing-target character selected by the player when a hint event occurs during the nurturing main game.

FIG. 19D is a drawing for illustrating a support event table. As shown in FIG. 19D, support events that can occur for each of the support cards possessed by the player are stored in the support event table. A support event is an event that may occur during the execution of the nurturing main game. When a support event occurs, the values of various kinds of statuses in the nurturing main game may increase or decrease.

For example, a support event that will occur may be decided according to the turn number, or alternatively, a support event that will occur may be decided by a predetermined lottery. In addition, a plurality of support events that will occur may be selected in one turn. In any case, it suffices if a support event that will occur is decided by a predetermined decision method that has been set in advance.

Note that support events may include a first hint event that can occur when a turn is started in the nurturing game, a second hint event that can occur after the execution of training (described below) in the nurturing game, a first ability event that can occur when a turn is started in the nurturing game, a second ability event that can occur after the execution of training in the nurturing game, etc. The first hint event and the second hint event are events that enable a skill to be possessed or earned. In addition, the first ability event and the second ability event are events that increase or decrease the numerical values of ability parameters of the character. Hereinafter, the first hint event and the first ability event are collectively referred to as a first event, and the second hint event and the second ability event are collectively referred to as a second event.

FIG. 18C is a second drawing for illustrating the support card organization screen 190. In this embodiment, when all six support cards are selected, the start operation section 193 becomes operable, as shown in FIG. 18C. On the other hand, when not all six support cards have been selected, the start operation section 193 is inoperable, as shown in FIG. 18A.

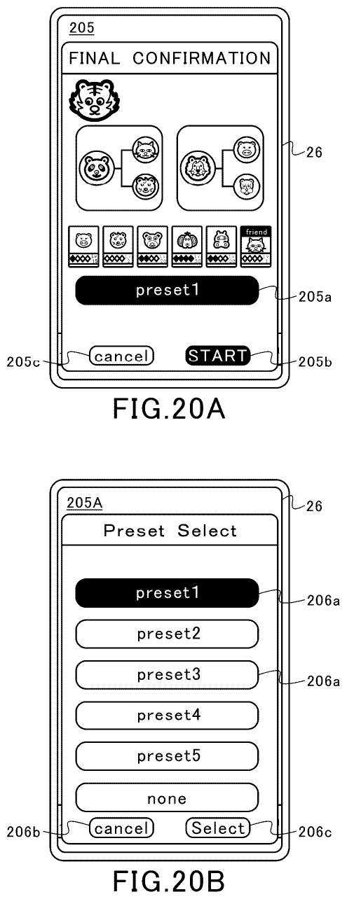

Note that when the return operation section 153 is operated on the support card organization screen 190, the inheritance character selection screen 170 shown in FIG. 8D is displayed on the display 26. Also, as shown in FIG. 18C, when the start operation section 193 is tapped on the support card organization screen 190, the support cards being selected are temporarily registered, and a final confirmation screen 205 (FIG. 20A) is displayed.

FIG. 20A is a drawing for illustrating the final confirmation screen 205. FIG. 20B is a drawing for illustrating a preset selection screen 205A. The nurturing-target character selected by the player, the nurtured characters constituting the first inheritance group, the nurtured characters constituting the second inheritance group, and the support cards are displayed on the final confirmation screen 205. A preset display section 205a is also displayed on the final confirmation screen 205. The number of the currently selected preset is indicated in the preset display section 205a.

Here, a preset is reservation information for a race in which the nurturing-target character is made to run in the nurturing main game. The player can select any race from among all races and generate a preset. The player can save a plurality of presets and can select one of the saved presets on the final confirmation screen 205. More specifically, when the preset display section 205a is tapped, the preset selection screen 205A shown in FIG. 20B is displayed.

On the preset selection screen 205A, preset reading buttons 206a corresponding to the saved presets are displayed. The player can set a preset by tapping any one of the preset reading buttons 206a and then tapping a select operation section 206c. Note that when the select operation section 206c is tapped, the preset selection screen 205A is closed, and the final confirmation screen 205 is displayed. In addition, when a cancel operation section 206b on the preset selection screen 205A is tapped, the preset selection screen 205A is displayed without changing the preset.

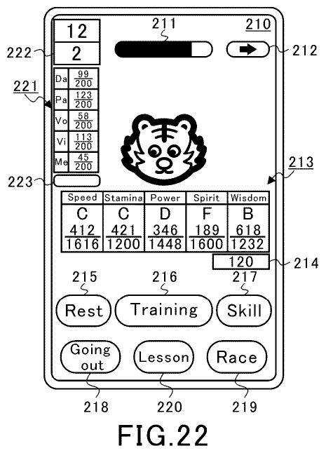

Note that when a cancel operation section 205c is tapped on the final confirmation screen 205, the support card organization screen 190 is displayed. On the other hand, when a start operation section 205b is tapped, a game screen 210 (FIG. 22) is displayed on the display 26.

Note that this embodiment is restricted so that the character type set as the nurturing-target character and the character type set as a support character are not the same when the support cards are registered.

As described above, when the nurturing-target character, inheritance characters, and support cards are registered, the preparatory-stage process ends.

### <Nurturing-Stage Process>

After the preparatory-stage process is completed, the nurturing-stage process starts. Through the nurturing-stage process, a nurturing main game in which the nurturing-target character can be nurtured proceeds. Note that for the sake of ease of understanding, the basic flow of the nurturing main game is described first.

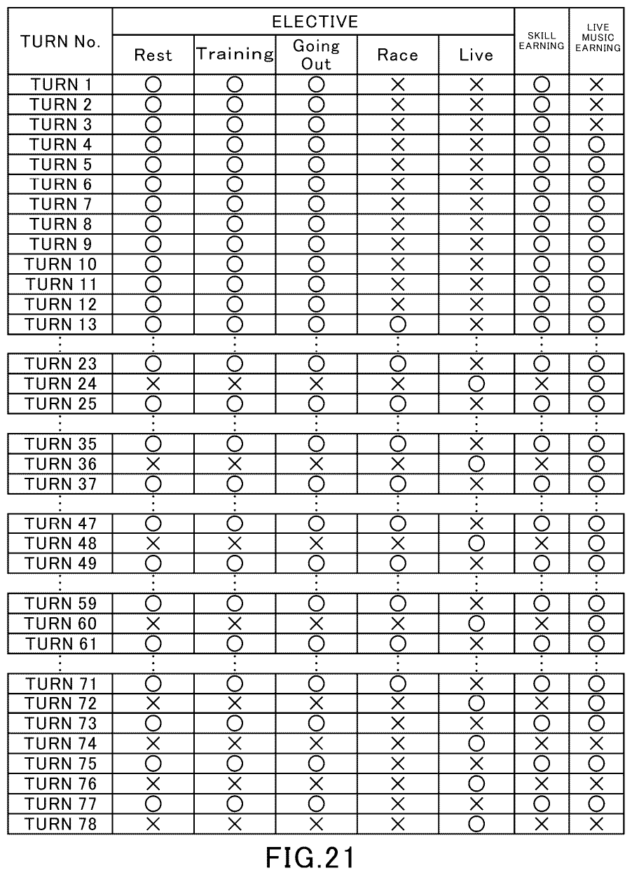

FIG. 21 is a drawing for illustrating electives for each of the turns. Note that here, electives that can be selected in each of the turns are common, regardless of the type of the nurturing-target character. It should be noted, however, that electives that can be selected in each of the turns may differ depending on the type of the nurturing-target character. The nurturing main game is composed of the first turn through the 78th turn, as shown in FIG. 21. Also, various kinds of parameters are updated according to the electives selected by the player in each of the turns.

FIG. 22 is a drawing for illustrating the game screen 210. Upon transition to the nurturing-stage process, the game screen 210 shown in FIG. 22 is displayed on the display 26. In the upper section of the game screen 210, a physical strength display section 211 and a physical condition display section 212 are displayed. The nurturing-target character has a “physical strength” parameter. The “physical strength” parameter is mainly used to calculate a failure rate, which is the probability of failure in training, as described below. The physical strength display section 211 is displayed so that the current remaining amount of “physical strength” of the nurturing-target character can be visually grasped with respect to the upper limit of “physical strength”.

In addition, the nurturing-target character also has a “physical condition” parameter. The physical condition display section 212 is displayed so that the current “physical condition” of the nurturing-target character can be visually grasped at a plurality of stages (five stages: very bad shape, bad shape, normal, good shape, and great shape). The higher the “physical condition” parameter, the more advantageous to the nurturing-target character the proceeding of the race, and the larger the increase values of ability parameters due to training.

In addition, as shown in FIG. 22, the image of the nurturing-target character, a status display section 213, and a skill point display section 214 are displayed in the center of the game screen 210. In the status display section 213, the current statuses of the nurturing-target character are indicated as numerical values and a plurality of ranks (18 ranks: G, G⁺, F, F⁺, E, E⁺, D, D⁺, C, C⁺, B, B⁺, A, A⁺, S, S⁺, SS, and SS⁺).

More specifically, the status display section 213 is displayed such that a denominator indicates the current upper limit of each of the ability parameters (“Speed”, “Stamina”, “Power”, “Spirit”, and “Wisdom”), and a numerator indicates the current numerical value (points) of each of those parameters. Also, ranks are displayed above the current numerical values and upper limits of the ability parameters. In addition, the remaining amount of skill points possessed by the nurturing-target character in the nurturing game is indicated numerically in the skill point display section 214.

Also, as shown in FIG. 22, in the lower section of the game screen 210, a rest operation section 215 captioned “Rest”, a training operation section 216 captioned “Training”, a skill operation section 217 captioned “Skill”, a going-out operation section 218 captioned “Going Out”, a race operation section 219 captioned “Race”, and a live preparation operation section 220 captioned “Lesson” are displayed.

When the rest operation section 215 is selected, a rest event occurs, recovering the physical strength. When the training operation section 216 is selected, training (described later) can be executed. When the skill operation section 217 is selected, a skill can be earned. When the going-out operation section 218 is selected, a going-out event occurs, mainly increasing the physical condition.

When the race operation section 219 is selected, the nurturing-target character can be made to run in a race. When a race is executed, rewards such as in-game currency and fans are granted according to the finish place of the nurturing-target character in the race. At this time, the higher the finish place, the larger the value of the rewards to be earned. Also, the higher the difficulty level of a race, the more rewards the player can earn in the race. For example, in the grades GI, GII, and GIII, the higher the grade of a race, the more rewards the player can earn in the race.

When the live preparation operation section 220 is selected, live music and live skills (hereinafter, referred to as live music, etc.) to be performed in a live event (described below) can be earned. Hereinafter, the rest operation section 215 through the live preparation operation section 220 are referred to as commands. Also, processes or events themselves executed on the basis of the operation of the rest operation section 215 through the live preparation operation section 220 are referred to as commands in some cases.

Note that when a rest event occurs, a going-out event occurs, training is executed, and the nurturing-target character runs in a race, the current turn ends and transitions to the next turn. On the other hand, in the case where a skill is earned and live music, etc. is earned, the player can further select another command without quitting the current turn.

In FIG. 21, commands that can be selected by the player in each of the turns are indicated with a circle, and commands that cannot be selected by the player in each of the turns are indicated with a cross mark. Note that the commands, shown in FIG. 21, that can be selected by the player in each of the turns are merely examples. Here, in this embodiment, the 24th turn, the 36th turn, the 48th turn, the 60th turn, the 72nd turn, the 74th turn, the 76th turn, and the 78th turn are set as live-event-holding turns. In the live-event-holding turns, live events captioned “Live” in FIG. 21 occur. Also, in the live-event-holding turns, the player can select only commands for performing a live event or earning live music, etc.

It should be noted, however, that, in the live-event-holding turns, the player may also be able to select a command other than the commands for performing a live event or earning live music, etc. In this case, it suffices, for example, if a live event is performed after a command for ending the current turn has been selected and a predetermined event has occurred.

Although described below in detail, in this embodiment, a live event is performed on the basis of live music, etc. that has been earned up to the live-event-holding turn. The nurturing-target character earns per-performance parameters (hereinafter, referred to as performance parameters, described below) through execution of training. Live music, etc. can be earned by consuming performance parameters possessed by the nurturing-target character. When a live event is performed, the player is granted a reward. The more the pieces of live music, etc. that have been earned before a live event is performed, the more advantageous the reward granted to the player.

Note that, during the nurturing main game, the player can confirm, on various screens, live music, etc. that has been earned until the next live event is performed. It should be noted, however, that when a live event is performed, the number of pieces of live music, etc. earned until the next live event is performed (i.e., the current number of pieces of earned live music, etc.) is zero. Therefore, the player needs to earn live music, etc., as appropriate, in a time period from the start of the nurturing main game to the first live-event-holding turn or in a time period between live-event-holding turns.

As shown in FIG. 22, a performance parameter display section 221, a turn display section 222, and an earning status indication icon 223 are provided in the upper left section of the game screen 210. In the performance parameter display section 221, the values of performance parameters possessed by the nurturing-target character are displayed. In this embodiment, five kinds of performance features, dance, passion, vocal, visual, and mental, are provided. Also, a parameter is provided for each of the performance features.

Da, Pa, Vo, Vi, and Me displayed in the performance parameter display section 221 represent the dance, passion, vocal, visual, and mental performance features, respectively. In the performance parameter display section 221, the upper limit of the parameter of each of the performance features is indicated as a denominator, and the current value of the parameter is indicated as a numerator. Note that the upper limit of the parameter of each of the performance features increases each time a live-event-holding turn ends. For example, the upper limits of the parameters of all performance features are set to 200 until the first live-event-holding turn ends. Therefore, each of the performance parameters increases or decreases within the range up to 200 until the 24th turn, which is the first live-event-holding turn. Also, when the 24th turn ends, the upper limit of the parameter of each of the performance features is raised to, for example, 300.

Thus, in this embodiment, the upper limit of the parameter of each of the performance features is raised in a stepwise manner. Because of this, the player is required to earn live music, etc. highly frequently.

In addition, the number of turns remaining until the next live-event-holding turn and the current turn number after the start of the nurturing main game are displayed in the turn display section 222. Furthermore, when the earning status indication icon 223 is tapped, an earning-status display screen (not shown in the figure) is displayed. On the earning-status display screen, music pieces that have been earned after the previous live-event-holding turn and that will be performed in the next live event are listed. Moreover, all pieces of live music, etc. that have been earned after the start of the nurturing main game can be confirmed on the earning-status display screen.

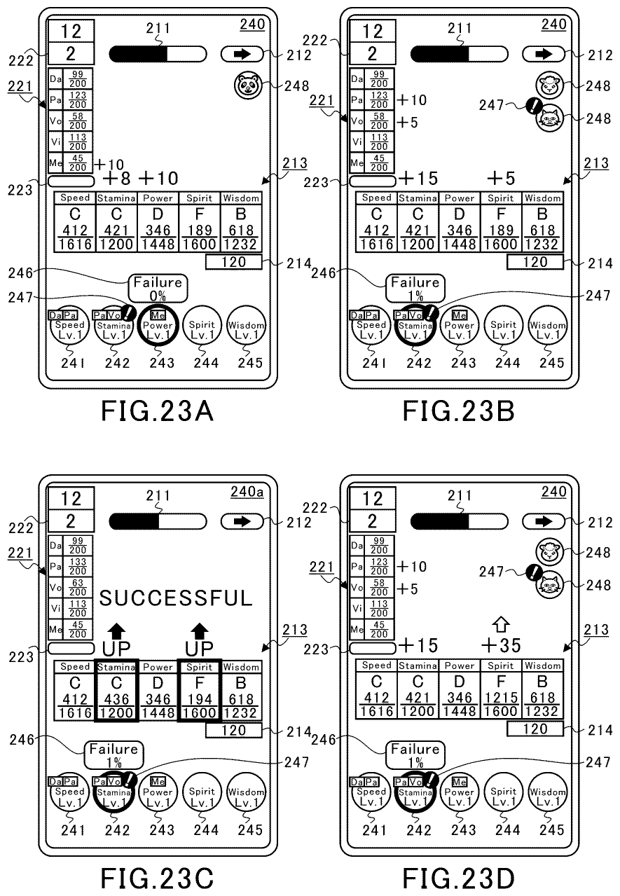

FIG. 23A is a first drawing for illustrating a training screen 240. FIG. 23B is a second drawing for illustrating the training screen 240. When the training operation section 216 on the game screen 210 is operated, the training screen 240 is displayed on the display 26.

As shown in FIG. 23A, the status display section 213 and the skill point display section 214 are displayed near the center of the training screen 240. Also, the performance parameter display section 221, the turn display section 222, and the earning status indication icon 223 are displayed in the upper left section of the training screen 240.

Furthermore, training courses are displayed in the lower section of the training screen 240. Here, a speed operation section 241 captioned “Speed”, a stamina operation section 242 captioned “Stamina”, a power operation section 243 captioned “Power”, a spirit operation section 244 captioned “Spirit”, and a wisdom operation section 245 captioned “Wisdom” are displayed.

When the player taps one of the operation sections 241 to 245 once, the training course corresponding to the tapped one of the operation sections 241 to 245 is temporarily selected. At this time, the one of the operation sections 241 to 245 corresponding to the temporarily selected training course is highlighted. FIG. 23A shows that the power operation section 243 is temporarily selected. In addition, FIG. 23B shows that the stamina operation section 242 is temporarily selected.

Training levels for the training courses are also displayed in the respective operation sections 241 to 245. A training level is a parameter that increases on the basis of the number of times the training course is selected. The higher the training level, the larger the increase values of ability parameters when the training is executed. A training level is initially set to level 1 and increases to a maximum of level 5.

In addition, a failure rate display section 246 captioned “Failure” is displayed in the temporarily selected one of the operation sections 241 to 245. The failure rate numerically displayed in the failure rate display section 246 is set to increase inversely proportionally to the remaining amount of physical strength displayed in the physical strength display section 211.

In addition, the status display section 213 displays the values by which ability parameters are increased when the temporarily selected training is successful. For example, in the example shown in FIG. 23A, the power operation section 243 is temporarily selected, and “+8” and “+10” are displayed for “Stamina” and “Power”, respectively, in the status display section 213. In addition, in the example shown in FIG. 23B, the stamina operation section 242 is temporarily selected, and “+15” and “+5” are displayed for “Stamina” and “Spirit”, respectively, in the status display section 213.

In addition, an event report indicator 247 is displayed in any of the operation sections 241 to 245 corresponding to a training course in which a predetermined event occurs when the training is successful. Note that the event report indicator 247 can be displayed in different manners depending on the event type.

In addition, as shown in FIG. 23B, placement character icons 248 corresponding to the characters placed in the temporarily selected training are displayed in the upper right section of the training screen 240. Also, in the case where the training is successful, a predetermined event may occur corresponding to the character displayed on a placement character icon 248. If this is the case, an event report indicator 247 is displayed on the corresponding placement character icon 248.

In this embodiment, characters placed in training include support characters. When training in which a support character is placed is executed, a second event tied to the placed support character may occur in some cases. In the case where this second event occurs, the event report indicator 247 is displayed on the placement character icon 248. When training in which a support character is placed is successful, a parameter increase value of the nurturing-target character is larger than when training in which no support characters are placed is successful.

Note that characters placed in training include characters other than the support characters corresponding to support cards registered by the player in the preparatory-stage process. For example, a character randomly selected by lottery from among all the support characters implemented in the game can be placed in training. In this case, a character icon 248 indicating a character other than the support characters registered by the player is displayed on the training screen 240.

In addition, when training for which a character icon 248 is displayed is executed, an event tied to a character other than the support characters registered by the player may occur. Here, the rate at which an event tied to a character not registered by the player occurs is lower than the rate at which an event tied to a support character registered by the player occurs. Also in this case, an event report indicator 247 may be displayed on the character icon 248 displayed on the training screen 240.

FIG. 23C is a drawing for illustrating a training result report screen 240a. When a temporarily selected one of the operation sections 241 to 245 is tapped again, the training corresponding to the tapped one of the operation sections 241 to 245 is executed. When the training is executed, the training result report screen 240a is displayed on the display 26. Success or failure in the training is reported on the training result report screen 240a.

FIG. 23C shows an example in the case where a success presentation is executed after successful training. In the success presentation, an image of the nurturing-target character doing training (not shown in the figure) is displayed. Also, the word “Successful” is displayed in the success presentation, reporting the player that training is successful. Furthermore, ability parameters in the status display section 213 are updated and displayed in the success presentation. More specifically, in the success presentation, “UP” is displayed above the ability parameters corresponding to the training course (nurturing type) selected by the player, thus displaying updated numerical values of the ability parameters.

Here, the values of the ability parameters that are displayed in the status display section 213 in FIG. 23B and that will add to the ability parameters when the training is successful are added. In addition, the display in the physical strength display section 211 is also updated according to the training course executed. When the speed, stamina, power, or spirit training is successful, the physical strength is decreased. On the other hand, when the wisdom training is successful, the physical strength is recovered.

In addition, if the training fails, a predetermined penalty is given. Specific penalties include a decrease in physical strength, a decrease in the numerical value of an ability parameter, a decrease in physical condition, etc. For example, a penalty given when the failure rate is high can be more disadvantageous (e.g., a greater decrease in the numerical value of the physical strength, a greater decrease in the numerical value of an ability parameter, or a greater decrease in the stage of the physical condition) than a penalty given when the failure rate is low.

The details of a penalty may also be decided depending on the training course. For example, a failure in speed training may result in a decrease in the value of the speed ability parameter, and a failure in power training may result in a decrease in the value of the power ability parameter. Also, for some of the training courses (e.g., wisdom), no penalty may be given even if the training fails.

When training fails, a failure presentation is executed on the training result report screen 240a. The player is informed of failure in training due to the failure presentation. Also, in the case where a penalty is imposed, the content of the penalty is reported by the failure presentation.

Here, in the nurturing game, each of the ability parameters has an upper limit set therefor, as described above. The value of each of the ability parameters is updated within the range up to the set upper limit. In other words, ability parameters are constrained from being updated to a value above the upper limits thereof. In addition, in the nurturing game, a common base value that is set in common among the plurality of ability parameters or the plurality of scenarios is provided. This common base value is applied to the ability parameters not including the scenario initial addition values and the addition values resulting from invoked factors. As described above, “1200” is set as the common base value in this embodiment.

The upper limit of each of the ability parameters is changed to a value exceeding the common base value when the scenario initial addition value or an addition value resulting from an invoked factor is added. Namely, the upper limit of each of the ability parameters that is set on the basis of the scenario initial addition value data includes a value exceeding the common base value. In addition, the upper limit of each of the ability parameters can be increased to a value exceeding the common base value by virtue of base ability factors or character factors of the nurtured characters selected by the player as inheritance characters. It can be said that the common base value is the original upper limit of each of the ability parameters. In the case where an ability parameter increases so as to exceed the common base value when training is successful, a special indication is given.

FIG. 23D is a drawing for illustrating a special indication. As described above, values by which ability parameters will increase when the temporarily selected training is successful are displayed in the status display section 213. At this time, suppose that the spirit parameter exceeds 1200, which is the common base value, and further increases up to 1215. In this case, besides the values by which ability parameters increase, a dedicated icon (arrow pointing upward in FIG. 23D) is displayed as a special indication above the status display section 213. Furthermore, in this case, the increase value of the ability parameter is displayed in a color different from the normal case as a special indication. This special indication reports that the ability parameter will increase so as to exceed the common base value, i.e., the original upper limit.

Note that when the temporarily selected training is executed in the aforementioned state, the spirit parameter increases so as to exceed the common base value. In this case, a success presentation is executed as shown in FIG. 23C, and a special indication is also given in this success presentation. In short, not only is a dedicated icon displayed in the status display section 213, but also the numerical value of the ability parameter in the status display section 213 is displayed in a color different from the normal case. Although a case where a special indication is given when an ability parameter exceeds the common base value has been described here, a special indication may be given in the case where an ability parameter reaches or exceeds the common base value.

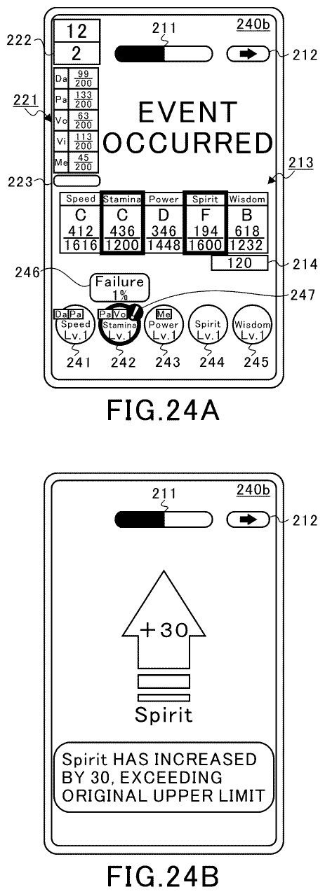

FIG. 24A is a drawing for illustrating an event screen 240b. When the display of the training result report screen 240a ends, the event screen 240b may be displayed on the display 26. Various events are executed on the event screen 240b. Note that in some cases, a plurality of events may occur in one turn.

For example, when a first hint event or a second hint event occurs, a hint for a skill is obtained. Once a skill is hinted, the player can earn the skill by consuming skill points. A plurality of kinds of skills are provided, and a predetermined ability may be invoked for each of the skills. Each of the skills has an invoking condition and an effect defined therefor, so that when an invoking condition is satisfied, an effect defined in advance is invoked. In some cases, a skill may be invoked during the execution of a race, as described below.

Events include, besides a first hint event and a second hint event for possessing skills: an event for recovering the physical strength; an event for decreasing the physical strength; a first ability event and a second ability event for increasing or reducing ability parameters; an event for increasing the physical condition; an event for decreasing the physical condition; etc. Although described below in detail, events include an event the occurrence turn of which is defined in advance and an event that occurs when a predetermined lottery is won. There are also an event occurring at the time a turn is started and an event occurring before a turn ends. When all events that have occurred are completed, the game screen 210 related to the next turn is displayed.

Here, in the case where an event that increases an ability parameter occurs and the ability parameter hence increases so as to exceed the common base value, a special presentation is executed. In short, in the case where the value of an ability parameter increases to 1201 or larger due to the occurrence of an event, a special presentation is executed.

FIG. 24B is a drawing for illustrating a special presentation. In the special presentation, the event screen 240b is displayed, as shown in FIG. 24B. In the special presentation, the increase value of an ability parameter and the kind of the increasing ability parameter are reported. In the example shown in FIG. 24B, the event screen 240b indicates the message “Spirit has increased by 30, exceeding the original upper limit”. Because of this, the player is informed that the spirit ability parameter increases by “30”. Note that in the case where an ability parameter increases within the range up to the common base value, no special presentation is executed, displaying a normal event screen instead. Although a case where a special presentation is executed when an ability parameter exceeds the common base value has been described here, a special presentation may be executed when an ability parameter reaches or exceeds the common base value.

As described above, in this embodiment, a common base value that is set in common among the plurality of ability parameters or the plurality of scenarios is provided. Also, the screen appears differently between when an ability parameter is updated within the range up to the common base value and when the ability parameter is updated so as to exceed the common base value. This satisfies the player because he/she is informed that an ability parameter has increased so significantly as to exceed the common base value.

Here, in the case where the updated numerical value of an ability parameter exceeds the common base value, a special indication or a special presentation is always executed. It should be noted, however, that a special indication or a special presentation for one ability parameter may be executed only when the ability parameter exceeds the common base value for the first time. In this case, it suffices if a success presentation or a normal presentation is executed when, for example, the ability parameter, which already exceeds the common base value, further increases.

In addition, a special indication or a special presentation may be executed when, for example, an ability parameter increases across the common base value. More specifically, a special indication or a special presentation for one ability parameter is executed when the ability parameter exceeds the common base value for the first time. Suppose that thereafter, the numerical value of the ability parameter is decreased below the common base value due to the occurrence of an event, failure in training, or the like. Thereafter, when the ability parameter increases so as to exceed the common base value due to successful training or the like, a special indication or a special presentation is executed again.

Here, in this embodiment, a performance feature is tied to each of the training courses at a predetermined probability. For example, at the start of a turn, a performance feature to be tied to each of the training courses is decided by lottery. Here, up to two performance features are tied to one training course. As shown in FIG. 23A and FIG. 23B, performance features tied to training courses are identifiably displayed in the speed operation section 241 through the wisdom operation section 245.

More specifically, in the example shown in FIG. 23A, two performance features, dance and passion, are tied to the speed training course. In this case, the speed operation section 241 is indicated with “Da” representing dance and “Pa” representing passion. Similarly, the performance features, passion and vocal, are tied to the stamina operation section 242. In addition, the performance feature, mental, is tied to the power operation section 243. On the other hand, no performance features are tied to the spirit and wisdom training courses. It should be noted, however, that at least one performance feature may be always tied to each of training courses in all turns. Also, the same performance feature may be tied to two or more different training courses.

Here, suppose that a training course is selected, and the training is successful. At this time, in the case where a performance feature is tied to the successful training, the parameter of this performance feature tied to the successful training increases. As described above, in the example shown in FIG. 23A, the mental performance feature is tied to the power training course. In a state in which the power training course is temporarily selected, “+10” appears on the right of the mental indication in the performance parameter display section 221. This means that when the power training is successful, the mental performance parameter increases by 10.

Similarly, the example shown in FIG. 23B indicates that when the stamina training is successful, the passion performance parameter increases by 10, and the vocal performance parameter increases by 5. Thus, in a state in which a training course is temporarily selected, values by which performance parameters will increase when the temporarily selected training is successful are displayed in the performance parameter display section 221.

Also, when a training course is decided and the training is successful, the performance parameters increase. FIG. 23C shows a case where the stamina training is successful. Here, as can be seen by comparing between FIG. 23B and FIG. 23C, the passion performance parameter increases by 10, and the vocal performance parameter increases by 5 in the performance parameter display section 221. Note that increase values of performance parameters will be described later.

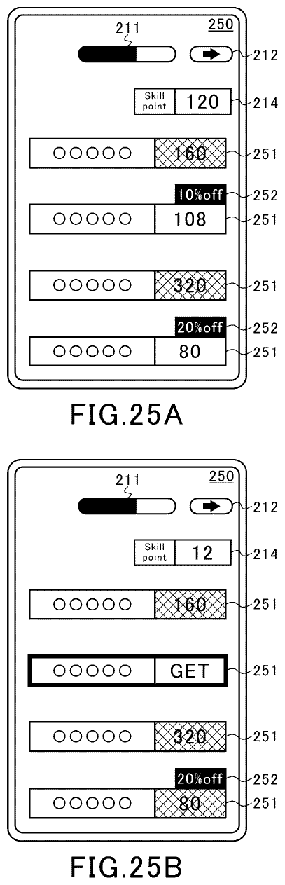

FIG. 25A is a first drawing for illustrating a skill screen 250. FIG. 25B is a second drawing for illustrating the skill screen 250. When the skill operation section 217 on the game screen 210 is operated, the skill screen 250 shown in FIG. 25A is displayed on the display 26.

Skill display fields 251 are displayed on the skill screen 250. An earned skill, a possessed skill that is set in advance in the nurturing-target character, a possessed skill that has been possessed due to the occurrence, etc. of various kinds of events, and so on are displayed in the skill display fields 251. In addition, when a first hint event or a second hint event occurs for a possessed skill, skill points consumed to earn this possessed skill are discounted. Here, for a possessed skill that has been hinted, the skill points required to earn the possessed skill are displayed in terms of a discounted value. At this time, a discount rate display icon 252, which indicates the discount rate, is also displayed in the skill display field 251.

In addition, skills displayed on the skill screen 250 are also indicated with the respective skill invoking conditions and the respective effects that are produced when the skills are invoked. When a possessed skill is earned by consuming skill points on the basis of a player operation, “GET” is displayed on the earned skill to report that the skill has been earned, as shown in FIG. 25B, thereby causing the display to be updated as a result of the consumed skill points being subtracted from the skill points displayed in the skill point display section 214.

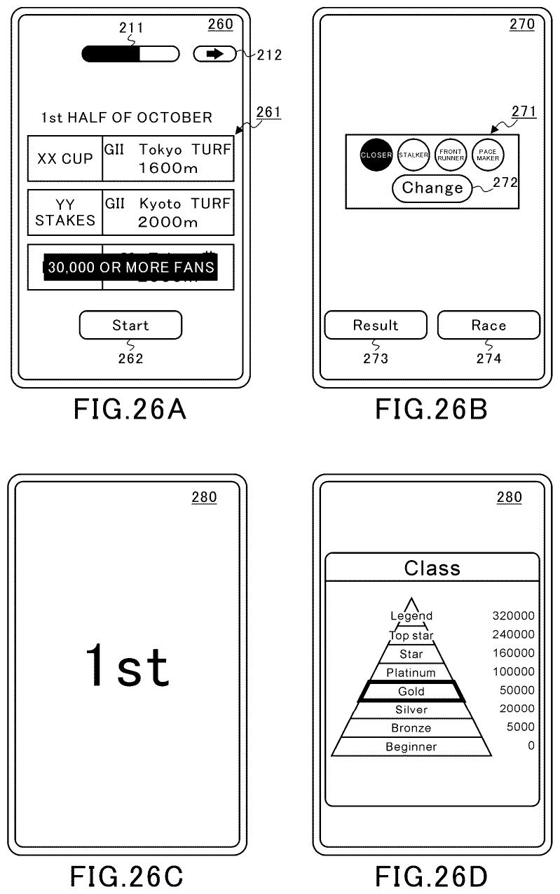

FIG. 26A is a first drawing for illustrating a race selection screen 260. When the race operation section 219 on the game screen 210 is operated, the race selection screen 260 shown in FIG. 26A is displayed. A race has gameplay in which the nurturing-target character races against NPCs.

In the upper section of the race selection screen 260, the physical strength display section 211 and the physical condition display section 212 are displayed. Also, a race selection operation section 261 for selecting a race category in which the nurturing-target character is made to run is displayed in the center of the race selection screen 260. A plurality of race selection operation sections 261 can be displayed on the race selection screen 260. In addition, in the lower section of the race selection screen 260, a start operation section 262 captioned “Start” is displayed. Note that races that can be selected with the race selection operation sections 261 on the race selection screen 260 are set in advance for each of the turns.

In addition, each of the races has a race-participating condition set therefor in advance, so that the player is allowed to cause the nurturing-target character to run only in races satisfying the respective race-participating conditions thereof. As described above, earning a certain number of fans is specified as a race-participating condition in some races. A race-participating condition is displayed in the race selection operation section 261 for a race that does not satisfy the specified number of fans, as shown in FIG. 26A, thereby informing the player that the race cannot be selected.

FIG. 26B is a drawing for illustrating a race start screen 270. When the start operation section 262 is operated while the race category of a race in which the nurturing-target character will run is selected in the race selection operation section 261, the race start screen 270 shown in FIG. 26B is displayed. A strategy display section 271 is displayed in the center of the race start screen 270. In the strategy display section 271, not only is the currently selected strategy (closer, stalker, front runner, or pace maker) highlighted but also a change operation section 272 captioned “Change” is displayed. When the change operation section 272 is operated, a strategy change screen (not shown in the figure) is displayed on the display 26. The player can change the strategy in the race to any strategy via an operation on the strategy change screen.

A result operation section 273 captioned “Result” and a race operation section 274 captioned “Race” are also displayed in the lower section of the race start screen 270.

When the race operation section 274 is operated, a race screen (not shown in the figure) is displayed on the display 26. On the display 26, a video showing the proceeding of the race (hereinafter, also referred to as a race video) appears.

FIG. 26C is a first drawing for illustrating a race result screen 280. FIG. 26D is a second drawing for illustrating the race result screen 280. When playback of the aforementioned race video is completed and when the result operation section 273 is operated, the race result screen 280 is displayed on the display 26. On the race result screen 280, the finish place of the nurturing-target character in the race is displayed, as shown in FIG. 26C. On the race result screen 280, the current class of the nurturing-target character is also displayed, as shown in FIG. 26D.

In this embodiment, the nurturing-target character is categorized into classes according to the number of earned fans. Each of the classes has a range of the number of fans set therefor, and here, the nurturing-target character is categorized as one of eight classes according to the number of fans. The number of fans earned in this race is displayed on the race result screen 280. In addition, the total number of fans obtained by adding the number of newly earned fans to the number of fans that were earned before is displayed on the race result screen 280. Also, the current class corresponding to the total number of fans is identifiably displayed.

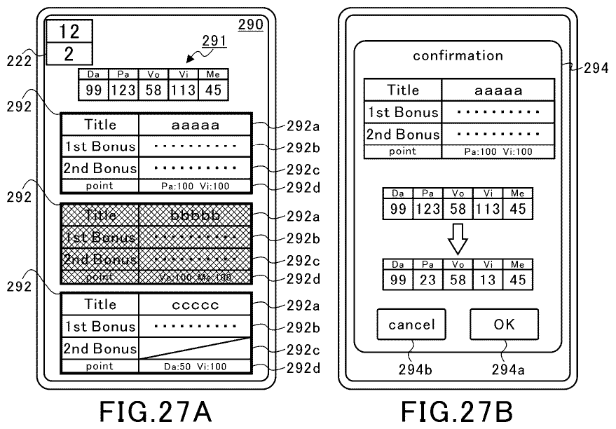

FIG. 27A is a drawing for illustrating an example of a live preparation screen 290. When the live preparation operation section 220 of the game screen 210 is operated, the live preparation screen 290 shown in FIG. 27A is displayed. The live preparation screen 290 is a screen that allows live music, etc. to be earned by consuming performance parameters. A performance parameter display section 291 is displayed in the upper section of the live preparation screen 290. In the performance parameter display section 291, the current parameter value is displayed for each of the five kinds of performance features.

On the live preparation screen 290, three pieces of live music, etc. that can be earned by the player are presented. Below the performance parameter display section 291, a live-music-etc-details display field 292 is displayed for each of the pieces of live music, etc. In short, three live-music-etc-details display fields 292 are always displayed on the live preparation screen 290. Pieces of live music, etc. that differ from one another are tied to the respective live-music-etc-details display fields 292. By tapping a live-music-etc-details display field 292, the player can earn the live music, etc. tied to the live-music-etc-details display field 292.

Each of the live-music-etc-details display fields 292 includes a title display field 292a, a first bonus display field 292b, a second bonus display field 292c, and a consumption parameter display field 292d. The title name of the live music, etc. is displayed in the title display field 292a. The content of a first bonus is indicated in the first bonus display field 292b, and the content of a second bonus is indicated in the second bonus display field 292c. Performance parameters consumed to earn the live music, etc., in other words, performance parameters necessary to earn the live music, etc. are indicated in the consumption parameter display field 292d.

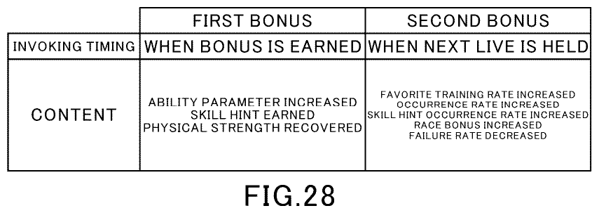

FIG. 28 is a drawing for illustrating an example of the first bonus and the second bonus. Live music, etc. always has a first bonus tied thereto. A first bonus achieves effectiveness advantageous to the player. Examples of effectiveness of a first bonus include an increase in ability parameters, earning of a hint for a skill, and a recovery in the physical strength.

Also, a second bonus, in addition to a first bonus, is tied to some of the pieces of live music, etc. More specifically, there are live skills to which only a first bonus is tied and live music to which both a first bonus and a second bonus are tied. A second bonus, as well as a first bonus, achieves effectiveness advantageous to the player. Examples of effectiveness of a second bonus include an increase in the probability of placing a character in his/her favorite training (favorite training rate), an increase in the probability that an event occurs, an increase in the rate at which a hint for a skill occurs, an increase in a reward (race bonus) to be earned in a race, and a decrease in the failure rate.

Here, a first bonus and a second bonus have different invoking timings of effectiveness. In other words, a first bonus and a second bonus have different timings at which effectiveness is achieved. In the case of a first bonus, effectiveness thereof is achieved in a turn in which the player earns the live music, etc. On the other hand, in the case of a second bonus, effectiveness thereof is achieved in a particular turn that was set in advance and that comes after the turn in which the player earns the live music, etc. More specifically, effectiveness of a second bonus is achieved when the next live event is held, namely, in the next live-event-holding turn.

Effectiveness, which is the content of a first bonus and a second bonus, that will be achieved is indicated in the first bonus display field 292b and the second bonus display field 292c, respectively, shown in FIG. 27A. Note that the second bonus display field 292c of the live-music-etc-details display field 292 displayed as the lowest field in FIG. 27A is blank. This indicates that no second bonus is tied to the live music, etc.

Also, if performance parameters necessary to earn live music, etc. are insufficient, the player cannot earn the live music, etc. displayed on the live preparation screen 290. For live music, etc., that cannot be earned due to insufficient performance parameters, the live-music-etc-details display field 292 is grayed out. In the example shown in FIG. 27A, the live music, etc. corresponding to the top and bottom live-music-etc-details display fields 292 can be earned, and the live music, etc. corresponding to the middle live-music-etc-details display field 292 cannot be earned.

FIG. 27B is a drawing for illustrating a confirmation dialog 294. When the live-music-etc-details display field 292 corresponding to live music, etc. that can be earned is tapped, the confirmation dialog 294 shown in FIG. 27B is displayed. The same information as the information in the live-music-etc-details display field 292 tapped by the player is displayed in the confirmation dialog 294. Also, the current performance parameters, as well as the performance parameters remaining after the relevant live music, etc. is earned, are displayed.

In addition, an execution button 294a and a cancel button 294b are provided in the confirmation dialog 294. When the cancel button 294b is tapped, the confirmation dialog 294 is closed, and the live preparation screen 290 is displayed. When the execution button 294a is tapped, the live music, etc. selected by the player is earned. When live music, etc. is earned, the first bonus tied to the earned live music, etc. is invoked. As a result of the first bonus being invoked, various parameters are updated. Although not shown in the figure, effectiveness achieved by the first bonus is reported in the form of a presentation.

When the player earns live music, etc. as described above, the next three pieces of live music, etc. that can be earned by the player are newly decided. In short, among the three pieces of live music, etc. presented on the live preparation screen 290, the player loses the chance of earning the two pieces of live music, etc. that are not earned by the player.

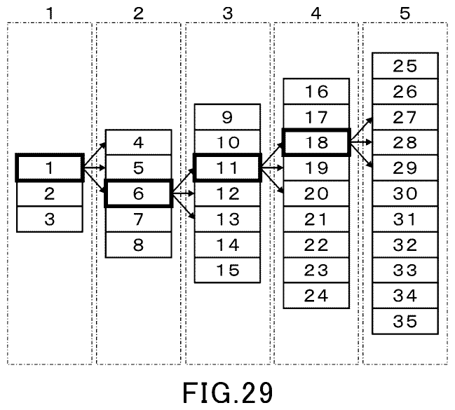

FIG. 29 is a drawing for illustrating an example of live-music-etc-routing information. Live music, etc. presented so as to be earnable by the player is in the form of a so-called tree structure. Suppose that after the start of the nurturing main game, the player is presented with, for example, three pieces of live music, etc. No. 1, No. 2, and No. 3. In the case where the player earns live music, etc. No. 1, the player is then presented with three pieces of live music, etc. No. 4, No. 5, and No. 6. In the case where the player earns live music, etc. No. 6 thereafter, the player is then presented with three pieces of live music, etc. No. 11, No. 12, and No. 13. In the case where the player further earns live music, etc. No. 11, the player is then presented with three pieces of live music, etc. No. 18, No. 19, and No. 20.

Note that a route in FIG. 29 may be looped such that when the route reaches the last one of the horizontally arranged columns, the route continues to a predetermined column. This allows the player to earn live music, etc., regardless of the limit of the tree structure.

Thus, each of the three pieces of live music, etc. presented to the player has the next three pieces of live music, etc. set therefor in advance that are presented so as to be earnable by the player. Types of effectiveness that differ from one another are tied to live music, etc. to be earned by the player. Therefore, which route to follow in order to earn live music, etc. is an important strategy to the player.

Note that, in this embodiment, one piece of live music, etc. cannot be earned in duplicate. Given this constraint, whether or not to display each of the next three pieces of live music, etc. that can be earned by the player may be decided on the basis of whether or not the player has earned the piece of live music, etc. For example, live music, etc. that has already been earned by the player may be hidden, and only live music, etc. that has not been earned by the player may be displayed. At this time, the live music, etc. that has been earned may be replaced with other live music, etc. that has not been earned. Thus, by hiding music, etc. that has been earned, the player is assured of three earnable choices being displayed at all times.

An upper limit may be imposed on the number of pieces of music, etc. that can be earned in a particular turn. In this case, it is a good idea to decide whether or not to display the next three pieces of live music, etc. that can be earned by the player on the basis of whether or not the maximum permitted number of pieces of music, etc. have been earned in the particular turn. This suppresses frequent earning of music, etc. that achieves particularly profound effectiveness in the game, thereby making it possible to enhance the pleasure of the game.

In addition, the method for deciding live music, etc. to be presented to the player is not limited to the above. For example, in the case where the player earns live music, etc., a plurality of pieces of live music, etc. that can be newly earned by the player may be decided by lottery. In this case, the next three pieces of live music, etc. that can be earned by the player may be decided, for example, by lottery. Alternatively, either one of the remaining two pieces of live music, etc. that have not been earned by the player may be retained, so that another two pieces of live music, etc. can be decided by lottery.

Also, for example, three routes including a first route, a second route, and a third route, in each of which the order of one piece of live music, etc. presented to the player is defined, may be provided. In this case, when the player earns live music, etc., for example, in the first route, the next live music, etc. defined in the first route is presented to the player. At this time, live music, etc. in the second route and the third route may be presented as is, or alternatively, the next live music, etc. in the second route and the third route may be presented to the player just as in the case of the first route.

Furthermore, here, the player can earn only one of the three presented pieces of live music, etc. It should be noted, however, that the player may be able to earn two or more of the three pieces of presented live music, etc.

When the player earns live music, etc., live-music-etc-details display fields 292 corresponding to new live music, etc. are displayed on the live preparation screen 290. Therefore, the player can earn a plurality of pieces of live music, etc. in one turn.

In addition, here, a case where the three choices that can be selected by the player are all live music, etc. has been described. It should be noted, however, that three choices that can be selected by the player may include, in addition to live music, etc., a first bonus or a second bonus not tied to live music, etc. For example, No. 1 shown in FIG. 29 may be a first bonus, No. 2 may be a second bonus, and No. 3 may be live music, etc. In this case, when No. 2 is selected, the player is granted a second bonus, and choices No. 5, No. 6, and No. 7 are newly presented.

Also, here, a fixed first bonus and a fixed second bonus are tied to each of the pieces of live music, etc. It should be noted, however, that, for example, a first bonus group or a second bonus group may be tied to each of the pieces of live music, etc. In this case, a winning probability of at least one type of effectiveness is set in advance, separately for each of the first bonus group and the second bonus group. Also, effectiveness to be granted may be decided by lottery on the basis of the first bonus group or the second bonus group tied to the live music, etc. earned by the player.

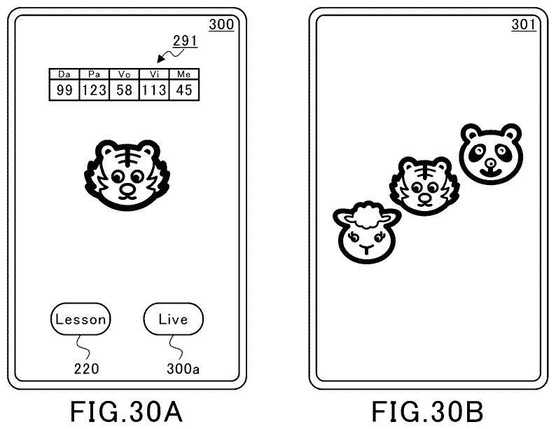

FIG. 30A is a drawing for illustrating an example of a live start screen 300. FIG. 30B is a drawing for illustrating an example of a live event screen 301. In a live-event-holding turn, the live start screen 300 is displayed in place of the game screen 210. The performance parameter display section 291 is displayed on the live start screen 300. In addition, the live preparation operation section 220 and a live start button 300a are displayed in the lower section of the live start screen 300.

When the live preparation operation section 220 is tapped on the live start screen 300, the live preparation screen 290 shown in FIG. 27A is displayed. Therefore, the player can also earn live music, etc. in the live-event-holding turn. Furthermore, when the live start button 300a is tapped, the live event screen 301 shown in FIG. 30B is displayed.

A cut-in image displaying a plurality of characters is included on the live event screen 301. An image that shows the nurturing-target character, etc. performing live is displayed on the live event screen 301. Note that the number of characters displayed on the live event screen 301 is any of one, three, and five. In this case, for example, the larger the number of pieces of live music, etc. earned by the player between live-event-holding turns is, the larger the number of characters displayed on the live event screen 301 may be. Alternatively, the number of characters displayed on the live event screen 301 may be constant.

Also, here, merely a cut-in image is displayed on the live event screen 301, and it is not that a live video is actually displayed. It should be noted, however, that a live video corresponding to actually earned live music, etc. may be output. Alternatively, only live videos corresponding to some of the earned pieces of live music, etc. may be output.

In addition, although described below in detail, this embodiment is specified so as to decide live partner members in turns set in advance. Therefore, rewards granted after the end of the live event may differ depending on the number of live partner members and the character types of the live partner members. More specifically, in a predetermined turn, a character set in advance becomes a live partner member, or a character won in a lottery becomes a live partner member. In short, as the player proceeds through the turns, the number of live partner members gradually increases. At this time, characters to be displayed on the live event screen 301 may be decided by lottery from the live partner members. In this case, the live event screen 301 appears in different manners depending on the proceeding of the nurturing main game, thereby enhancing the pleasure of the game.

In addition, the larger the number of pieces of live music, etc. earned by the player in the time period from the previous live event to the current live event is, the more advantageous the rewards granted after the end of the live event may be. For example, in the case where the number of pieces of live music, etc. earned by the player is smaller than a predetermined number, the live event results in a success, granting a predetermined reward. On the other hand, in the case where the number of pieces of live music, etc. earned by the player is equal to or larger than the predetermined number, the live event results in a big success, granting a reward more advantageous than in a success.

Note that, in this embodiment, even in the case where no live music, etc. has been earned, it is determined that the live event is a success. In this case, it is a good idea to bring about a storyline in which, for example, fixed live music, etc. is performed in the live event. It should be noted, however, that in the case where no live music, etc. is earned in a live-event-holding turn, it may be determined that the live event has failed or the game may end.

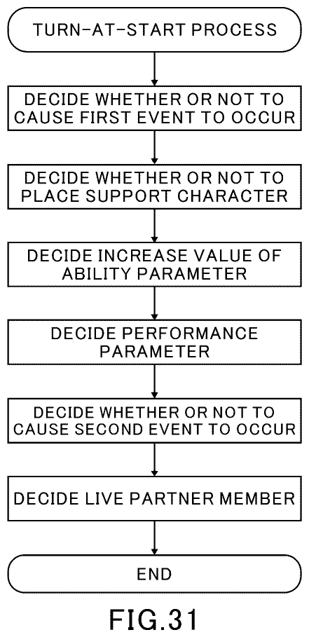

FIG. 31 is a drawing for illustrating the general flow of a turn-at-start process. The nurturing-stage process includes the turn-at-start process, which is executed at the start of each of the turns of the nurturing game. Details of the turn-at-start process are described below. Here, the general flow of the turn-at-start process will be described instead.

During the nurturing main game, a process for deciding whether or not to cause various events to occur is executed in each of the turns. Events are roughly classified into three types: a scenario event, the aforementioned dedicated event provided for each nurturing-target character, and a support event. Note that scenario events, dedicated events, and support events that can occur during the nurturing main game are defined in advance for each scenario.

A scenario event is an event set for each scenario of the nurturing main game. In this embodiment, a plurality of scenarios are provided, and the player can select a scenario. A scenario event occurs for each of the scenarios selected by the player. In other words, scenario events that occur in the nurturing main game are decided on the basis of the scenario selected by the player.

Note that scenario events may include a scenario-specific event and a scenario-common event. A scenario-specific event is an event that is tied to only one scenario. For example, a scenario-specific event tied to the first scenario will occur only if the first scenario is selected, and will not occur if any other scenario is selected.

Also, a scenario-common event is an event that commonly occurs in a plurality of scenarios. Therefore, a scenario-common event occurs both when the first scenario is selected and when the second scenario is selected.

Here, it is assumed that a scenario-specific event and a scenario-common event are provided as a scenario event. It should be noted, however, that only one of the scenario-specific event and the scenario-common event may be provided.

A dedicated event is an event that is set in advance for each character, as described above. In the nurturing main game, there occur dedicated events of the character that has been registered by the player as the nurturing-target character in the setting game, i.e., in the preparatory-stage process.

A support event is an event that is set in advance for each support card, as described above. In the nurturing main game, there occur support events that are tied to the support cards registered by the player in the setting game. Support events include a first event that can occur at the time a turn starts and a second event that can occur after the execution of training. Whether or not a first event occurs is decided on the basis of a randomly acquired random number and a first event table when a turn is started.

Whether or not a second event occurs is decided on the basis of a randomly acquired random number and a second event table after the execution of a process for deciding a support character to be placed in training. Note that only in the case where a support character is placed in training, it is decided whether or not a second event occurs in relation to the placed support character.

This embodiment assumes that a first event is selected by lottery from among the support events tied to the support cards registered in the deck by the player in the preparatory-stage process. Without limitation to this, however, it may be possible to select a support event tied to a support card selected by lottery from among all support cards implemented in the game. In this case, it is preferable that the probability of selecting a support event tied to a support card registered in the deck is set higher than the probability of selecting a support card event tied to a support card not registered in the deck.

Thus, whether or not a scenario event occurs, etc., is decided on the basis of the scenario. In addition, whether or not a dedicated event and a support event occur, etc. is decided on the basis of the nurturing-target character and support cards, respectively. These event types are categorized according to information that is referenced when it is decided whether or not the event occurs, etc.

In contrast, in this embodiment, each event is categorized as one of the six event classifications according to the content produced by the occurrence of the event. Here, each event is categorized as one of the following event classifications: a first hint event, a second hint event, a first ability event, a second ability event, an aptitude event, and a story event.

As described above, a first hint event and a second hint event are events that enable a skill to be possessed or earned. In addition, a first ability event and a second ability event are events that increase or decrease ability parameters of the nurturing-target character. An aptitude event is an event that increases or decreases aptitude parameters of the nurturing-target character. A story event is an event that displays a story related to a character appearing in the nurturing game. In addition to displaying a story, some story events change ability parameters or aptitude parameters.

Here, scenario events include a first hint event, a second hint event, a first ability event, a second ability event, an aptitude event, and a story event. In addition, dedicated events and support events include a first hint event, a second hint event, a first ability event, and a second ability event. Note that dedicated events may include a story event.

In this embodiment, the turn-at-start process includes, in addition to a process for deciding a scenario event and a process for deciding a dedicated event: a “process for deciding whether or not to cause a first event to occur”; a “process for deciding whether or not to place a support character”; a “process for deciding an increase value of an ability parameter”; a “process for deciding a performance parameter”; a “process for deciding whether or not to cause a second event to occur”; and a “process for deciding a live partner member”, as shown in FIG. 31. Although various other processes are executed in the turn-at-start process, the processes shown in FIG. 31 will be described in order here.

### <Process for Deciding Whether or not to Cause First Event to Occur>

A first event is selected by lottery from among the support events (first events) tied to the support cards registered by the player in the preparatory-stage process. More specifically, when a turn is started, a random number is randomly acquired, and whether or not to cause a first event to occur and the content of the first event are decided on the basis of the acquired random number and the first event table. The selection ratio of whether a first event is made to “occur” or “not to occur” is set in the first event table. In this embodiment, first events include four types of events: event a, event b, event c, and event d. For example, in the first event table, the probability of causing each of the events (events a to d) to “occur” is set to 20%, and the probability of causing a first event “not to occur” is set to 20%. Note that the selection ratio of first events may be set individually for each of the support cards, namely, support characters.

### <Process for Deciding Whether or not to Place Support Character>

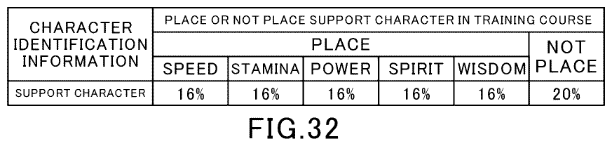

FIG. 32 is a drawing for illustrating a placement probability table. As shown in FIG. 32, the selection ratio of whether or not to place a support character in a training course (“place” or “not place” a support character in any of the training courses) is set in the placement probability table. In this embodiment, whether or not to place each of the support characters corresponding to all the support cards registered by the player in the preparatory-stage process is decided on the basis of the placement probability table shown in FIG. 32. More specifically, when a turn is started, a random number is randomly acquired, and whether or not to place each of the support characters in a training course is decided on the basis of the acquired random number and the placement probability table. Without limitation to this, however, the process for deciding whether or not to place each of the support characters in a training course may be applied to the support characters selected by lottery from among the support characters corresponding to all support cards implemented in the game.

More specifically, in this embodiment, the probability of “placing” a support character in any of the speed, stamina, power, spirit, and wisdom training courses is 16%, and the probability of “not placing” a support character in any of the training courses is 20%, as shown in FIG. 32. Note that a plurality of kinds of favorite training are set in a support character, as shown in FIG. 19A. Thus, for example, the selection ratio of placing a support character in each of the training courses may be set so as to be higher in the case where the support character is placed in a training course corresponding to its favorite training than in the case where the support character is placed in a training course corresponding to training other than its favorite training. When a lottery is to be drawn, a lottery table in which a selection ratio for the lottery is defined may be pre-stored, or alternatively, a lottery table may be generated each time a lottery is drawn.

Note that when a training course to place a support character in is decided, the support character decided to be placed and the decided training course may be stored in the server 1000 so as to be tied to each other. More specifically, tying information in which the training ID indicating the type of the training course is tied to the character ID of the support character or the support card ID of the support card tied to the support character may be stored in the server 1000.

### <Process for Deciding Increase Value of Ability Parameter>

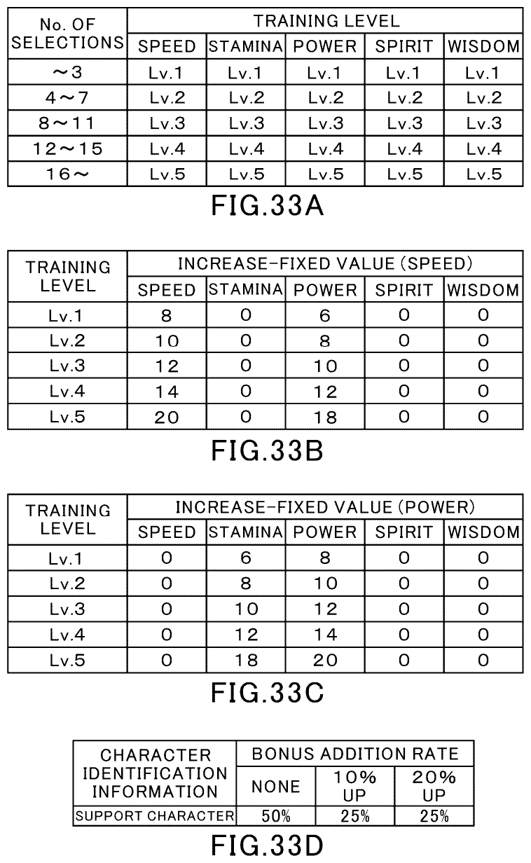

FIG. 33A is a drawing for illustrating a training level table. As shown in FIG. 33A, the training level of each of the training courses is set to increase according to the number of times the training course is selected. More specifically, each of the training levels related to speed, stamina, power, spirit, and wisdom is set to “level 1” if the number of times the training is selected is three or less, each of the training levels is set to “level 2” if the number of times the training is selected is four to seven, each of the training levels is set to “level 3” if the number of times the training is selected is eight to 11, each of the training levels is set to “level 4” if the number of times the training is selected is 12 to 15, and each of the training levels is set to “level 5” if the number of times the training is selected is 16 or more.

In this embodiment, when the training selected by the player is successfully executed, the values of predetermined ability parameters are increased according to the executed training course.

More specifically, in this embodiment, when the speed training is successfully executed, the values of the speed and power ability parameters are increased.

In addition, when the stamina training is successfully executed, the values of the stamina and spirit ability parameters are increased.

Furthermore, when the power training is successfully executed, the values of the stamina and power ability parameters are increased.

Also, when the spirit training is successfully executed, the values of the speed, power, and spirit ability parameters are increased.

In addition, when the wisdom training is successfully executed, the values of the speed and wisdom ability parameters are increased.

In this embodiment, the value of an ability parameter that increases when training is successful is calculated by adding, to an increase-fixed value that is decided in accordance with the executed training course and the training level, a value obtained by multiplying the increase-fixed value by a bonus addition rate described below.

FIG. 33B is a drawing for illustrating an increase-fixed value (speed) table. In addition, FIG. 33C is a drawing for illustrating an increase-fixed value table (power). Namely, FIG. 33B shows increase-fixed values in the case where the training course is speed. Also, FIG. 33C shows increase-fixed values in the case where the training course is power.

As shown in FIG. 33B and FIG. 33C, increase-fixed values decided corresponding to the executed training course and training level are stored in the increase-fixed value tables. In addition, in this embodiment, the higher the training level, the greater the increases in the ability parameters, as shown in FIG. 33B and FIG. 33C.

Although not described here, there are also increase-fixed value tables used when stamina, spirit, and wisdom are selected as training courses.

In addition to the aforementioned increase-fixed values, bonus addition rates are decided for each of the training courses on the basis of the placed support characters.

FIG. 33D is a drawing for illustrating a bonus addition rate table. In this embodiment, a bonus addition rate is decided on the basis of the support character decided to be placed in each of the training courses. More specifically, the selection ratio among the bonus addition rates of a 0% increase (none), a 10% increase, and a 20% increase is stored for each of the support characters in the bonus addition rate table, as shown in FIG. 33D.

For the bonus addition rate, “none” is selected with a probability of 50%, a “10% increase” is selected with a probability of 25%, and a “20% increase” is selected with a probability of 25%.

Also, a bonus addition value is derived by multiplying the increase-fixed value decided on the basis of the increase-fixed value table by the bonus addition rate. The value obtained by adding the bonus addition value to the increase-fixed value is decided to be the amount of increase in the value of the corresponding ability parameter in the case of successful training. Note that for training in which a plurality of support characters are placed, the bonus addition values for the respective placed support characters are added to the increase-fixed value. In this way, the amounts of increase in ability parameters of the nurturing-target character in the case of successful training are decided for all training types.

### <Process for Deciding Performance Parameters>

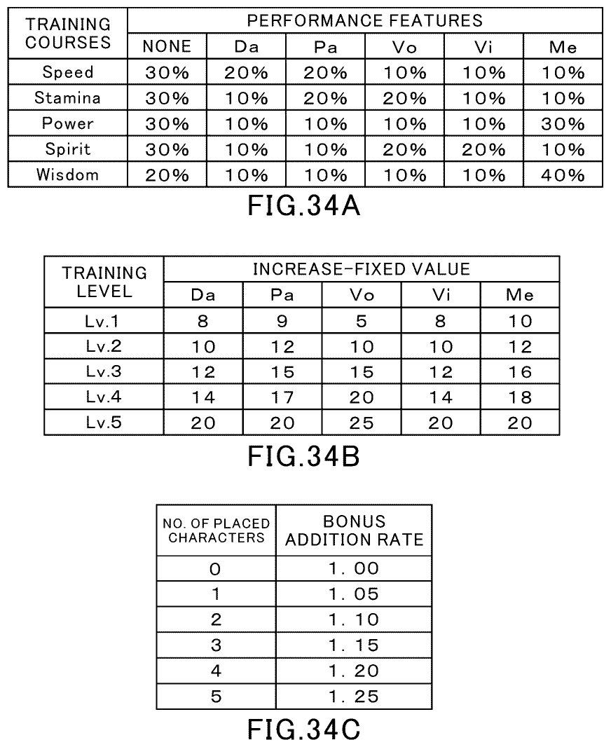

FIG. 34A is a drawing for illustrating performance features tied to training courses. In a turn in which training can be executed, whether or not to tie a performance feature to each of the five training courses, as well as a performance feature to be tied to each of the five training courses, is decided at the start of the turn. More specifically, first, whether or not to tie a performance feature to the speed training course is decided by lottery.

At this time, the probability of deciding that no performance feature is tied to the speed training course (indicated as “None” in the figure) is set as 30%. In addition, the probabilities of deciding that the dance, passion, vocal, visual, and mental performance features are tied to the speed training course are set as 20%, 20%, 10%, 10%, and 10%, respectively.

Furthermore, for example, the probability of deciding that no performance feature is tied to the power training course is set as 30%. In addition, the probabilities of deciding that the dance, passion, vocal, visual, and mental performance features are tied to the power training course are set as 10%, 10%, 10%, 10%, and 30%, respectively. Here, as shown in FIG. 34A, the probabilities that performance features are tied are set in advance, classified by training course and by performance feature.

Note that, in this embodiment, up to two performance features can be tied to one training course in one turn. Therefore, for example, in the case where a performance feature to be tied to the speed training course is decided, a lottery having the probabilities shown in FIG. 34A is drawn twice. If the results of these two lotteries are “None”, then no performance feature is tied to the speed training course.

In addition, if the results of these two lotteries are, for example, dance, then only the dance performance feature is tied to the speed training course. Note that if a performance feature is decided in the first lottery, a second lottery may be drawn by excluding the performance feature decided in the first lottery. In this case, the probability that each of the performance features is decided in the first lottery may differ from that in the second lottery.

Also, here, the same performance feature can be tied to a plurality of training courses in one turn. For example, the dance performance feature can be tied to both speed and stamina, depending on lottery results. It should be noted, however, that the game may be designed so as not to tie the same performance feature to two or more training courses in duplicate in one turn.

Furthermore, here, some performance features are tied to one training course at a high probability, and other performance features are tied to the same training course at a low probability. For example, the dance and passion performance features are tied to the speed training course at a higher probability than the other performance features are.

In addition, a performance feature is tied to some training courses at a high probability, and the same performance feature is tied to the other training courses at a low probability. For example, the mental performance feature is tied to the power and wisdom training courses at a higher probability than to the other training courses.

It should be noted, however, that each of the performance features may be tied to all the training courses at the same probability. Furthermore, all the performance features may be tied to each of the training courses at the same probability. In any case, the probabilities shown in FIG. 34A are merely examples. In addition, the method for deciding a performance feature to be tied to a training course can be designed, as appropriate.

FIG. 34B is a drawing for illustrating increase-fixed values of performance parameters. When performance features tied to training courses are decided, increase-fixed values of performance parameters are then decided for each of the performance features tied to the training courses. An increase-fixed value is set in advance for each of the performance features. Also, an increase-fixed value is set for each of the training levels of the training courses.

FIG. 34B shows increase-fixed values of the speed training course. For example, suppose that the dance performance feature is tied to the speed training course. In this case, an increase-fixed value of the dance performance parameter tied to the speed training course is decided. At this time, the increase-fixed value is decided to be 8 if the speed training level is level 1, and the increase-fixed value is decided to be 20 if the speed training level is level 5. Also, as is obvious from FIG. 34B, the higher the training level, the larger the increase-fixed value.

Here, it is assumed that the increase-fixed values for each of the training levels differ depending on the training course. In short, the table shown in FIG. 34B is provided for each of the training courses. It should be noted, however, that the table shown in FIG. 34B may be common to all the training courses.

FIG. 34C is a drawing for illustrating bonus addition rates of performance parameters. When an increase-fixed value is decided as described above, a bonus addition rate is then decided. The bonus addition rate differs depending on the number of characters placed in the training course to which the performance feature is tied. For example, suppose that the dance performance feature is tied to the speed training course with a training level of level 5. At this time, the increase-fixed value of the dance performance parameter is 20.

Also, in the case where no characters are placed in the speed training course, the bonus addition rate is decided to be 1.00. In addition, in the case where one to five characters are placed in the speed training course, the bonus addition rate is decided to be a value from 1.05 to 1.25 depending on the number of placed characters, as shown in FIG. 34C. Here, the larger the number of placed characters, the higher the bonus addition rate.

An increase value of the performance parameter is calculated by multiplying the bonus addition rate by the increase-fixed value. In the aforementioned example, if the number of characters placed in the speed training course is 0, the increase value of the performance parameter is calculated as 20×1.00=20. Also, if the number of characters placed in the speed training course is 5, the increase value of the performance parameter is calculated as 20×1.25=25. The increase values of performance parameters calculated in this manner are displayed in the performance parameter display section 221, as shown in FIG. 23A.

Note that the aforementioned method for calculating an increase value of a performance parameter is merely an example. For example, an increase value of a performance parameter may be decided by lottery. Also, the bonus addition rate is not essential. Moreover, a bonus addition rate may be decided on the basis of another factor instead of, or in addition to, the number of placed characters.

### <Process for Deciding Whether or not to Cause Second Event to Occur>

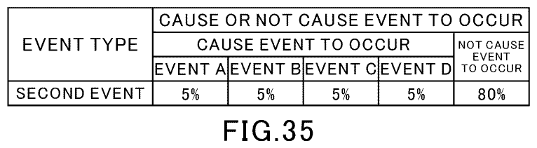

FIG. 35 is a drawing for illustrating a second event table. A second event is selected by lottery from among the support events (second events) tied to the support cards corresponding to the support characters placed in each of the training courses. More specifically, after the “process for deciding whether or not to place a support character”, a random number is randomly acquired, and whether or not to cause a second event to occur is decided on the basis of the acquired random number and the second event table. The selection ratio of whether a second event is made to “occur” or “not to occur” is set in the second event table.

For example, as shown in FIG. 35, second events include four types of events: event A, event B, event C, and event D. For example, in the second event table, the probability of causing each of the events (events A to D) to “occur” is set to 5%, and the probability of causing a second event “not to occur” is set to 80%. Note that the selection ratio of second events may be set individually for each of the support cards, namely, support characters.

In this embodiment, after the “process for deciding whether or not to place a support character”, a process for deciding whether or not to cause a second event to occur is executed for all support characters placed in each of the training courses. Then, on the basis of a decision as to the occurrence of a second event, an event report indicator 247 is displayed on the training screen 240. When the player selects training in which a character whose second event is decided to occur is placed, the second event occurs after the execution of training.

For example, when the speed training is executed in the case where the occurrence of a second hint event of a support character placed in the speed training is decided, the second hint event always occurs after the execution of the speed training. However, when training other than the speed training is executed, this second hint event does not occur after the execution of the training. At this time, if the occurrence of second events has been decided for at least two characters, which of the second events is made to occur is decided by lottery or on the basis of priorities, etc. of the support events set in advance.

For example, which of the plurality of second events is made to occur is decided at equal probabilities. Without limitation to this, however, weightings may be set according to the type of second event, so that which of the plurality of second events is made to occur can be decided according to the set weightings. Note that if the occurrence of second events has been decided for at least two characters, all of the decided second events may be made to occur.

Here, for example, when the occurrence of a second event is decided, occurrence information indicating whether or not to cause a support event to occur may be stored in the server 1000 so as to be tied to the support card or the support character tied to the second event. More specifically, tying information in which occurrence information is tied to the character ID of the support character or the support card ID of the support card tied to the support character may be stored in the server 1000.

### <Process for Deciding Live Partner Member>

As described above, a live partner member is decided in turns set in advance. Note that the method for deciding a live partner member is not particularly limited. For example, a character set in advance may be decided as a live partner member for each of the predetermined turns. Alternatively, a character serving as a live partner member may be decided by lottery for each of the predetermined turns. Furthermore, a character serving as a live partner member may be decided by lottery in all turns.

The nurturing game ends when all turns are completed in the aforementioned nurturing main game. If, in the course of the nurturing main game, the player fails to achieve the goals set for each character, the nurturing game ends at that point.

Here, when the nurturing game ends, the nurturing-target character nurtured in the nurturing game is stored as a nurtured character. More precisely, information concerning the nurtured character that has been nurtured in the nurturing game (hereinafter, referred to as “nurtured character information”) is stored so as to be tied to the player ID. Note that the nurtured character information is stored in both the player terminal 1 and the server 1000. Nurtured character information stored so as to be tied to the player ID includes ability parameters, aptitude parameters, earned skills, inheritance information, etc.

In addition, when the nurturing game ends, an evaluation score of the nurtured character that has been nurtured is calculated. Here, an evaluation score is calculated on the basis of the ability parameters, aptitude parameters, earned skills, race records, etc. as of the end of the nurturing game. Note that the method of calculating the evaluation score, in other words, a calculation formula for calculating the evaluation score, is prepared in advance, and the evaluation score is calculated on the basis of the predetermined calculation formula. The method and calculation formula for calculating the evaluation score are not particularly limited. For example, an evaluation score may be calculated on the basis of only parameters that affect the result of a race in a team competition game or another race game when the nurtured character runs in the race, such as ability parameters, aptitude parameters, earned skills, etc. as of the end of the nurturing game.

In addition, a nurturing rank is set for the nurtured character on the basis of the evaluation score. The nurturing rank is an indicator of the strength of the nurtured character, and each nurturing rank is associated with a range of evaluation scores. For example, a nurtured character with an evaluation score between 13000 and 14499 is assigned an “A+” nurturing rank, and a nurtured character with an evaluation score between 14500 and 15499 is assigned an “S” nurturing rank. In this way, it is easier to understand the general strength of a nurtured character as a result of a nurturing rank being assigned on the basis of the evaluation score. Note that the evaluation score and the nurturing rank are also included in the nurtured character information.

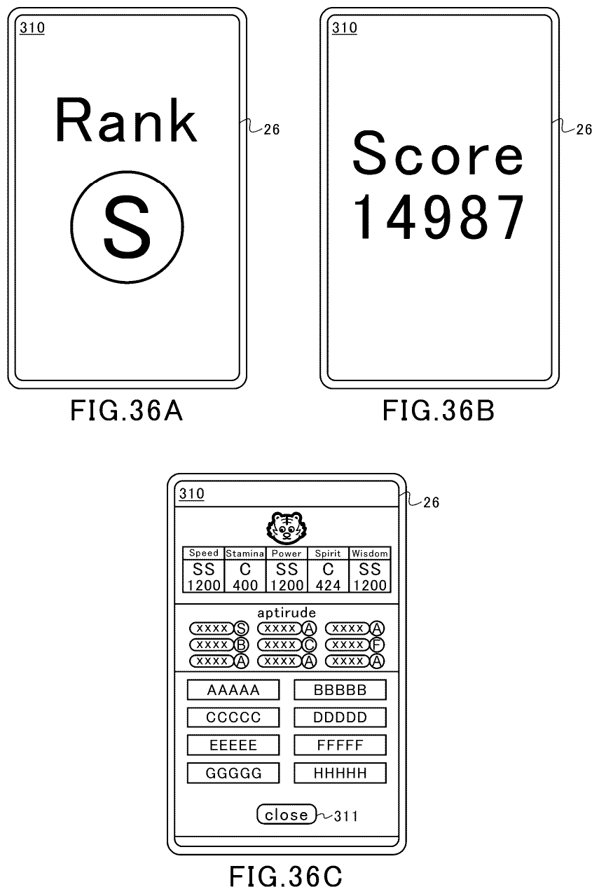

FIG. 36A is a first drawing for illustrating a nurturing completion screen 310. FIG. 36B is a second drawing for illustrating the nurturing completion screen 310. FIG. 36C is a third drawing for illustrating the nurturing completion screen 310. When the nurturing game is completed, the nurturing completion screen 310 is displayed on the display 26, as shown in FIG. 36A. On the nurturing completion screen 310, the nurturing rank of the nurtured character that has been nurtured is first displayed, followed by the display of the evaluation score as shown in FIG. 36B.

In addition, a predetermined amount of time after the display of the evaluation score, the ability parameters, aptitude parameters, and earned skills of the nurtured character are displayed on the nurturing completion screen 310, as shown in FIG. 36C. At this time, a close operation section 311 is provided on the nurturing completion screen 310. When the close operation section 311 is tapped, the nurturing completion screen 310 is hidden, and the home screen 100 is displayed on the display 26.

When the nurturing game is completed, a lottery is drawn for factors to be earned by the nurturing-target character, and the factor information is stored so as to be tied to the nurtured character. Although not shown in the figure, the player can display the factor information earned by the nurtured character on the nurturing completion screen 310.

As described above, in the nurturing game, a nurtured character with ability parameters, aptitude parameters, earned skills, etc. is created. In the nurturing game, the placement of support characters, the occurrence of various events, etc. are decided by lottery, so that even if the same character is used as the nurturing-target character, nurtured characters with different parameters are created.

As described above, a plurality of scenarios are provided in this embodiment. Also, the player plays a nurturing game by selecting any of the scenarios. In this embodiment, all scenarios are common in the following respects. That is, nurtured characters created at the end of nurturing games have common parameters, including speed, stamina, power, spirit, wisdom, distance aptitudes, and racetrack aptitudes, regardless of the scenario. In addition, a nurtured character created in a nurturing game is managed as a nurturing-completed game medium common to all scenarios.

It should be noted, however, that the nurtured character has data tied thereto indicating the scenario in which the nurtured character itself has been nurtured. The scenario in which the nurtured character has been nurtured is displayed on the screen showing detailed information concerning the nurtured character.

Furthermore, when a nurturing game is started, game points common to all scenarios are consumed. In this embodiment, the game points consumed when a nurturing game is started are common to all scenarios. It should be noted, however, that game points to be consumed may differ depending on the scenario. Also, no matter which scenario a nurtured character has been nurtured in, the nurtured character can be used in other games (e.g., race games, which are games to be played by consuming parameters different from the game points).

In addition, nurturing-target characters, inheritance characters, and support cards that can be selected by the player are common to all scenarios. It should be noted, however, that at least the nurturing-target characters, inheritance characters, or support cards that can be selected by the player may differ depending on the scenario.

Also, for example, the processes that are executed by a nurturing-at-completion processing unit 702a or a nurturing game end processing unit 1102a when nurturing is completed may be common to all scenarios. Note that factors granted to nurtured characters may be common or different among all scenarios.

In addition, in this embodiment, the player can save interruption data while playing a nurturing game, regardless of the scenario. In other words, whichever scenario is used for a nurturing game, the player can return to the home screen 100 by interrupting the nurturing game. Also, the player can resume the nurturing game from the interrupted point on the basis of the interruption data. Note that the number of items of interruption data that can be saved at a time is only one and common to all scenarios. However, it is also acceptable that interruption data can be saved individually for each of the scenarios. In this case, the player is allowed to select a scenario with which the nurturing game is resumed.

In addition, in this embodiment, the following respects differ from scenario to scenario. That is, at least some of the events occurring in the nurturing game differ from scenario to scenario. Furthermore, the types of commands that can be selected by the player during the nurturing game differ from scenario to scenario. It should be noted, however, that the types of commands that can be selected by the player during the nurturing game may be common to all scenarios.

Also, the amount by which a parameter increases, in other words, a calculation expression for calculating the amount of increase in a parameter, when a predetermined command is executed differs depending on the scenario. Furthermore, background images and user interface images (buttons, etc.) that are displayed during the nurturing game, as well as data that is tied to a nurtured character and that indicates the scenario in which the nurtured character has been nurtured, differ depending on the scenario.

Next, functional configurations of the player terminal 1 and the server 1000 for executing the aforementioned nurturing game will be described.

### (Functional Configuration of Player Terminal 1)

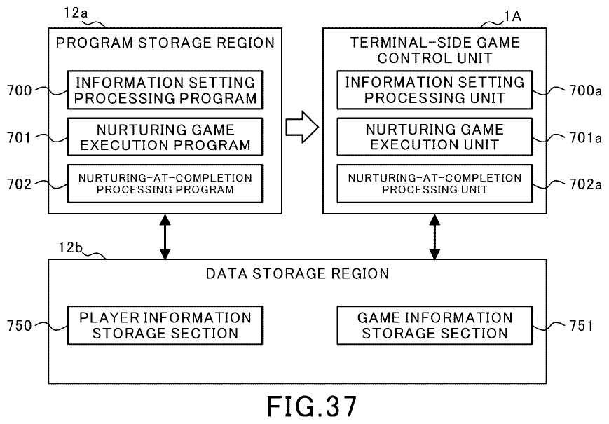

FIG. 37 is a drawing for illustrating the configuration of the memory 12 in the player terminal 1 and functions of the player terminal 1 as a computer. A program storage region 12a and a data storage region 12b are provided in the memory 12. When a game is started, the CPU 10 stores terminal-side game control programs (modules) in the program storage region 12a.

The terminal-side game control programs include: an information setting processing program 700; a nurturing game execution program 701; and a nurturing-at-completion processing program 702. Note that the programs listed in FIG. 37 are examples, and many other programs are provided as the terminal-side game control programs.

In the data storage region 12b, a player information storage section 750 and a game information storage section 751 are provided as storage sections for storing data. Note that many other storage sections are provided in the data storage region 12b. Here, information directly related to a game (hereinafter, referred to as game information), such as the nurturing game, is stored in the game information storage section 751.

Note that various kinds of information while each game, such as the nurturing game, is proceeding are also temporarily stored in the game information storage section 751. Therefore, all information related to a nurtured character nurtured in the nurturing game is stored in the game information storage section 751. In addition, all information other than the game information, such as information concerning the player or other players, setting information of the player terminal 1, and information concerning a character that can be set as a nurturing-target character, is player information. The player information is stored in the player information storage section 750.

The CPU 10 runs the individual programs stored in the program storage region 12a and updates the data in the individual storage sections of the data storage region 12b. Furthermore, the CPU 10 runs the individual programs stored in the program storage region 12a, thereby causing the player terminal 1 (computer) to function as a terminal-side game control unit 1A. The terminal-side game control unit 1A includes: an information setting processing unit 700a; a nurturing game execution unit 701a; and the nurturing-at-completion processing unit 702a.

More specifically, the CPU 10 runs the information setting processing program 700, thereby causing the computer to function as the information setting processing unit 700a. Similarly, the CPU 10 runs the nurturing game execution program 701 and the nurturing-at-completion processing program 702, thereby causing the computer to function as the nurturing game execution unit 701a and the nurturing-at-completion processing unit 702a, respectively.

When various kinds of information settings are made at the player terminal 1, the information setting processing unit 700a stores, in the player information storage section 750, information concerning the settings as player information. In addition, when information in the player information storage section 750 is updated, the information setting processing unit 700a transmits update information to the server 1000.

The nurturing game execution unit 701a executes all processes related to the nurturing game. More specifically, the nurturing game execution unit 701a executes the preparatory-stage process and the nurturing-stage process.

When the nurturing game is completed, the nurturing-at-completion processing unit 702a stores nurtured character information including ability parameters, aptitude parameters, earned skills, inheritance information, and factor information of the nurtured character, character types used to nurture the nurtured character, etc.

### (Functional Configuration of Server 1000)

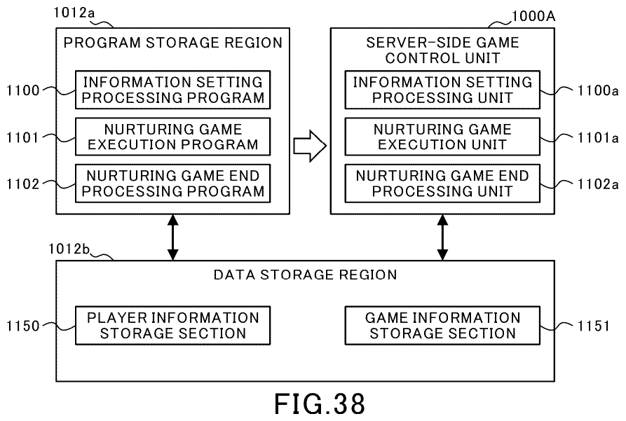

FIG. 38 is a drawing for illustrating the configuration of the memory 1012 in the server 1000 and functions of the server 1000 as a computer. A program storage region 1012a and a data storage region 1012b are provided in the memory 1012. When a game is started, the CPU 1010 stores server-side game control programs (modules) in the program storage region 1012a.

The server-side game control programs include: an information setting processing program 1100; a nurturing game execution program 1101; and a nurturing game end processing program 1102. The programs listed in FIG. 38 are examples, and many other programs are provided as the server-side game control programs.

In the data storage region 1012b, a player information storage section 1150 and a game information storage section 1151 are provided as storage sections for storing data. Note that many other storage sections are provided in the data storage region 1012b. Here, game information of all players is stored in the game information storage section 1151 so as to be tied to the respective player IDs. In addition, player information of all players is stored in the player information storage section 1150 so as to be tied to the respective player IDs.

The CPU 1010 runs the individual programs stored in the program storage region 1012a and updates data in the individual storage sections in the data storage region 1012b. Also, the CPU 1010 runs the individual programs stored in the program storage region 1012a, thereby causing the server 1000 (computer) to function as a server-side game control unit 1000A. The server-side game control unit 1000A includes: an information setting processing unit 1100a; a nurturing game execution unit 1101a; and the nurturing game end processing unit 1102a.

More specifically, the CPU 1010 runs the information setting processing program 1100, thereby causing the computer to function as the information setting processing unit 1100a. Similarly, the CPU 1010 runs the nurturing game execution program 1101 and the nurturing game end processing program 1102, thereby causing the computer to function as the nurturing game execution unit 1101a and the nurturing game end processing unit 1102a, respectively.

When various kinds of information settings are made at the player terminal 1, the information setting processing unit 1100a updates the player information in the player information storage section 1150 on the basis of the update information received from the player terminal 1. In addition, the information setting processing unit 1100a performs time keeping and updates game points of each player.

The nurturing game execution unit 1101a executes all processes related to the nurturing game. More specifically, the nurturing game execution unit 1101a executes the preparatory-stage process and the nurturing-stage process.

When the nurturing game ends, the nurturing game end processing unit 1102a derives an evaluation score, a nurturing rank, etc. for the nurtured character that has been nurtured. In addition, the nurturing game end processing unit 1102a decides factors to be earned by the nurtured character by lottery. The nurturing game end processing unit 1102a also stores, in the game information storage section 1151, nurtured character information including ability parameters, aptitude parameters, earned skills, inheritance information, and factor information of the nurtured character, character types used to nurture the nurtured character, etc. so as to be tied to the player ID.

Although the information setting processing unit 700a in the player terminal 1 and the information setting processing unit 1100a in the server 1000 are common in that both units store player information, they differ in specific processing details and the scope of the player information to be stored. In addition, although the nurturing game execution unit 701a and the nurturing-at-completion processing unit 702a in the player terminal 1 and the nurturing game execution unit 1101a and the nurturing game end processing unit 1102a in the server 1000 are common in that all units execute processes related to the nurturing game, they differ in their roles, i.e., the scope of their responsibilities.

Processes to be executed by the aforementioned individual functional units in the player terminal 1 and server 1000 will be described below by using flowcharts.

### (Processes of Player Terminal 1 and Server 1000)

### <Processes Related to Nurturing Game>

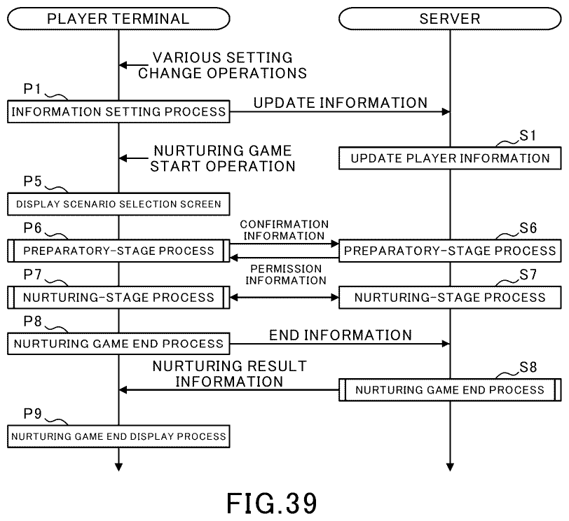

FIG. 39 is a sequence diagram for illustrating processes of the player terminal 1 and the server 1000 related to the nurturing game. Note that, in the following description, processes in the player terminal 1 are denoted as Pn (n is any integer). Furthermore, processes in the server 1000 are denoted as Sn (n is any integer).

When the player performs various setting change operations at the player terminal 1, the information setting processing unit 700a of the player terminal 1 executes an information setting process (P1) for updating the player information storage section 750 on the basis of the player operation inputs. In this information setting process, the update information is transmitted to the server 1000. At the server 1000, upon receiving the update information, the information setting processing unit 1100a updates the player information in the player information storage section 1150 (S1).

Note that the player information updated in P1 and S1 includes, for example, profile information that can be set by the player. Also, for example, when an operation for adding another player as a friend or for unregistering a friend is input as a setting change operation, friend information indicating information concerning friends is updated. Note that, in P1 and S1, each of the information setting processing unit 700a and the information setting processing unit 1100a manages game points to be consumed to execute a nurturing game. If the game points are below the upper limit, the information setting processing units 700a and 1100a perform time keeping and grant a predetermined value of game points to the player every predetermined time.

Suppose that a nurturing game start operation (tapping the nurturing game operation section 104) for starting a nurturing game is input at the player terminal 1. When the nurturing game start operation is input, the nurturing game execution unit 701a displays the scenario selection screen (P5) and then executes the preparatory-stage process (P6). Note that, on the scenario selection screen, the nurturing game execution unit 701a allows the player to select a plurality of scenarios in which at least some of the events occurring during the nurturing game differ from one another. In addition, during the preparatory-stage process, communication processes are executed between the player terminal 1 and the server 1000. At the server 1000, the nurturing game execution unit 1101a executes the preparatory-stage process (S6) on the basis of information received from the player terminal 1.

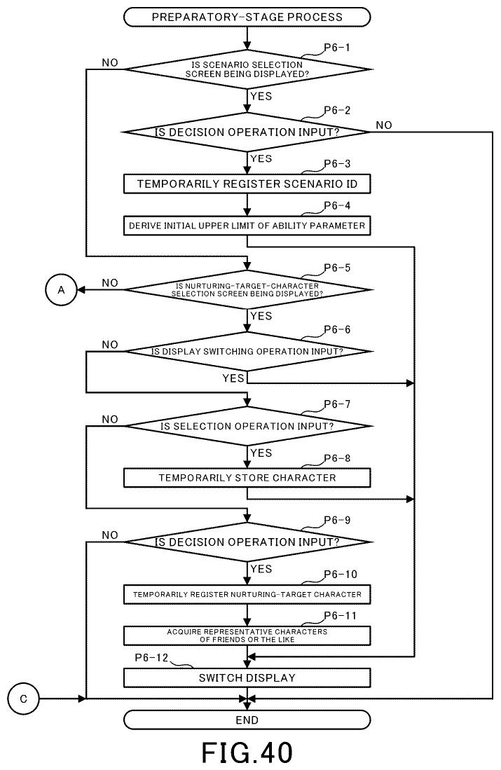

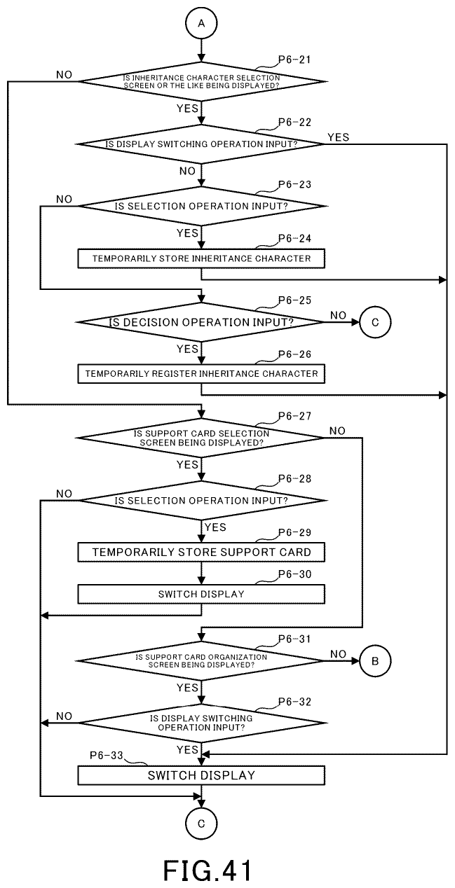

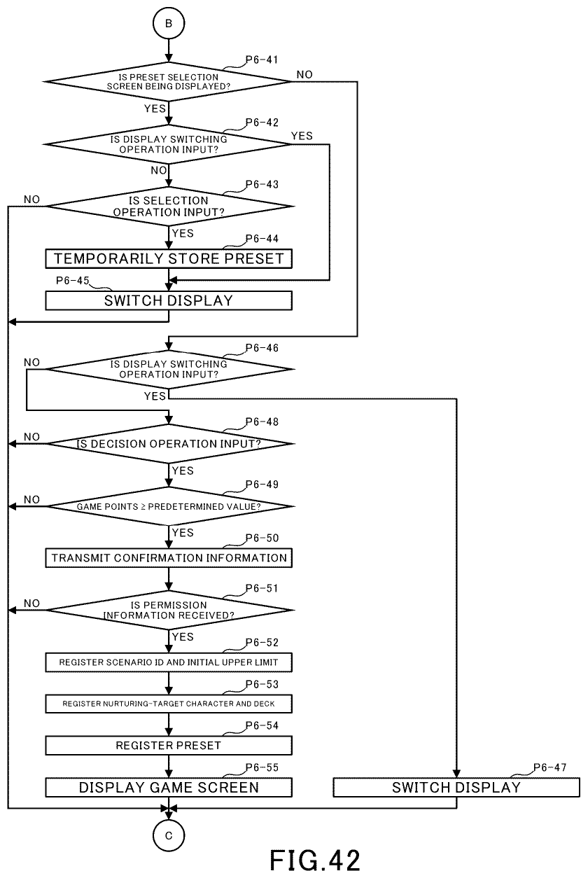

FIG. 40 is a first flowchart for illustrating the preparatory-stage process (P6) in the player terminal 1. FIG. 41 is a second flowchart for illustrating the preparatory-stage process (P6) in the player terminal 1. FIG. 42 is a third flowchart for illustrating the preparatory-stage process (P6) in the player terminal 1. The nurturing game execution unit 701a of the player terminal 1 determines whether or not the scenario selection screen is being displayed on the display 26 (P6-1).

If the scenario selection screen is being displayed (YES in P6-1) and a decision operation for deciding a scenario is input (YES in P6-2), the nurturing game execution unit 701a temporarily registers the scenario ID corresponding to the scenario selected by the player (P6-3). In addition, the nurturing game execution unit 701a derives an initial upper limit of each of the ability parameters (P6-4).

More specifically, on the basis of the scenario initial addition value data and the scenario selected by the player, the nurturing game execution unit 701a adds the scenario initial addition value to the common base value, thereby deriving an initial upper limit of each of the ability parameters. Namely, a process for setting upper limits of the ability parameters is executed on the basis of the scenario selected by the player and the scenario initial addition value data, which is data tied to scenarios to derive upper limit of ability parameters to be updated during the nurturing game and in which the values for at least some of the ability parameters differ from scenario to scenario.

When initial upper limits are derived in P6-4, the nurturing game execution unit 701a switches the screen on the display 26 to the nurturing-target-character selection screen 150 (P6-12). At this time, the initial upper limits derived in P6-4 are displayed in the ability parameter display section 152a of the nurturing-target-character selection screen 150.

In addition, in the case where the nurturing-target-character selection screen 150 is being displayed (YES in P6-5) and a display switching operation for switching the screen display is input (YES in P6-6), the nurturing game execution unit 701a switches the display screen of the display 26 (P6-12).

Also, when a selection operation (tapping a character icon 151) is input on the nurturing-target-character selection screen 150 (YES in P6-7), the nurturing game execution unit 701a temporarily stores the character corresponding to the selected character icon 151 (P6-8) and switches the display screen (P6-12).

Furthermore, when a decision operation (tapping the next operation section 154) is input on the nurturing-target-character selection screen 150 (YES in P6-9), the nurturing game execution unit 701a temporarily registers the character temporarily stored in P6-8 above as a nurturing-target character (P6-10). In addition, the nurturing game execution unit 701a acquires, from the server 1000, information concerning representative characters extracted according to a predetermined extraction condition, such as the representative characters of the friends (P6-11), and displays the inheritance character selection screen 170 (P6-12).

Also, in the case where the inheritance character selection screen 170 or the nurtured character list screen 180 is being displayed (YES in P6-21) as shown in FIG. 41, and a display switching operation for switching the screen display is input (YES in P6-22), the nurturing game execution unit 701a switches the display screen on the display 26 (P6-33).

Here, the display switching operation on the inheritance character selection screen 170 or the nurtured character list screen 180 includes: tapping the skill display button 172 and pressing and holding a nurtured character icon 182 shown in FIG. 8B; and tapping the nickname change button 186a, the memo input button 186b, the skill display tab 188a, the inheritance information display tab 188b, the nurturing information display tab 188c, and the close operation section 188d in the character details dialog 185A shown in FIG. 14.

For example, in the case where the skill display button 172 is tapped on the nurtured character list screen 180, the nurturing game execution unit 701a displays the skill display dialog 185B in P6-33. In addition, in the case where a nurtured character icon 182 is pressed and held on the nurtured character list screen 180, the nurturing game execution unit 701a displays the character details dialog 185A in P6-33. Note that in the case where the nickname change button 186a, the memo input button 186b, the skill display tab 188a, the inheritance information display tab 188b, the nurturing information display tab 188c, or the close operation section 188d is tapped in the character details dialog 185A, the current screen switches to the screen corresponding to the tapped operation section.

In addition, when a selection operation (tapping a nurtured character icon 182) is input on the nurtured character list screen 180 (YES in P6-23), the nurturing game execution unit 701a temporarily stores the character corresponding to the selected nurtured character icon 182 as an inheritance character (P6-24) and switches the display screen (P6-33).

Note that here, the display of the ability parameter display section 152a is updated on the basis of the numerical values and upper limits of ability parameters that increase due to base ability factors tied to the inheritance characters.

Also, when a decision operation (tapping the next operation section 154) is input on the inheritance character selection screen 170 (YES in P6-25), the nurturing game execution unit 701a temporarily registers the inheritance characters temporarily stored in P6-24 (P6-26) and displays the support card organization screen 190 on the display 26 (P6-33).

In addition, in the case where the support card selection screen 200 is being displayed (YES in P6-27) and a selection operation (tapping the card icon 201 of a support card) is input on the support card selection screen 200 (YES in P6-28), the nurturing game execution unit 701a temporarily stores the support card corresponding to the selected card icon 201 (P6-29) and switches the display screen (P6-30).

Also, in the case where the support card organization screen 190 is being displayed (YES in P6-31) and a display switching operation for switching the screen display is input (YES in P6-32), the nurturing game execution unit 701a switches the display screen of the display 26 (P6-33).

In addition, as shown in FIG. 42, in the case where the preset selection screen 205A is being displayed (YES in P6-41 in FIG. 42) and a display switching operation for switching the screen display is input (YES in P6-42), the nurturing game execution unit 701a switches the display screen of the display 26 (P6-45).

Moreover, in the case where a selection operation (tapping the select operation section 206c) is input on the preset selection screen 205A (YES in P6-43), the nurturing game execution unit 701a temporarily stores the reservation selection information corresponding to the selected preset (P6-44) and switches the display screen (P6-45).

Furthermore, in the case where the final confirmation screen 205 is being displayed (NO in P6-41) and a display switching operation for switching the screen display is input (YES in P6-46), the nurturing game execution unit 701a switches the display screen of the display 26 (P6-47).

Also, when a decision operation (tapping the start operation section 205b) is input on the final confirmation screen 205 (YES in P6-48), the nurturing game execution unit 701a determines whether or not the game points are equal to or larger than a predetermined value (e.g., 30) (P6-49). If the game points are equal to or larger than the predetermined value (YES in P6-49), the nurturing game execution unit 701a transmits confirmation information to the server 1000 (P6-50).

Note that the confirmation information includes information for identifying the temporarily registered nurturing-target character, inheritance characters, and support cards. Upon receiving the confirmation information, it is determined in the preparatory-stage process (S6 in FIG. 39) at the server 1000 whether or not to permit execution of a nurturing main game by using the temporarily registered nurturing-target character, inheritance characters, and support cards. Also, at the server 1000, it is determined whether or not all conditions for starting a nurturing game are satisfied. When it is determined that all conditions for starting a nurturing game are satisfied, the nurturing game execution unit 1101a stores, in the game information storage section 1151, the various kinds of game information registered in the player terminal 1. Also, the nurturing game execution unit 1101a causes the player terminal 1 to receive permission information.

At the player terminal 1, upon receiving the permission information (YES in P6-51) after transmitting the confirmation information (P6-50), the nurturing game execution unit 701a registers the scenario ID temporarily registered in P6-3 (P6-52). Here, the nurturing game execution unit 701a registers the initial upper limit of each of the ability parameters on the basis of the initial upper limits derived in P6-4 and the base ability factors that are tied to the inheritance characters temporarily registered in P6-26.

In addition, the nurturing game execution unit 701a registers the nurturing-target character temporarily registered in P6-10 above (P6-53). Here, the nurturing game execution unit 701a also registers, in the deck, the inheritance characters (nurtured characters) temporarily registered as inheritance characters in P6-26 above and the support cards temporarily stored in P6-29 above.

In addition, the nurturing game execution unit 701a registers the reservation selection information for the preset temporarily stored in P6-44 above (P6-54). Also, the nurturing game execution unit 701a displays the game screen 210 on the display 26 (P6-57). By doing so, the preparatory-stage process ends.

Referring back to FIG. 39, when the preparatory-stage process (P6) is completed, the nurturing game execution unit 701a executes the nurturing-stage process (P7). Also, during this nurturing-stage process, communication processes are executed between the player terminal 1 and the server 1000. At the server 1000, the nurturing game execution unit 1101a executes the nurturing-stage process (S7) on the basis of information received from the player terminal 1. In reality, the player terminal 1 and the server 1000 have individual roles assigned thereto for proceeding with the nurturing main game such that the player terminal 1 is in charge of the nurturing-stage process (P7) and the server 1000 is in charge of the nurturing-stage process (S7). It should be noted, however, that some or all of the processes described below in the nurturing-stage process (P7) in the player terminal 1 may be executed in the nurturing-stage process (S7) in the server 1000. Also, some or all of the processes described below in the nurturing-stage process (S7) in the server 1000 may be executed in the nurturing-stage process (P7) in the player terminal 1.

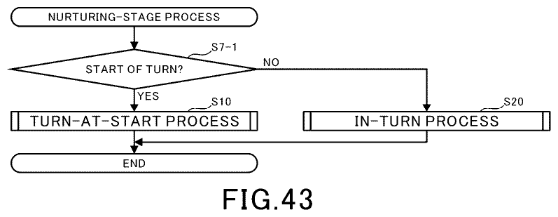

FIG. 43 is a flowchart for illustrating the nurturing-stage process in the server 1000. The nurturing game execution unit 1101a of the server 1000 executes the turn-at-start process (510) if the player is at the start of a turn (YES in S7-1). Also, after the turn-at-start process has been executed, the nurturing game execution unit 1101a executes an in-turn process (S20).

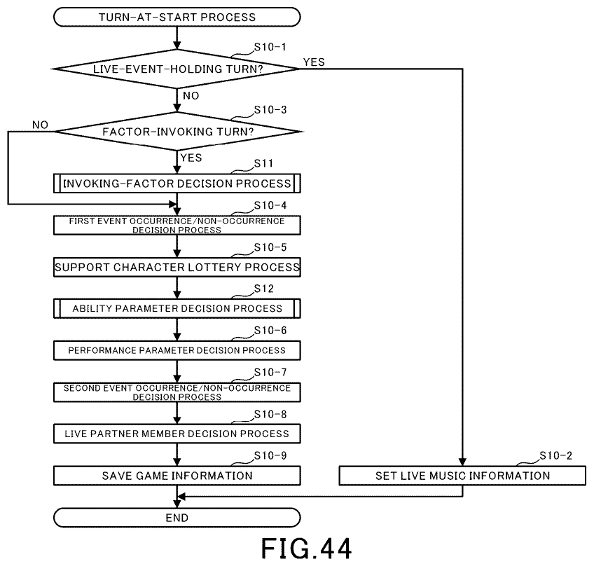

FIG. 44 is a flowchart for illustrating the turn-at-start process in the server 1000. The nurturing game execution unit 1101a of the server 1000 determines whether or not the current turn is a live-event-holding turn (510-1). If the current turn is a live-event-holding turn (YES in S10-1), the nurturing game execution unit 1101a sets live-music-etc information (S10-2). Note that when the player earns live music, etc., information indicating the earned live music, etc. is stored in the player terminal 1 and the server 1000 as live-music-etc information. Here, live-music-etc information earned in the time period from the start of the nurturing game or the previous live-event-holding turn to the current turn is extracted and is set so as to be received by the player terminal 1.

In addition, if the current turn is not a live-event-holding turn (NO in S10-1) and is a factor-invoking turn (YES in S10-3), the nurturing game execution unit 1101a executes an invoking-factor decision process (S11).

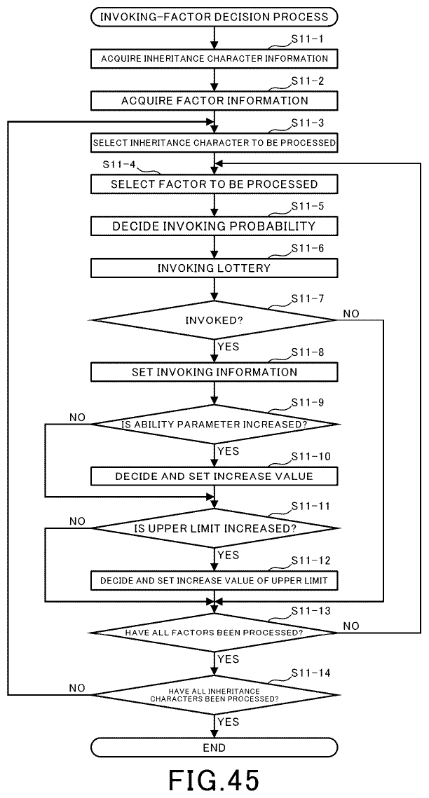

FIG. 45 is a flowchart for illustrating the invoking-factor decision process in the server 1000. The nurturing game execution unit 1101a acquires inheritance character information concerning the registered inheritance characters (S11-1). Furthermore, the nurturing game execution unit 1101a acquires factor information tied to the registered inheritance characters (S11-2).

Also, the nurturing game execution unit 1101a selects, as a character to be processed from among the six inheritance characters, one of the inheritance characters that have not been subjected to the processes in S11-4 and after (S11-3). Then, the nurturing game execution unit 1101a selects, as a factor to be processed from among the factors tied to the inheritance characters selected in S11-3, one of the factors that have not been subjected to the processes in S11-5 and after (S11-4).

The nurturing game execution unit 1101a decides an invoking probability on the basis of the factor to be processed selected in S11-4 and the current turn number (S11-5). In addition, the nurturing game execution unit 1101a draws an invoking lottery for deciding whether or not to invoke the factor to be processed on the basis of the invoking probability decided in S11-5 (S11-6). In the case where it is decided in the invoking lottery that the factor to be processed is invoked (YES in S11-7), the nurturing game execution unit 1101a sets invoking information indicating that the factor will be invoked (S11-8).

Furthermore, in the case where it is decided that a factor involving an increase in an ability parameter is invoked (YES in S11-9), the nurturing game execution unit 1101a decides and sets an increase value of the applicable ability parameter (S11-10).

Here, first the nurturing game execution unit 1101a decides an increase value on the basis of the factor level, etc. Thereafter, the nurturing game execution unit 1101a derives the difference between the upper limit of the applicable ability parameter and the current numerical value, and determines whether or not the previously decided increase value is smaller than or equal to the derived difference. As a result, if the increase value is smaller than or equal to the difference, the nurturing game execution unit 1101a sets the increase value. On the other hand, in the case where the increase value exceeds the difference, the difference is set as the increase value. Namely, the nurturing game execution unit 1101a updates an ability parameter within the range up to the upper limit by constraining the ability parameter from being updated to a value exceeding the set upper limit.

In addition, in the case where it is decided that a factor involving an increase in the upper limit of an ability parameter is invoked (YES in S11-11), the nurturing game execution unit 1101a decides and sets an increase value of the upper limit of the applicable ability parameter (S11-12). Note that here, an increase value of the upper limit may be decided by lottery or may be decided to be a value set in advance for each of the factors.

The nurturing game execution unit 1101a determines whether or not the processes on all factors tied to the inheritance character to be processed have completed (S11-13). If not all factors have been processed, the flow returns to the process in S11-4, in which the aforementioned processes are performed on the remaining factors. On the other hand, when all factors have been processed (YES in S11-13), the nurturing game execution unit 1101a determines whether or not the processes on all inheritance characters have completed (S11-14). If not all inheritance characters have been processed, the flow returns to the process in S11-3, in which the aforementioned processes are performed on the remaining inheritance characters. On the other hand, when all inheritance characters have been processed (YES in S11-14), the nurturing game execution unit 1101a ends the invoking-factor decision process.

Referring back to FIG. 44, the nurturing game execution unit 1101a executes a first event occurrence/non-occurrence decision process (S10-4). More specifically, when a turn is started, a random number is randomly acquired, and whether or not to cause a first event to occur and the content of the first event are decided on the basis of the acquired random number and the first event table.

Next, the nurturing game execution unit 1101a executes a support character lottery process (S10-5). More specifically, the nurturing game execution unit 1101a decides, by lottery, whether or not to place support characters in each of the training courses with reference to the placement probability table shown in FIG. 32. This process is executed for each of the support characters. Note that when it is decided that a support character is placed in a training course, the nurturing game execution unit 1101a ties the support character ID to the training ID corresponding to the training course.

In addition, here, a lottery for deciding whether or not to place, in a training course, the support character tied to a support card not registered by the player in the deck may further be drawn. Furthermore, a lottery for deciding whether or not to place, in a training course, a predetermined character, other than the support character, appearing in the nurturing game may be drawn.

Next, the nurturing game execution unit 1101a executes an ability parameter decision process (S12).

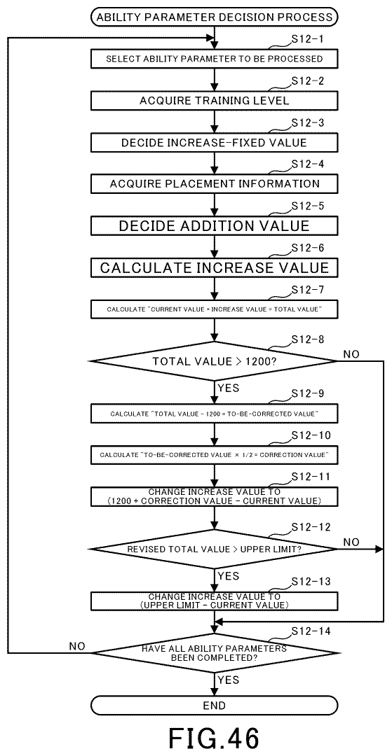

FIG. 46 is a flowchart for illustrating the ability parameter decision process in the server 1000. The nurturing game execution unit 1101a selects, as an ability parameter to be processed from among the five ability parameters, one of the ability parameters that have not been subjected to the processes in S12-2 and after (S12-1). Next, the nurturing game execution unit 1101a acquires the training level of the ability parameter to be processed (S12-2) and decides an increase-fixed value (S12-3).

Then, the nurturing game execution unit 1101a acquires placement information of support characters, etc. (S12-4) and decides an addition value (S12-5). Then, the nurturing game execution unit 1101a calculates an increase value by summing the increase-fixed value decided in S12-3 and the addition value decided in S12-5 (S12-6). Next, the nurturing game execution unit 1101a calculates a total value by adding the increase value calculated in S12-6 to the current value of the ability parameter to be processed (S12-7).

In the case where the total value exceeds “1200”, which is the common base value (YES in S12-8), the nurturing game execution unit 1101a calculates a to-be-corrected value by subtracting 1200 from the total value (S12-9). Then, the nurturing game execution unit 1101a calculates a correction value by multiplying the to-be-corrected value calculated in S12-9 by ½ (S12-10). Next, the nurturing game execution unit 1101a changes the increase value to a value obtained by subtracting the current numerical value from the value resulting from adding the correction value calculated in S12-10 to 1200 (S12-11).

Thus, in this embodiment, an increase value of an ability parameter resulting from successful training, if exceeding the common base value, is corrected to one half of the original increase value. Suppose, for example, that the current value of the ability parameter to be processed is “1180” and the increase value calculated in S12-6 is “100”. If this is the case, the ability parameter should be expected to increase to “1280”. In this embodiment, however, the portion of the ability parameter exceeding “1200”, which is the common base value, is halved. Therefore, of “100”, serving as the original increase value, “80” exceeding “1200” is halved. Consequently, the portion of the increase value exceeding “1200” is calculated as “40”, and the portion of the increase value up to “1200” is “20”. Ultimately, the ability parameter increases by “60”, which is obtained by adding “40” to “20”.

Note that any fraction resulting from the aforementioned calculation is discarded. In addition, in the case where the increase value is smaller than one as a result of a halved correction value being applied, the increase value is one. In short, the increase value is always at least one. In the case where an ability parameter is decreased, it is also acceptable that the halving correction is not applied. Also, for example, in the case where an amount of increase in an ability parameter is added in accordance with a predetermined condition, apart from the amount of increase in the ability parameter due to normal training, each of the increase values may be halved.

As described above, in this embodiment, a common base value that is set in common among the plurality of ability parameters or the plurality of scenarios is provided. Also, in the case where an ability parameter is updated in the range up to the common base value, the update value of the ability parameter is decided according to a first update condition. On the other hand, in the case where the ability parameter is updated so as to exceed the common base value, the update value of the ability parameter is decided according to a second update condition, which less readily increases the ability parameter than the first update condition. This prevents a particular ability parameter from easily and extremely being increased.

Here, an increase value of an ability parameter exceeding the common base value is corrected in the case of successful training. It should be noted, however, that in the case where an ability parameter increases due to the invocation of a factor or the occurrence of an event in S11-10, the increase value may also be corrected in the same manner as described above.

In addition, the nurturing game execution unit 1101a determines whether or not the revised total value obtained by adding the current value to the increase value changed in S12-11 exceeds the current upper limit of the ability parameter to be processed (S12-12). If the revised total value exceeds the current upper limit (YES in S12-12), the nurturing game execution unit 1101a changes the increase value to a value obtained by subtracting the current numerical value from the current upper limit (S12-13).

Also, if not all ability parameters have been subjected to the aforementioned processes (NO in S12-14), the flow returns to S12-1, in which the same processes are performed on the remaining ability parameters. On the other hand, when all ability parameters have been processed, the nurturing game execution unit 1101a ends the ability parameter decision process.

Although not described in detail, the amount of decrease in the physical strength or the amount of recovery of the physical strength in the case where each of the training courses is executed is decided in the ability parameter decision process. Also, the nurturing game execution unit 1101a calculates a failure rate of training for each of the training courses on the basis of the physical strength of the nurturing-target character.

Referring back to FIG. 44, the nurturing game execution unit 1101a executes a performance parameter decision process (S10-6). In the performance parameter decision process, performance features to be tied to each of the training courses are decided. More specifically, the nurturing game execution unit 1101a draws a lottery for deciding whether or not to tie performance features to training courses at the probabilities shown in FIG. 34A. This lottery is drawn for each of the training courses. Also, zero to two performance features are tied to one training course.

Furthermore, the nurturing game execution unit 1101a decides increase values of performance parameters in the case where each of training courses is successfully executed. More specifically, the nurturing game execution unit 1101a decides the increase values of the performance parameters tied to training courses on the basis of the increase-fixed value table (refer to FIG. 34B) and the bonus addition rate table (refer to FIG. 34C).

Next, the nurturing game execution unit 1101a executes a second event occurrence/non-occurrence decision process (S10-7). More specifically, the nurturing game execution unit 1101a decides, by lottery, whether or not to cause a second event to occur with reference to the second event table shown in FIG. 35. The nurturing game execution unit 1101a randomly acquires a random number and decides whether or not to cause a second event to occur on the basis of the acquired random number and the second event table. Here, for example, the nurturing game execution unit 1101a decides, by lottery, whether or not to execute a support event set in advance in each of the support cards tied to a training course.

Also, the nurturing game execution unit 1101a executes a live partner member decision process (S10-8). Here, in the case where the current turn is a turn set in advance, a live partner member is decided according to a predetermined algorithm.

Then, the nurturing game execution unit 1101a saves, in the game information storage section 1151, game information including information concerning the lottery results in S10-3 to S10-8 so as to be receivable by the player terminal 1 (S10-9).

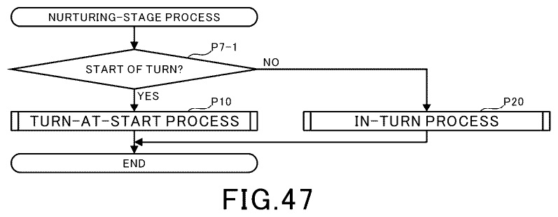

FIG. 47 is a flowchart for illustrating the nurturing-stage process in the player terminal 1. The nurturing game execution unit 701a of the player terminal 1 executes the turn-at-start process (P10) if the player is at the start of a turn (YES in P7-1) or the in-turn process (P20) if the player is not at the start of a turn.

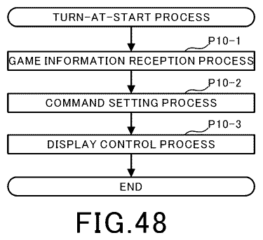

FIG. 48 is a flowchart for illustrating the turn-at-start process in the player terminal 1. At the start of a turn, the nurturing game execution unit 701a accesses the game information storage section 1151 of the server 1000 and receives, from the server 1000, the game information saved in S10-9 above (P10-1).

Then, the nurturing game execution unit 701a executes a command setting process for allowing the player to select various commands related to the nurturing-stage process (P10-2). More specifically, as shown in, for example, FIG. 21, on the basis of the current turn number, the nurturing game execution unit 701a executes a process for allowing the player to select various kinds of commands, such as the rest operation section 215, the training operation section 216, the skill operation section 217, the going-out operation section 218, the race operation section (specific command) 219, and the live preparation operation section 220. The nurturing game execution unit 701a also executes a process for allowing the player to select a plurality of race selection operation sections (sub-command) 261 tied to the race operation section 219.

In addition, in the command setting process, the nurturing game execution unit 701a allows the player to select the commands for the speed operation section 241, the stamina operation section 242, the power operation section 243, the spirit operation section 244, and the wisdom operation section 245 corresponding to the respective training courses. The nurturing game execution unit 701a executes a process for allowing the player to select one of the plurality of these commands.

Note that, in a live-event-holding turn, the nurturing game execution unit 701a enables the selection of the live preparation operation section 220 and the live start button 300a and disables the selection of the other operation sections, i.e., commands.

Next, on the basis of the game information received from the server 1000, the current turn, and the process result of the command setting process in P10-2, the nurturing game execution unit 701a executes a display control process for displaying the game screen 210, the training screen 240, a live start screen 300, etc. (P10-3). Here, the screens shown in, for example, FIG. 23A, FIG. 23B, and FIG. 23D are displayed. Because of this, it is determined that the game enters a turn thereafter in the player terminal 1, causing the in-turn process (P20) for accepting a player operation input to be executed.

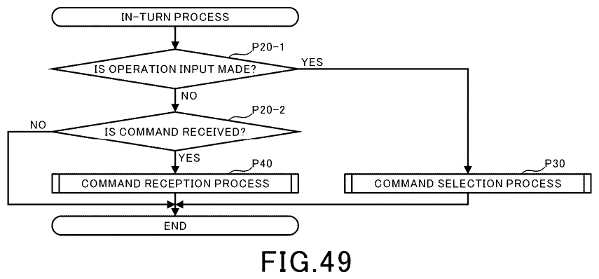

FIG. 49 is a flowchart for illustrating the in-turn process in the player terminal 1. When a player operation input is made in the player terminal 1 (YES in P20-1), the nurturing game execution unit 701a executes a command selection process (P30). In addition, in the case where no operation inputs are made (NO in P20-1) and a command is received from the server 1000 (YES in P20-2), the nurturing game execution unit 701a executes a command reception process (P40).

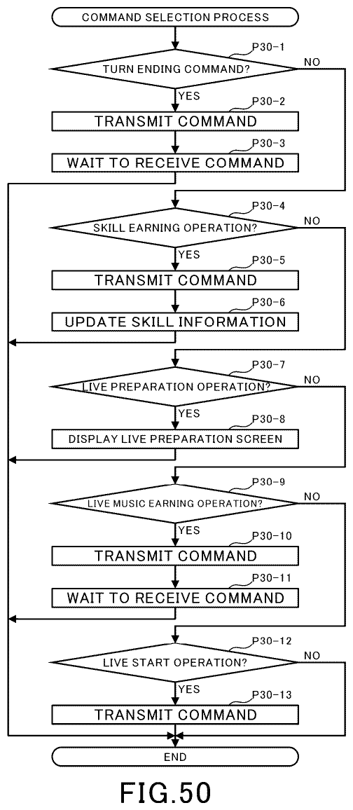

FIG. 50 is a flowchart for illustrating the command selection process in the player terminal 1. When the player selects a turn ending command (rest operation section 215, going-out operation section 218, speed operation section 241, stamina operation section 242, power operation section 243, spirit operation section 244, wisdom operation section 245, or race operation section 274) serving as a predetermined command for ending a turn (YES in P30-1), the nurturing game execution unit 701a transmits the selected command to the server 1000 (P30-2). The nurturing game execution unit 701a then waits to receive a command from the server 1000 (P30-3).

In addition, when a skill earning operation (tapping a skill display field 251) for earning a skill is input (YES in P30-4), the nurturing game execution unit 701a transmits, to the server 1000, the command corresponding to the operated skill display field 251 (P30-5). Furthermore, the nurturing game execution unit 701a updates skill information indicating that the corresponding skill has been earned (P30-6).

Also, when a live preparation operation (tapping the live preparation operation section 220 or a live-music-etc-details display field 292) is input (YES in P30-7), the nurturing game execution unit 701a displays the live preparation screen 290 or the confirmation dialog 294 on the display 26 (P30-8).

In addition, when a live-music-etc earning operation (tapping the execution button 294a) is input (YES in P30-9), the nurturing game execution unit 701a transmits, to the server 1000, the command corresponding to the operated live-music-etc-details display field 292 (P30-10). The nurturing game execution unit 701a then waits to receive a command from the server 1000 (P30-11).

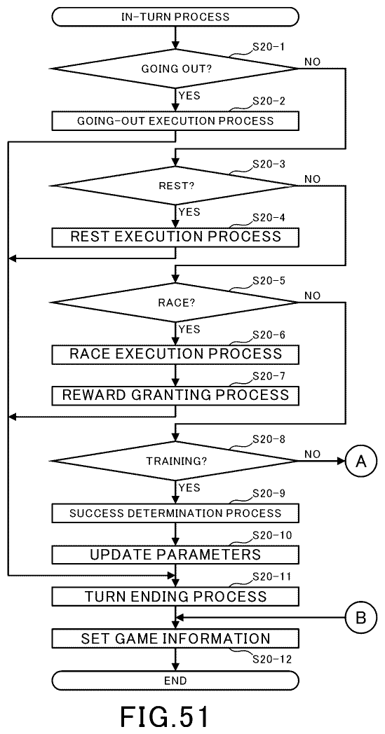

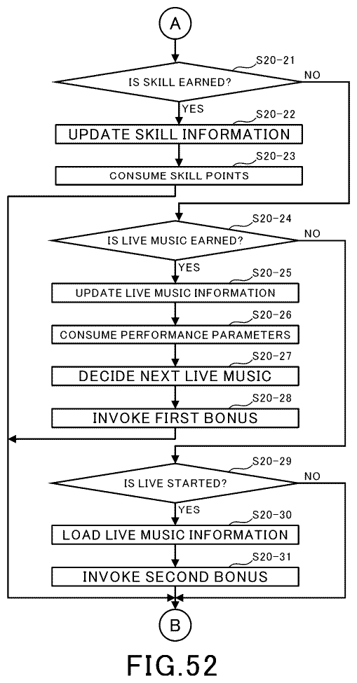

Also, when a live start operation (tapping the live start button 300a) is input (YES in P30-12), the nurturing game execution unit 701a transmits, to the server 1000, a command indicating that a live start operation has been made (P30-13). Upon receiving the command transmitted in P30-2, P30-5, P30-10, or P30-13 above, the server 1000 executes the in-turn process (S20) as shown in FIG. 51 and FIG. 52.

FIG. 51 is a first flowchart for illustrating the in-turn process in the server 1000. FIG. 52 a second flowchart for illustrating the in-turn process in the server 1000. Upon receiving a command indicating an operation input to the going-out operation section 218 (YES in S20-1), the nurturing game execution unit 1101a executes a going-out execution process (S20-2). Here, a going-out event for increasing the parameters of the physical strength and the physical condition is decided. Also, the parameters of the physical strength and the physical condition are updated on the basis of the decided going-out event.

Upon receiving a command indicating an operation input to the rest operation section 215 (YES in S20-3), the nurturing game execution unit 1101a executes a rest execution process (S20-4). Here, a rest event for increasing the physical strength parameter is decided. In addition, the physical strength parameter is updated on the basis of the decided rest event.

Upon receiving a command indicating an operation input for starting a race (YES in S20-5), the nurturing game execution unit 1101a executes a race execution process (S20-6). Here, a race simulation is executed on the basis of the parameters of the nurturing-target character and NPCs that run in the race. Furthermore, the nurturing game execution unit 1101a executes a reward granting process for granting a reward to the player (S20-7). Here, a reward is decided on the basis of simulation results, namely, the finish place of the nurturing-target character, race proceeding, etc., and the decided reward is granted to the player.

Upon receiving a command indicating the execution of any training (YES in S20-8), the nurturing game execution unit 1101a executes a success determination process (S20-9). Here, a success or a failure in the training is determined on the basis of a failure rate calculated in advance. Then, the nurturing game execution unit 1101a updates various parameters on the basis of the determination result in S20-9 (S20-10). Here, ability parameters, etc. are updated as decided in S10-5 at the start of the training. Here, performance parameters are also updated as decided in S10-6 at the start of the training.

Also, in the case where a process involving the ending of the turn is executed (S20-2, S20-4, S20-6, S20-7, S20-9, or S20-10), the nurturing game execution unit 1101a executes a process for ending the current turn and transitioning to the next turn (S20-11). This ends the in-turn process (S20) in the server 1000 and makes the server 1000 wait for the turn-at-start process (510).

Furthermore, various items of game information decided and updated through the processes shown in FIG. 51 and FIG. 52 are set in the game information storage section 1151 (S20-12). The game information set here is received by the player terminal 1.

In addition, as shown in FIG. 52, upon receiving a command indicating an input of a skill earning operation (YES in S20-21), the nurturing game execution unit 1101a updates the skill information in the game information storage section 1151 (S20-22). Also, the nurturing game execution unit 1101a consumes skill points along with earning of a skill (S20-23).

In addition, upon receiving a command indicating earning of live music, etc. (YES in S20-24), the nurturing game execution unit 1101a updates live-music-etc information indicating the earned live music, etc. (S20-25). Furthermore, the nurturing game execution unit 1101a consumes performance parameters along with earning of live music, etc. (S20-26).

In addition, with reference to the live-music-etc-routing information, the nurturing game execution unit 1101a decides the next three pieces of live music, etc. that can be selected by the player on the basis of the earned live music, etc. (S20-27).

Also, the nurturing game execution unit 1101a invokes a first bonus tied to the earned live music, etc. (S20-28). Here, a first bonus being invoked causes an increase in an ability parameter, recovery of the physical strength, earning of a skill hint, etc. Thus, a first bonus tied to live music, etc. is invoked in the turn in which the live music, etc. is earned.

Also, upon receiving a command indicating a live start operation (YES in S20-29), the nurturing game execution unit 1101a loads live-music-etc information indicating the live music, etc. earned by the player (S20-30). Then, the nurturing game execution unit 1101a invokes a second bonus tied to live music, etc. earned in the time period from the start of the nurturing main game or the previous live-event-holding turn to the current turn (live-event-holding turn) (S20-31). Here, a second bonus being invoked causes various parameters including the favorite training rate, event occurrence rate, skill hint occurrence rate, race bonus, failure rate, etc. to be updated. Thus, a second bonus tied to live music, etc. is invoked in the turn in which the first live event is held after the live music, etc. has been earned.

Note that here, the effectiveness of a second bonus continues from when it has been invoked to when the nurturing main game ends. It should be noted, however, that the effectiveness of a second bonus may be valid only within a predetermined time period. For example, the effectiveness of a second bonus may continue only within a time period such as from when the second bonus has been invoked to when the next live-event-holding turn is reached or to when the number of turns set in advance elapse.

At the player terminal 1, upon receiving the game information (command) set in S20-12, the command reception process (P40) is executed in the in-turn process (P20) shown in FIG. 49.

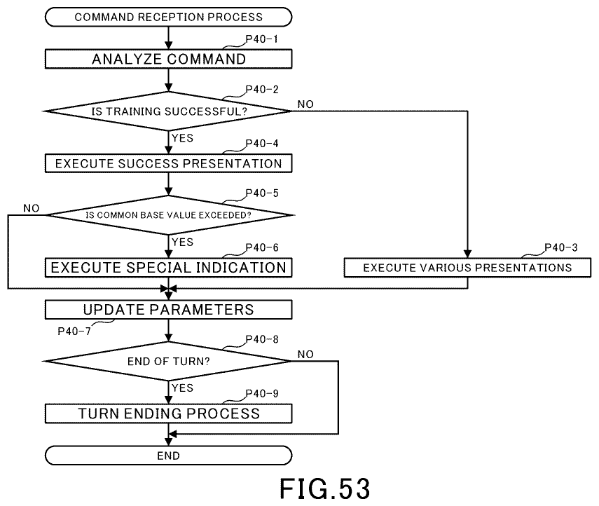

FIG. 53 is a flowchart for illustrating a command reception process in the player terminal 1. The nurturing game execution unit 701a analyzes the command received from the server 1000 (P40-1). Upon receiving a command other than the command indicating successful training (NO in P40-2), the nurturing game execution unit 701a executes various presentations, such as displaying the event screen 240b, on the basis of the received command (P40-3).

For example, when an event that increases ability parameters occurs, an event screen 240b corresponding to the event that has occurred is displayed. At this time, in the case where an ability parameter exceeds the common base value, a special presentation is executed.

Note that, in a live-event-holding turn, the number of characters and character types displayed on the live event screen 301 are decided according to the number of pieces of live music, etc. and live partner members. In short, in a live-event-holding turn, a display pattern of the live event screen 301 is decided according to the number of pieces of live music, etc. and live partner members. Also, the nurturing game execution unit 701a displays the live event screen 301 in the decided display pattern. Note that here, the display pattern of the live event screen 301 is decided at the player terminal 1. It should be noted, however, that the display pattern of the live event screen 301 may be decided at the server 1000.

In addition, upon receiving a command indicating successful training (YES in P40-2), the nurturing game execution unit 701a executes a success presentation, such as displaying the screen shown in FIG. 23C (P40-4). In addition, the nurturing game execution unit 701a determines whether or not the increased numerical value of an ability parameter exceeds the common base value (P40-5). In the case where the increased numerical value of an ability parameter exceeds the common base value (YES in P40-5), the nurturing game execution unit 701a executes a special indication, such as displaying a dedicated icon (P40-6).

Furthermore, the nurturing game execution unit 701a updates various parameters in the game information storage section 751 on the basis of the received command (P40-7). Also, in the case where a command for ending the turn is received (YES in P40-8), the nurturing game execution unit 701a executes a turn ending process (P40-9). Here, after the display of various screens, such as the event screen, a process for ending the current turn and starting the next turn is executed. This causes the in-turn process shown in FIG. 49 to end. In the case where the next turn is present, the turn-at-start process shown in FIG. 47 is executed at the player terminal 1. On the other hand, in the case where the next turn is not present, namely, in the case where the last turn ends, the nurturing-stage process (P7 and S7) ends.

Referring back to FIG. 39, when the aforementioned nurturing-stage process ends, the nurturing-at-completion processing unit 702a executes a nurturing game end process (P8) at the player terminal 1. In the nurturing game end process, the nurturing-at-completion processing unit 702a stores, in the game information storage section 751, information concerning the nurtured character nurtured in the nurturing game. In addition, the nurturing-at-completion processing unit 702a transmits end information to the server 1000. This end information includes information, etc. concerning the nurtured character. At the server 1000, upon receiving the end information, the nurturing game end processing unit 1102a executes the nurturing game end process (S8).

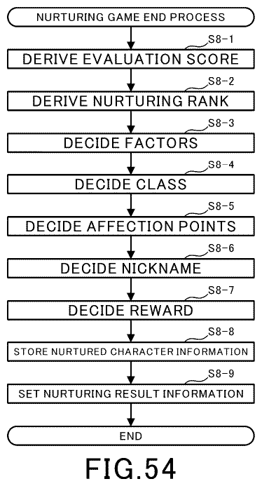

FIG. 54 is a flowchart for illustrating the nurturing game end process in the server 1000. The nurturing game end processing unit 1102a derives an evaluation score on the basis of the end information received from the player terminal 1 (S8-1). In addition, the nurturing game end processing unit 1102a derives a nurturing rank on the basis of the derived evaluation score (S8-2).

Furthermore, the nurturing game end processing unit 1102a decides factors to be earned by the nurtured character (S8-3). Here, a base ability factor, an aptitude factor, race factors, and skill factors to be tied to the nurturing-target character (nurtured character) are decided on the basis of, for example, race results in the nurturing game, final ability parameters, etc. Factor levels are also decided for factors decided to be tied to the nurturing-target character (nurtured character).

In this embodiment, a character factor is provided for each of the characters that can be set as a nurturing-target character. Here, in the case where the character selected as the nurturing-target character has a predetermined level, a character factor is always tied to the nurturing-target character (nurtured character).

As described above, character factors include a factor achieving effectiveness for increasing the upper limit of a predetermined ability parameter. For example, when the player plays a nurturing game in which a character having a character factor tied thereto for increasing the upper limit of the speed ability parameter serves as a nurturing-target character, the player can create a nurtured character having a character factor tied thereto for increasing the upper limit of the speed ability parameter. The player can increase the upper limit of the speed ability parameter by playing a nurturing game in which a nurtured character created in this manner serves as an inheritance character.

In short, it can be said that selection of a nurturing-target character in a nurturing game is to select the character factor to be tied to a nurtured character the nurturing of which is completed. This allows the player to easily increase the upper limit of a desired ability parameter. As a result, the player is further encouraged to play the game, aiming at creating nurtured characters having various character factors.

Also, the nurturing game end processing unit 1102a decides a class on the basis of the number of earned fans (S8-4). In addition, the nurturing game end processing unit 1102a decides affection points on the basis of a predetermined parameter, such as the nurturing rank or the number of fans (S8-5). Although not described in detail, affection points are points granted not to the nurtured character but to a character on which the nurtured character is based.

The story screen described above is provided in a plurality for each character, and a release condition is set for some of the story screens. There are some story screens in which affection points are set as a release condition therefor, so that the player is allowed to view such story screens when the affection points reach a threshold value.

In addition, the nurturing game end processing unit 1102a decides a nickname (S8-6). Here, conditions achieved in the nurturing main game are confirmed, and a nickname to be earned by the nurtured character is decided. In addition, the nurturing game end processing unit 1102a decides a reward to be granted to the player on the basis of results of the nurturing game (S8-7).

Furthermore, the nurturing game end processing unit 1102a stores, in the game information storage section 1151, nurtured character information including the character type, the evaluation score, the nurturing rank, the ability parameters, the aptitude parameters, the earned skills, the inheritance information, the factor information, the class, the nickname, etc. so as to be tied to the player ID of the player (S8-8). Note that the nurtured character information may include the upper limits of the ability parameters. Also, the nurturing game end processing unit 1102a sets nurturing result information, and causes the player terminal 1 to receive the nurturing result information (S8-9).

Referring back to FIG. 39, upon receiving the nurturing result information, the nurturing-at-completion processing unit 702a executes a nurturing game end display process (P9). Here, the nurturing-at-completion processing unit 702a stores the received nurturing result information in the game information storage section 751. Furthermore, the nurturing-at-completion processing unit 702a displays the nurturing completion screen 310 (refer to FIG. 36A, FIG. 36B, and FIG. 36C) on the display 26 on the basis of the nurturing result information.

The aforementioned nurturing game is realized through the aforementioned processes. In addition, nurtured character information concerning the nurtured character nurtured (created) by the nurturing game is stored so as to be tied to the player ID. By doing so, the created nurtured character can be used as an inheritance character in the subsequent nurturing games.

Note that the aforementioned processes in the player terminal 1 and the server 1000 are merely examples. Each of the aforementioned processes may be executed only in the player terminal 1 or only in the server 1000.

Although an aspect of an embodiment has been described with reference to the accompanying drawings, it goes without saying that the present invention is not limited to the aforementioned embodiment. It would be obvious that a person skilled in the art could conceive of various modifications and amendments within the scope recited in the claims, and it will be understood that those modifications and amendments obviously belong to the technical scope.

The gameplay and the processes in the player terminal 1 and the server 1000 described in the aforementioned embodiment are merely examples. In any case, it suffices if an information processing program causes a computer (at least one of the player terminal 1 and server 1000 in the embodiment) to execute the following processes.

### (Processes Executed by Computer)

Process for allowing a player to select a nurturing-completed game medium (e.g., nurtured character in the embodiment) that is used in a nurturing game and to which predetermined inheritance information (e.g., factor information in the embodiment) is tied (e.g., P6-12 in the embodiment).

Process for executing the nurturing game (e.g., P6, P7, S6, and S7 in the embodiment), said process including at least a process for updating at least one parameter (e.g., five ability parameters in the embodiment) tied to a nurturing-target character (e.g., S20-10 in the embodiment) and a process based on the nurturing-completed game medium selected by the player (e.g., S11 in the embodiment).

Process for creating and storing, on the basis of completion of the nurturing game, the nurturing-completed game medium in which the parameter and the inheritance information are tied to the nurturing-target character (e.g., S8 in the embodiment).

In addition, the inheritance information includes specific inheritance information (e.g., base ability factor and character factor in the embodiment) for increasing an upper limit of the parameter.

Also, the process for executing the nurturing game increases the upper limit of a predetermined parameter in the case where the specific inheritance information is tied to the nurturing-completed game medium selected by the player (e.g., P6-52 and S11-12 in the embodiment).

Although the aforementioned embodiment has been described by way of an example where the parameter the upper limit of which increases is an ability parameter, the parameter the upper limit of which increases is not limited to an ability parameter. For example, in the aforementioned embodiment, the upper limit of a performance parameter or the physical strength parameter may increase.

Also, the aforementioned embodiment has been described by way of an example where a base ability factor and a character factor are provided as factors for increasing the upper limit of an ability parameter. It should be noted, however, that the type of factor for increasing the upper limit of an ability parameter is not limited to those described above. In addition, the aforementioned embodiment has been described by way of an example where an increase value of an ability parameter is further tied to a factor for increasing the upper limit of the same ability parameter. It should be noted, however, that there may be a factor having only effectiveness set therefor for increasing the upper limit of an ability parameter.

In addition, the aforementioned embodiment has been described by way of an example where an ability parameter is increased or a hint for a skill is earned on the basis of a factor tied to an inheritance character. It should be noted, however, that processes based on an inheritance character are not limited to those described above. For example, in the aforementioned embodiment, a predetermined event may occur on the basis of an inheritance character.

Also, a base value (e.g., common base value in the embodiment) set in common among a plurality of the parameters may be provided. In addition, in the case where the specific inheritance information is tied to the nurturing-completed game medium selected by the player, the process for executing the nurturing game may be capable of increasing the upper limit of the predetermined parameter to a value larger than the base value. It should be noted, however, that the base value is not essential.

In addition, an information processing program may cause a computer to execute a process for performing different displays between in the case where the parameter is updated in the range below the base value and in the case where the parameter is updated so as to exceed the base value (e.g., P10-3, P40-3, and P40-6 in the embodiment). It should be noted, however, that common display may be performed, regardless of whether the base value is exceeded.

In addition, the inheritance information may include a plurality of kinds of the specific inheritance information that differ from one another in terms of at least either the parameter the upper limit of which increases or an increase value of the upper limit. It should be noted, however, that only one kind of the specific inheritance information may be provided.

Furthermore, the information processing program may cause the computer to execute a process for allowing the player to select, from among a plurality of characters to which any of the plurality of kinds of specific inheritance information is tied, a character that is set as the nurturing-target character (e.g., P5 in the embodiment). It should be noted, however, that only one kind of character that can be set as the nurturing-target character may be provided.

Also, the information processing program may tie, to the nurturing-completed game medium, the specific inheritance information tied to the character set as the nurturing-target character. It should be noted, however, that specific inheritance information unique to a character is not essential.

Furthermore, in the process for updating at least one parameter, an update value of the parameter may be decided according to a first update condition in the case where the parameter is updated in the range below the base value, and an update value of the parameter may be decided according to a second update condition, which less readily increases the parameter than the first update condition, in the case where the parameter is updated so as to exceed the base value (e.g., S12-8 to S12-11 in the embodiment).

In contrast to the above, however, a second update condition that more easily increases the parameter than the first update condition may be set. Alternatively, an update value of the parameter may be decided according to a common update condition, regardless of the base value or the updated numerical value.

Note that the information processing program for executing the processes in the aforementioned embodiment and various modifications may be stored in a computer-readable, non-transitory storage medium and may be provided as a storage medium. Furthermore, it is also acceptable to provide a game terminal device including this storage medium. In addition, the aforementioned embodiment and various modifications may also be an information processing method that realizes each of the functions and the steps shown in the flowcharts.

What is claimed is:

1. A non-transitory computer readable medium storing a program causing a computer to execute:
a process for allowing a player to select a nurturing-completed game medium that is used in a nurturing game and to which predetermined inheritance information is tied;
a process for executing the nurturing game, the process including at least a process for updating at least one parameter tied to a nurturing-target character and a process based on the nurturing-completed game medium selected by the player; and
a process for creating and storing, on the basis of completion of the nurturing game, the nurturing-completed game medium in which the at least one parameter and the inheritance information are tied to the nurturing-target character,
wherein the inheritance information includes specific inheritance information for increasing an upper limit of the at least one parameter, and
the process for executing the nurturing game increases the upper limit of a predetermined parameter in the case where the specific inheritance information is tied to the nurturing-completed game medium selected by the player.

2. The non-transitory computer readable medium according to claim 1,
wherein the at least one parameter includes a plurality of parameters,
a base value set in common among the plurality of parameters is provided,
the process for executing the nurturing game can increase the upper limit of the predetermined parameter to a value larger than the base value in the case where the specific inheritance information is tied to the nurturing-completed game medium selected by the player, and
the program causes the computer to execute a process for performing different displays between in the case where the parameter is updated in a range below the base value and in the case where the parameter is updated so as to exceed the base value.

3. The non-transitory computer readable medium according to claim 1,
wherein the inheritance information includes a plurality of kinds of the specific inheritance information that differ from one another in terms of at least either the parameter the upper limit of which increases or an increase value of the upper limit,
the program causes the computer to execute a process for allowing the player to select, from among a plurality of characters to which any of the plurality of kinds of specific inheritance information is tied, a character that is set as the nurturing-target character, and
the process for creating and storing the nurturing-completed game medium ties, to the nurturing-completed game medium, the specific inheritance information tied to the character set as the nurturing-target character.

4. The non-transitory computer readable medium according to claim 1,
wherein an increase value of the predetermined parameter is further tied to the specific inheritance information.

5. The non-transitory computer readable medium according to claim 3,
wherein an increase value of the predetermined parameter is further tied to the specific inheritance information.

6. The non-transitory computer readable medium according to claim 1,
wherein the at least one parameter includes a plurality of parameters,
a base value set in common among the plurality of parameters is provided,
the process for executing the nurturing game can increase the upper limit of the predetermined parameter to a value larger than the base value in the case where the specific inheritance information is tied to the nurturing-completed game medium selected by the player,
an update value of the parameter is decided according to a first update condition in the case where the parameter is updated in a range below the base value, and
an update value of the parameter is decided according to a second update condition, which less readily increases the parameter than the first update condition, in the case where the parameter is updated so as to exceed the base value.

7. An information processing method executed by at least one computer that executes:
a process for allowing a player to select a nurturing-completed game medium that is used in a nurturing game and to which predetermined inheritance information is tied;
a process for executing the nurturing game, the process including at least a process for updating at least one parameter tied to a nurturing-target character and a process based on the nurturing-completed game medium selected by the player; and
a process for creating and storing, on the basis of completion of the nurturing game, the nurturing-completed game medium in which the at least one parameter and the inheritance information are tied to the nurturing-target character,
wherein the inheritance information includes specific inheritance information for increasing an upper limit of the at least one parameter, and
the process for executing the nurturing game increases the upper limit of a predetermined parameter in the case where the specific inheritance information is tied to the nurturing-completed game medium selected by the player.

8. A game device comprising at least one computer that executes:
a process for allowing a player to select a nurturing-completed game medium that is used in a nurturing game and to which predetermined inheritance information is tied;
a process for executing the nurturing game, the process including at least a process for updating at least one parameter tied to a nurturing-target character and a process based on the nurturing-completed game medium selected by the player; and
a process for creating and storing, on the basis of completion of the nurturing game, the nurturing-completed game medium in which the at least one parameter and the inheritance information are tied to the nurturing-target character,
wherein the inheritance information includes specific inheritance information for increasing an upper limit of the at least one parameter, and
the process for executing the nurturing game increases the upper limit of a predetermined parameter in the case where the specific inheritance information is tied to the nurturing-completed game medium selected by the player.
